(19) United States
(12) Patent Application Publication
(10) Pub. No.: US 2024/0192315 A1
(43) Pub. Date: Jun. 13, 2024

(54) RADAR APPARATUS AND METHOD FOR TRANSMISSION AND RECEPTION BY RADAR APPARATUS

(71) Applicant: Panasonic Intellectual Property Management Co., Ltd., Osaka (JP)

(72) Inventors: Takaaki KISHIGAMI, Tokyo (JP); Junji SATO, Tokyo (JP)

(21) Appl. No.: 18/407,730

(22) Filed: Jan. 9, 2024

Related U.S. Application Data
(63) Continuation of application No. PCT/JP2022/022347, filed on Jun. 1, 2022.

(30) Foreign Application Priority Data
Jul. 12, 2021 (JP) 2021-114909

(51) Int. Cl. G01S 7/35; G01S 7/03; G01S 13/931

(52) U.S. Cl. CPC G01S 7/356; G01S 7/032; G01S 13/931

(57) ABSTRACT

In a radar apparatus, either a plurality of transmission antennas or a plurality of reception antennas include a first antenna group disposed in a first direction and a second antenna group disposed in a second direction different from the first direction, and an other of the plurality of transmission antennas and the plurality of reception antennas include a third antenna group disposed in a third direction different from each of the first direction and the second direction.

### TECHNICAL FIELD

The present disclosure relates to a radar apparatus.

### BACKGROUND ART

Recently, a study of radar apparatuses using a radar transmission signal of a short wavelength including a microwave or a millimeter wave that allows high resolution has been carried out. Further, it has been demanded to develop a radar apparatus which senses small objects such as pedestrians in addition to vehicles in a wide-angle range (e.g., referred to as “wide-angle radar apparatus”) in order to improve the outdoor safety.

Examples of the configuration of the radar apparatus having a wide-angle sensing range include a configuration using a technique of receiving a reflected wave from a target by an array antenna composed of a plurality of antennas (also referred to as antenna elements), and estimating the direction of arrival of the reflected wave (also referred to as the angle of arrival) using a signal processing algorithm based on received phase differences with respect to element spacings (antenna spacings) (Direction of Arrival (DOA) estimation).

Examples of the DOA estimation include a Fourier method, and, a Capon method, Multiple Signal Classification (MUSIC), and Estimation of Signal Parameters via Rotational Invariance Techniques (ESPRIT) that are methods achieving higher resolution.

In addition, a radar apparatus has been proposed which, for example, includes a plurality of antennas (array antenna) at a transmitter in addition to at a receiver, and is configured to perform beam scanning through signal processing using the transmission and reception array antennas (also referred to as Multiple Input Multiple Output (MIMO) radar) (e.g., see Non-Patent Literature (hereinafter referred to as “NPL”) 1).

### CITATION LIST

### Patent Literature

PTL 1
Japanese Patent Application Laid-Open No. 2021-081282

### Non-Patent Literature

NPL 1
J. Li, and P. Stoica, “MIMO Radar with Colocated Antennas,” Signal Processing Magazine, IEEE Vol. 24, Issue: 5, pp. 106-114, 2007
NPL 2
Kazuo Shirakawa et al., “3D-Scan Millimeter-Wave Radar for Automotive Application,” Fujitsu Ten technical report, Vol. 30, No. 1, 2012.
NPL 3
M. Kronauge, H. Rohling, “Fast two-dimensional CFAR procedure,” IEEE Trans. Aerosp. Electron. Syst., 2013, 49, (3), pp. 1817-1823 NPL 4
Direction-of-arrival estimation using signal subspace modeling Cadzow, J. A.; Aerospace and Electronic Systems, IEEE Transactions on Volume: 28, Issue: 1 Publication Year: 1992, Page (s): 64-79

### SUMMARY OF INVENTION

However, there is scope for further study on a method for improving the angular measurement accuracy or resolution in a radar apparatus (e.g., a MIMO radar).

One non-limiting and exemplary embodiment facilitates providing a radar apparatus capable of enhancing angular measurement accuracy or resolution.

A radar apparatus according to an exemplary embodiment of the present disclosure includes: transmission circuitry, which, in operation, transmits a transmission signal using a plurality of transmission antennas; and reception circuitry, which, in operation, receives a reflected wave signal using a plurality of reception antennas, the reflected wave signal being the transmission signal reflected by an object, in which either the plurality of transmission antennas or the plurality of reception antennas include a first antenna group disposed in a first direction and a second antenna group disposed in a second direction different from the first direction, and an other of the plurality of transmission antennas and the plurality of reception antennas include a third antenna group disposed in a third direction different from each of the first direction and the second direction.

It should be noted that general or specific embodiments may be implemented as a system, a method, an integrated circuit, a computer program, a storage medium, or any selective combination thereof.

According to an exemplary embodiment of the present disclosure, the angular measurement accuracy or resolution of a radar apparatus can be enhanced

Additional benefits and advantages of the disclosed embodiments will become apparent from the specification and drawings. The benefits and/or advantages may be individually obtained by the various embodiments and features of the specification and drawings, which need not all be provided in order to obtain one or more of such benefits and/or advantages.

### BRIEF DESCRIPTION OF DRAWINGS

FIG. 1 is a diagram illustrating an arrangement example of a MIMO antenna;

FIG. 2 is an example of a direction estimation result;

FIG. 3 is a diagram illustrating an example of antennas of a sub-array configuration;

FIG. 4 is an example of a direction estimation result;

FIG. 5 is an example of a direction estimation result;

FIG. 6 is a block diagram illustrating an exemplary configuration of a radar apparatus;

FIG. 7 is an example of a transmission signal and a reflected wave signal when a chirp pulse is used;

FIG. 8 is a diagram illustrating an arrangement example of a MIMO antenna according to Arrangement Example 1;

FIG. 9 is a diagram illustrating an arrangement example of a virtual reception array according to Arrangement Example 1;

FIG. 10 is a diagram illustrating an example of the direction estimation result according to Arrangement Example 1;

FIG. 11 is a diagram illustrating an arrangement example of a MIMO antenna according to Comparative Arrangement 1;

FIG. 12 is a diagram illustrating an example of the direction estimation result according to Comparative Arrangement 1;

FIG. 13 is a diagram illustrating an arrangement example of a MIMO antenna according to Comparative Arrangement 2;

FIG. 14 is a diagram illustrating an example of the direction estimation result according to Comparative Arrangement 2;

FIG. 15 is a diagram illustrating an arrangement example of a MIMO antenna according to Variation 1 of Arrangement Example 1;

FIG. 16 is a diagram illustrating an arrangement example of a virtual reception array according to Variation 1 of Arrangement Example 1;

FIG. 17 is a diagram illustrating an example of the direction estimation result according to Variation 1 of Arrangement Example 1;

FIG. 18 is a diagram illustrating another arrangement example of a MIMO antenna according to Variation 1 of Arrangement Example 1;

FIG. 19 is a diagram illustrating another arrangement example of the virtual reception array according to Variation 1 of Arrangement Example 1;

FIG. 20 is a diagram illustrating an arrangement example of the MIMO antenna according to Variation 1 of Arrangement Example 1;

FIG. 21 is a diagram illustrating an arrangement example of a MIMO antenna according to Variation 2 of Arrangement Example 1;

FIG. 22 is a diagram illustrating an arrangement example of a virtual reception array according to Variation 2 of Arrangement Example 1;

FIG. 23 is a diagram illustrating an arrangement example of the virtual reception array according to Variation 2 of Arrangement Example 1;

FIG. 24 is a diagram illustrating an example of the direction estimation result according to Variation 2 of Arrangement Example 1;

FIG. 25 is a diagram illustrating an example of the direction estimation result according to Variation 2 of Arrangement Example 1;

FIG. 26 is a diagram illustrating an arrangement example of a MIMO antenna according to Variation 3 of Arrangement Example 1;

FIG. 27 is a diagram illustrating an arrangement example of a virtual reception array according to Variation 3 of Arrangement Example 1;

FIG. 28 is a diagram illustrating an example of the direction estimation result according to Variation 3 of Arrangement Example 1;

FIG. 29 is a diagram illustrating an arrangement example of a MIMO antenna according to Variation 4 of Arrangement Example 1;

FIG. 30 is a diagram illustrating an arrangement example of the MIMO antenna according to Variation 4 of Arrangement Example 1;

FIG. 31 is a diagram illustrating an arrangement example of the MIMO antenna according to Variation 4 of Arrangement Example 1;

FIG. 32 is a diagram illustrating an arrangement example of the MIMO antenna according to Variation 4 of Arrangement Example 1;

FIG. 33 is a diagram illustrating an arrangement example of a virtual reception array according to Variation 4 of Arrangement Example 1;

FIG. 34 is a diagram illustrating an arrangement example of the virtual reception array according to Variation 4 of Arrangement Example 1;

FIG. 35 is a diagram illustrating an arrangement example of the virtual reception array according to Variation 4 of Arrangement Example 1;

FIG. 36 is a diagram illustrating an arrangement example of the virtual reception array according to Variation 4 of Arrangement Example 1;

FIG. 37 is a diagram illustrating an example of the direction estimation result according to Variation 4 of Arrangement Example 1;

FIG. 38 is a diagram illustrating an example of the direction estimation result according to Variation 4 of Arrangement Example 1;

FIG. 39 is a diagram illustrating an example of the direction estimation result according to Variation 4 of Arrangement Example 1;

FIG. 40 is a diagram illustrating an example of the direction estimation result according to Variation 4 of Arrangement Example 1;

FIG. 41 is a diagram illustrating an arrangement example of a MIMO antenna according to Variation 5 of Arrangement Example 1;

FIG. 42 is a diagram illustrating an arrangement example of the MIMO antenna according to Variation 5 of Arrangement Example 1;

FIG. 43 is a diagram illustrating an arrangement example of the MIMO antenna according to Variation 5 of Arrangement Example 1;

FIG. 44 is a diagram illustrating an arrangement example of the MIMO antenna according to Variation 5 of Arrangement Example 1;

FIG. 45 is a diagram illustrating an arrangement example of a virtual reception array according to Variation 5 of Arrangement Example 1;

FIG. 46 is a diagram illustrating an arrangement example of the virtual reception array according to Variation 5 of Arrangement Example 1;

FIG. 47 is a diagram illustrating an arrangement example of the virtual reception array according to Variation 5 of Arrangement Example 1;

FIG. 48 is a diagram illustrating an arrangement example of the virtual reception array according to Variation 5 of Arrangement Example 1;

FIG. 49 is a diagram illustrating an example of the direction estimation result according to Variation 5 of Arrangement Example 1;

FIG. 50 is a diagram illustrating an example of the direction estimation result according to Variation 5 of Arrangement Example 1;

FIG. 51 is a diagram illustrating an example of the direction estimation result according to Variation 5 of Arrangement Example 1;

FIG. 52 is a diagram illustrating an example of the direction estimation result according to Variation 5 of Arrangement Example 1;

FIG. 53 is a diagram illustrating an arrangement example of the MIMO antenna according to Variation 5 of Arrangement Example 1;

FIG. 54 is a diagram illustrating an arrangement example of the virtual reception array according to Variation 5 of Arrangement Example 1;

FIG. 55 is a diagram illustrating an example of the direction estimation result according to Variation 5 of Arrangement Example 1;

FIG. 56 is a diagram illustrating an arrangement example of a MIMO antenna according to Variation 6 of Arrangement Example 1;

FIG. 57 is a diagram illustrating an arrangement example of the MIMO antenna according to Variation 6 of Arrangement Example 1;

FIG. 58 is a diagram illustrating an arrangement example of the MIMO antenna according to Variation 6 of Arrangement Example 1;

FIG. 59 is a diagram illustrating an arrangement example of a MIMO antenna according to Variation 7 of Arrangement Example 1;

FIG. 60 is a diagram illustrating an arrangement example of the MIMO antenna according to Variation 7 of Arrangement Example 1;

FIG. 61 is a diagram illustrating an arrangement example of the MIMO antenna according to Variation 7 of Arrangement Example 1;

FIG. 62 is a diagram illustrating an arrangement example of the MIMO antenna according to Variation 7 of Arrangement Example 1;

FIG. 63 is a diagram illustrating an arrangement example of a virtual reception array according to Variation 7 of Arrangement Example 1;

FIG. 64 is a diagram illustrating an arrangement example of the virtual reception array according to Variation 7 of Arrangement Example 1;

FIG. 65 is a diagram illustrating an arrangement example of the virtual reception array according to Variation 7 of Arrangement Example 1;

FIG. 66 is a diagram illustrating an arrangement example of the virtual reception array according to Variation 7 of Arrangement Example 1;

FIG. 67 is a diagram illustrating an example of the direction estimation result according to Variation 7 of Arrangement Example 1;

FIG. 68 is a diagram illustrating an example of the direction estimation result according to Variation 7 of Arrangement Example 1;

FIG. 69 is a diagram illustrating an example of the direction estimation result according to Variation 7 of Arrangement Example 1;

FIG. 70 is a diagram illustrating an example of the direction estimation result according to Variation 7 of Arrangement Example 1;

FIG. 71 is a diagram illustrating an arrangement example of a MIMO antenna according to Variation 8 of Arrangement Example 1;

FIG. 72 is a diagram illustrating an arrangement example of a virtual reception array according to Variation 8 of Arrangement Example 1;

FIG. 73 is a diagram illustrating an example of the direction estimation result according to Variation 8 of Arrangement Example 1;

FIG. 74 is a diagram illustrating an arrangement example of a MIMO antenna and a virtual reception array under Arrangement Condition 1;

FIG. 75 is a diagram illustrating an arrangement example of the MIMO antenna and the virtual reception array under Arrangement Condition 1;

FIG. 76 is a diagram illustrating an arrangement example of the MIMO antenna and the virtual reception array under Arrangement Condition 1;

FIG. 77 is a diagram illustrating an arrangement example of the MIMO antenna and the virtual reception array under Arrangement Condition 1;

FIG. 78 is a diagram illustrating an arrangement example of the MIMO antenna and the virtual reception array under Arrangement Condition 1;

FIG. 79 is a diagram illustrating an arrangement example of the MIMO antenna and the virtual reception array under Arrangement Condition 1;

FIG. 80 is a diagram illustrating an arrangement example of a MIMO antenna according to Arrangement Example 2;

FIG. 81 is a diagram illustrating an arrangement example of a virtual reception array according to Arrangement Example 2;

FIG. 82 is a diagram illustrating an example of the direction estimation result according to Arrangement Example 2;

FIG. 83 is a diagram illustrating an arrangement example of a MIMO antenna and an example of the direction estimation result according to Comparative Arrangement 2a;

FIG. 84 is a diagram illustrating an arrangement example of a MIMO antenna and an example of the direction estimation result according to Comparative Arrangement 2b;

FIG. 85 is a diagram illustrating an arrangement example of a MIMO antenna and an example of the direction estimation result according to Comparative Arrangement 2c;

FIG. 86 is a diagram illustrating an arrangement example of a MIMO antenna and an example of the direction estimation result according to Comparative Arrangement 2d;

FIG. 87 is a diagram illustrating an arrangement example of a MIMO antenna according to Arrangement Example 2a;

FIG. 88 is a diagram illustrating an arrangement example of a virtual reception array according to Arrangement Example 2a;

FIG. 89 is a diagram illustrating an example of the direction estimation result according to Arrangement Example 2a;

FIG. 90 is a diagram illustrating an arrangement example of a MIMO antenna according to Arrangement Example 2b;

FIG. 91 is a diagram illustrating an arrangement example of a virtual reception array according to Arrangement Example 2b;

FIG. 92 is a diagram illustrating an example of the direction estimation result according to Arrangement Example 2b;

FIG. 93 is a diagram illustrating an arrangement example of a MIMO antenna according to Variation 4 of Arrangement Example 2;

FIG. 94 is a diagram illustrating an arrangement example of the MIMO antenna according to Variation 4 of Arrangement Example 2;

FIG. 95 is a diagram illustrating an arrangement example of the MIMO antenna according to Variation 4 of Arrangement Example 2;

FIG. 96 is a diagram illustrating an arrangement example of the MIMO antenna according to Variation 4 of Arrangement Example 2;

FIG. 97 is a diagram illustrating an arrangement example of a MIMO antenna and a virtual reception array under Arrangement Condition 2;

FIG. 98 is a diagram illustrating an arrangement example of the MIMO antenna and the virtual reception array under Arrangement Condition 2;

FIG. 99 is a diagram illustrating an arrangement example of the MIMO antenna and the virtual reception array under Arrangement Condition 2;

FIG. 100 is a diagram illustrating an arrangement example of the MIMO antenna and the virtual reception array under Arrangement Condition 2; and

FIG. 101 is a diagram illustrating an arrangement example of the MIMO antenna and the virtual reception array under Arrangement Condition 2.

### DESCRIPTION OF EMBODIMENTS

A MIMO radar transmits, from a plurality of transmission antennas (also referred to as “transmission array antenna”), signals (radar transmission waves) that are time-division, frequency-division, or code-division multiplexed, for example. The MIMO radar then receives signals (radar reflected waves) reflected, for example, by an object around the radar using a plurality of reception antennas (also referred to as “reception array antenna”) to separate and receive multiplexed transmission signals from reception signals. With this processing, the MIMO radar can extract a propagation path response indicated by the product of the number of transmission antennas and the number of reception antennas, and performs array signal processing using these reception signals as a virtual reception array.

In the MIMO radar, the virtual reception array antenna (hereinafter, referred to as the virtual reception array, a MIMO virtual reception array, a virtual reception antenna, or a virtual reception array antenna) equal in number to the product of the number of transmission antenna elements and the number of reception antenna elements at most can be configured by devising arrangement of the antenna elements in a transmission/reception array antenna. It is thus possible to obtain the effect of increasing the effective aperture length of the array antenna by a small number of elements, so as to enhance the angular measurement accuracy or the resolution.

In addition, the MIMO radar is applicable not only to one-dimensional scanning (angular measurement) in a vertical direction or a horizontal direction but also to two-dimensional beam scanning (angular measurement) in the vertical direction and the horizontal direction (for example, see NPL 2).

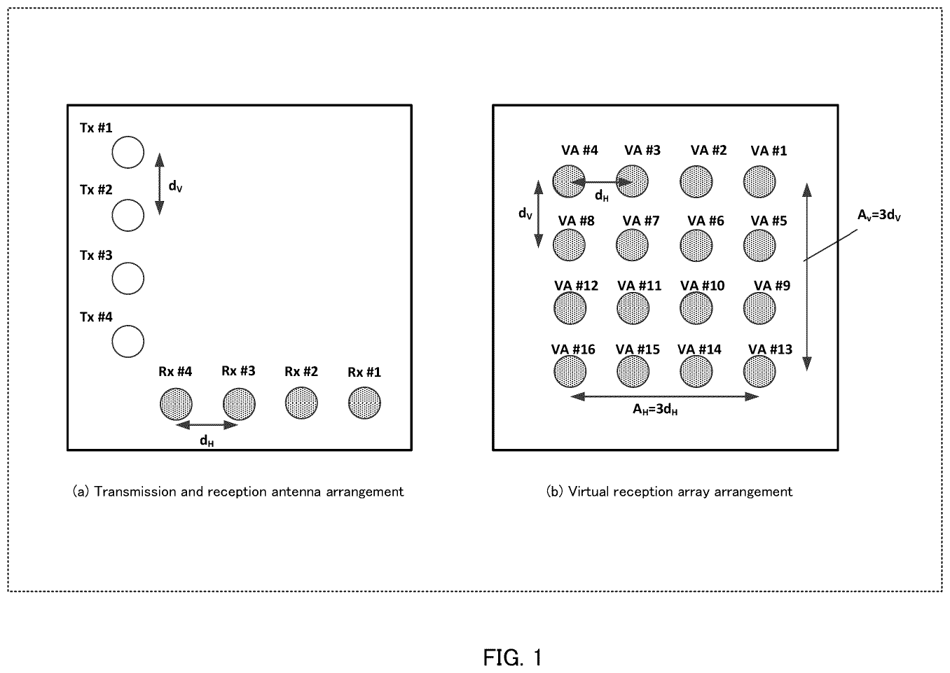

By way of example, (a) of FIG. 1 illustrates a transmission array antenna including four transmission antennas (Tx #1 to Tx #4) arranged in the vertical direction (in the upper-lower direction at (a) of FIG. 1) and a reception array antenna including four reception antennas (Rx #1 to Rx #4) arranged in the horizontal direction (in the lateral direction at (a) of FIG. 1). In (a) of FIG. 1, the transmission antennas are arranged at equal spacings (d_{V}) in the vertical direction, and the reception antennas are arranged at equal spacings (d_{H}) in the horizontal direction (see, for example, NPL 2).

Part (b) of FIG. 1 illustrates a virtual reception array including transmission/reception array antennas of the antenna arrangement illustrated at (a) of FIG. 1. The virtual reception array illustrated at (b) of FIG. 1 is composed of 16 elements of virtual antennas (VA #1 to VA #16) of four horizontal antennas and four vertical antennas arranged in a rectangular shape. At part (b) of FIG. 1, horizontal and vertical element spacings of the virtual reception array are d_{H} and d_{V}, respectively. Horizontal and vertical aperture lengths A_{H} and A_{V} of the virtual reception array are A_{H}=3d_{H} and A_{V}=3d_{V}, respectively.

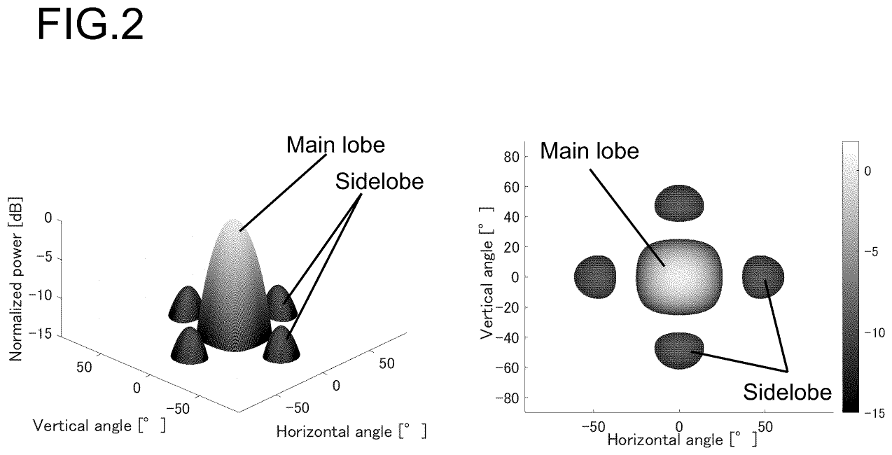

Parts (a) and (b) of FIG. 2 illustrate Fourier beam patterns obtained in a case where horizontal element spacing d_{H}=0.52, vertical element spacing d_{V}=0.52, and the elements are oriented at 0° in the horizontal direction and at 0° in the vertical direction in the antenna arrangement of the MIMO radar illustrated at (a) of FIG. 1. The character “2” represents the wavelength of a radar carrier wave.

As illustrated at (a) of FIG. 2 and (b) of FIG. 2, a main beam (main lobe) is formed at 0° in the horizontal direction and at 0° in the vertical direction. In this respect, the narrower the beam width of the main beam, the higher the angular separation performance for multiple targets. For example, at (a) of FIG. 2 and (b) of FIG. 2, the beam width at which the power value is 3 dB is about 26°. As illustrated at (a) and (b) of FIG. 2, sidelobes are generated around the main beam. In the radar apparatus, the sidelobes are a factor of false detection as virtual images. Therefore, the lower the peak level of the sidelobes is, the lower the probability of false detection as virtual images in the radar apparatus is. For example, at (a) of FIG. 2 and (b) of FIG. 2, the power ratio (Peak Sidelobe Level Ratio (PSLR)) of the peak level of the sidelobes normalized by the peak level of the main beam is about −13 dB (when an equiamplitude beam weight is used).

In order to increase a detection range of the radar apparatus, it is effective to use an antenna having a high gain. For example, the antenna gain can be increased by narrowing the directivity (beam width) of the antenna. The directivity of the antenna becomes narrower, for example, as the aperture of the antenna is widened. Therefore, in order to narrow the directivity of the antenna, the antenna size tends to increase.

For example, in a radar apparatus mounted on a vehicle (also referred to as an in-vehicle radar, for example) or the like, a sub-array antenna configured by arranging a plurality of antenna elements in the vertical direction may be used in order to narrow directivity in the vertical direction. By narrowing the directivity in the vertical direction by the sub-array antenna, the antenna gain in the vertical direction can be increased, and a reflected wave in an unnecessary direction such as a direction toward a road surface can be reduced.

Note that, the vertical direction is a height direction of the vehicle on which the radar apparatus is mounted (or installed). The horizontal direction is a straight-traveling direction of the vehicle, a direction orthogonal to the straight-traveling direction of the vehicle, or a direction orthogonal to the height direction of the vehicle.

The vertical direction may be, for example, the direction of gravity in the case where the radar apparatus is mounted (or installed) on a signal device, and the horizontal direction may be a direction orthogonal to the direction of gravity.

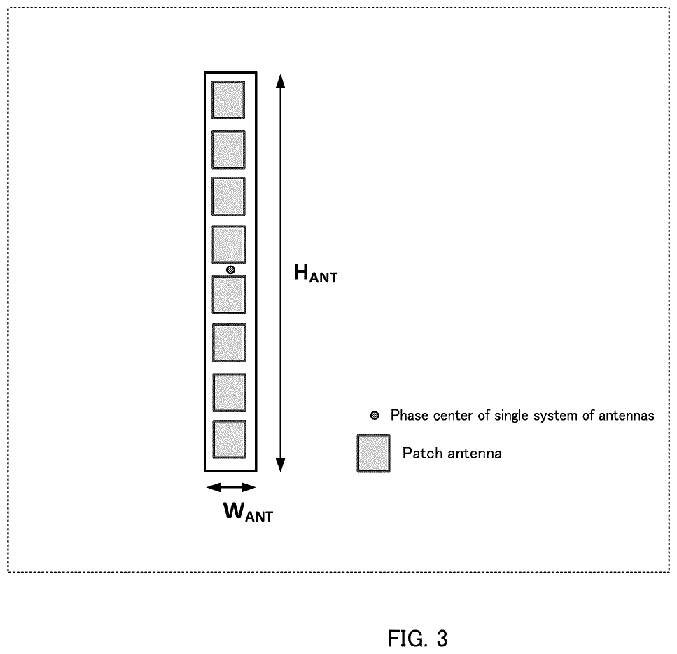

For example, FIG. 3 illustrates an exemplary sub-array in which eight planar patch antennas are arranged in the vertical direction (the upper-lower direction in FIG. 3) and one element is arranged in the horizontal direction (the lateral direction in FIG. 3). In FIG. 3, H_{ANT} indicates the antenna size in the vertical direction, and W_{ANT} indicates the antenna size in the horizontal direction. Note that the configuration of the sub-array is not limited to the configuration illustrated in FIG. 3, and for example, the number of elements in the vertical direction and the horizontal direction may be different from the numbers illustrated in FIG. 3.

Here, when the sub-array antenna is used for an antenna element constituting a transmission array antenna or a reception array antenna, it is difficult to arrange the antenna element of the array antenna in a space narrower than the size of the sub-array antenna. For example, when the antenna elements constituting the sub-array antenna are arranged in the vertical direction, the size of the sub-array antenna may be equal to or greater than one wavelength. Therefore, for example, when the sub-array antenna is used in the vertical direction in the MIMO radar illustrated at (a) of FIG. 1 (when the sub-array is formed in the vertical direction), element spacing d_{V} in the vertical direction is to be enlarged to the spacing equal to or greater than one wavelength.

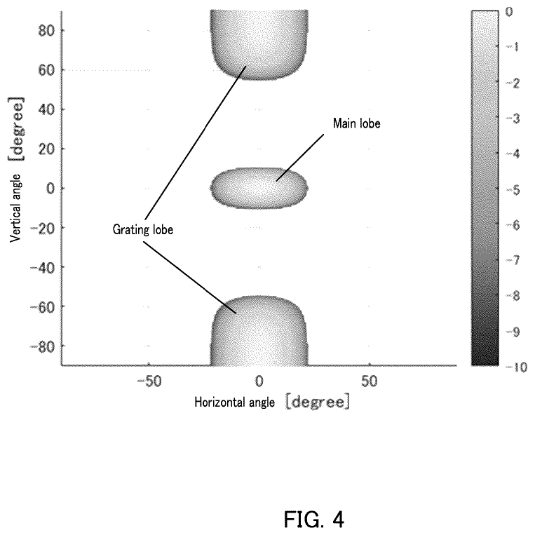

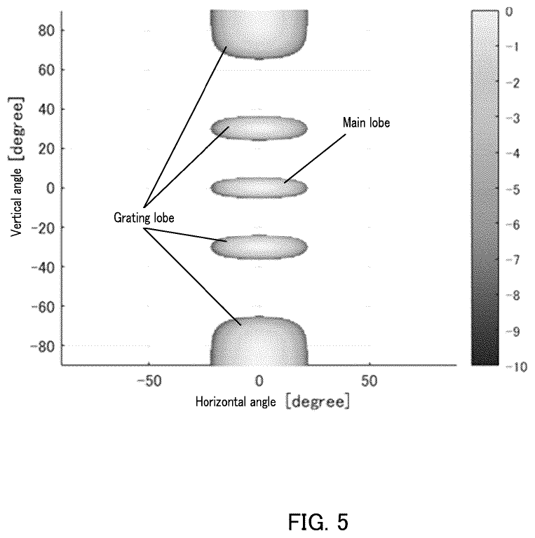

FIGS. 4 and 5 illustrate one example of Fourier beam patterns obtained when element spacing d_{V} in the vertical direction is set to a wavelength equal to or greater than one wavelength (λ) in the transmission and reception antenna arrangement of the MIMO radar illustrated at (a) of FIG. 1 and the MIMO radar is oriented at 0° in the horizontal direction and at 0° in the vertical direction. In FIGS. 4 and 5, the directivities of single antenna elements that are configured as the sub-array in the vertical direction are not taken into consideration.

In FIG. 4, vertical element spacing d_{V} is λ and horizontal element spacing du is 0.5λ, and in FIG. 5, vertical element spacing d_{V} is 2λ and horizontal element spacing du is 0.5λ.

As illustrated in FIGS. 4 and 5, the main beam (main lobe) is oriented at 0° in the horizontal direction and at 0° in the vertical direction, and sidelobes (e.g., grating lobes) which are of higher levels as compared with the sidelobes at (a) and (b) of FIG. 2, for example, are generated in the vertical direction around the main beam. In FIGS. 4 and 5, the ratio of the peak level of the grating lobes to the peak level of the main lobe (peak-sidelobe ratio) is 0 dB. In addition, the angular spacing at which the vertically higher-level sidelobes (e.g., grating lobes) are generated is narrower in FIG. 5 (d_{V}=2λ) than in FIG. 4 (d_{V}=λ). For example, the characteristics that vertical element spacing d_{V} increases with decreasing angular spacing at which sidelobes (e.g., grating lobes) are generated can be confirmed.

As is understood, in the radar apparatus, the larger the antenna size in the vertical direction, the wider the element spacing in the vertical direction. Thus, the grating lobes are likely to be generated at an angle relatively close to the main beam. For this reason, when the sensing angle range assumed by the radar apparatus is wider than the angle at which the grating lobes are generated, the radar apparatus is more likely to erroneously detect, as a target (target object), a false peak caused by the grating lobes within the sensing angle range, and the detection performance of the radar apparatus may deteriorate.

Further, for example, even when the grating lobes are outside the sensing angle range assumed by the radar apparatus, the radar apparatus is likely to erroneously detect arrival of the target within the viewing angle and, accordingly, the detection performance of the radar apparatus may deteriorate, when the power of the reflected wave coming from the grating-lobe direction is sufficiently high. For example, when the element spacing is equal to or greater than one wavelength, the grating lobes are always generated in a range of ±90 degrees, and therefore, even in a radar apparatus having a narrow viewing angle, deterioration of radar detection performance due to erroneous detection caused by the grating lobes is likely to occur.

On the other hand, for example, the wider the element spacing in the vertical direction, the narrower the beam width in the vertical direction. It is thus possible to enhance the angular measurement accuracy or the angular resolution in the vertical direction in the radar apparatus. For example, it can be confirmed that comparison among the vertical element spacings in FIGS. 2, 4, and 5 indicates the respective element spacings of 0.5λ, λ, and 2λ, and comparison among the main lobes in the Fourier beam patterns indicates that the larger the vertical element spacing, the narrower the vertical beam width and the sharper the beam formed. As is understood, the narrower the beam width in the vertical direction is, the higher the angular accuracy or angular resolution in the vertical direction in the radar apparatus can be.

Similarly, for example, the wider the element spacing in the horizontal direction, the narrower the beam width in the horizontal direction. Thus, the angular measurement accuracy or the angular resolution in the horizontal direction in the radar apparatus can be enhanced. On the other hand, the wider the element spacing in the horizontal direction, the more likely the grating lobes are generated. For example, when the sensing angle range assumed by the radar apparatus is wider than the angle at which the grating lobes are generated, the radar apparatus is more likely to erroneously detect, as a target (target object), a false peak caused by the grating lobes within the sensing angle range, and the detection performance of the radar apparatus may deteriorate.

In that connection, one non-limiting and exemplary embodiment of the present disclosure will be described in relation to an antenna arrangement capable of suppressing a grating lobe while increasing an element spacing in at least one of a vertical direction and a horizontal direction. By realizing such an antenna arrangement, the angular measurement accuracy or the resolution can be enhanced by using a smaller number of antennas.

The radar apparatus according to one exemplary embodiment of the present disclosure may be mounted on a mobile entity such as a vehicle, for example. The radar apparatus mounted on the mobile entity can be used, for example, as an Advanced Driver Assistance System (ADAS) for enhancing the collision safety, or as a sensor used for monitoring the periphery of the mobile entity during autonomous driving.

In addition, the radar apparatus according to one exemplary embodiment of the present disclosure may be attached to a relatively high-altitude structure, such as, for example, a roadside utility pole or traffic lights. Such a radar apparatus can be utilized, for example, as a sensor of a support system for enhancing the safety of passing vehicles or pedestrians.

The use of the radar apparatus is not limited to the above, and the radar apparatus may also be used for other uses.

Hereinafter, embodiments according to exemplary embodiments of the present disclosure will be described in detail with reference to the accompanying drawings. Note that, in the embodiments, the same constituent elements will be denoted with the same reference signs, and descriptions thereof will be omitted to avoid redundancy.

In the following, a description is given of a radar apparatus having a configuration in which a transmission branch transmits different code-division multiplexed transmission signals from a plurality of transmission antennas, and a reception branch performs reception processing by separating each of the transmission signals (for example, a MIMO radar configuration). However, the configuration of the radar apparatus is not limited thereto, and the radar apparatus may have a configuration in which the transmission branch transmits different frequency-division multiplexed transmission signals from a plurality of transmission antennas, and the reception branch performs reception processing by separating each of the transmission signals. Similarly, the configuration of the radar apparatus may be a configuration in which the transmission branch time-division multiplexed transmission signals from a plurality of transmission antennas and the reception branch performs reception processing.

Similarly, the radar apparatus may have a configuration in which the transmission branch transmits Doppler-division multiplexed transmission signals from a plurality of transmission antennas, and the reception branch performs reception processing by separating each of the transmission signals. Similarly, the radar apparatus may have a configuration in which the transmission branch transmits, from a plurality of transmission antennas, transmission signals multiplexed in combination of at least two of code-division multiplexing, frequency-division multiplexing, and Doppler-division multiplexing, and the reception branch performs reception processing by separating each of the transmission signals.

Further, by way of example, a description will be given below of a configuration of a radar system using a frequency-modulated pulse wave such as a chirp pulse (e.g., also referred to as chirp pulse transmission (fast chirp modulation)). However, the modulation scheme is not limited to frequency modulation. For example, an exemplary embodiment of the present disclosure is applicable to a radar system using a single pulse or an encoded pulse.

### Embodiment 1

### [Configuration of Radar Apparatus]

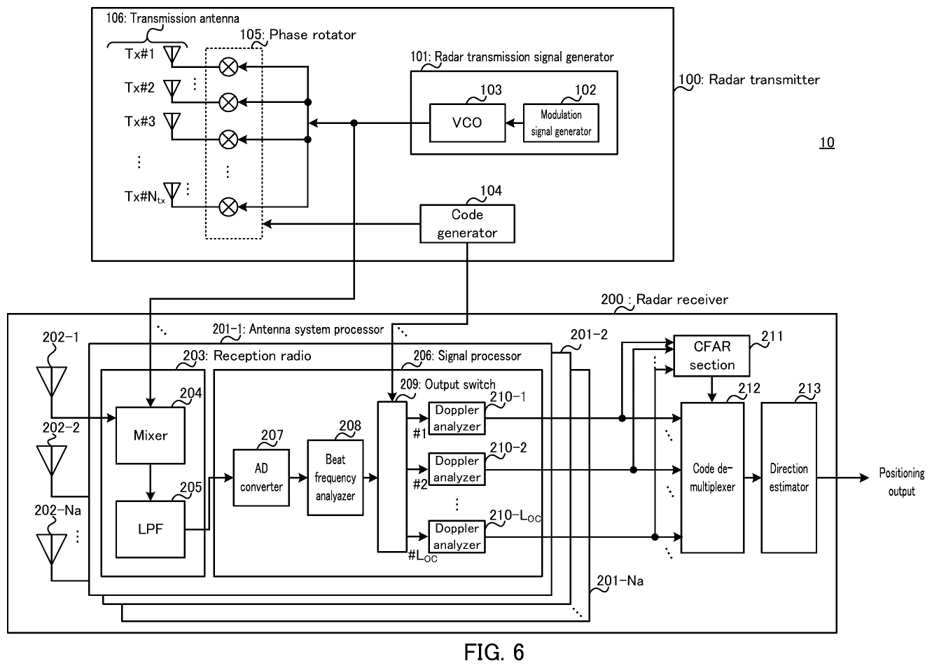

FIG. 6 is a block diagram illustrating an exemplary configuration of radar apparatus 10 according to the present embodiment.

Radar apparatus 10 includes radar transmitter (transmission branch) 100 and radar receiver (reception branch) 200.

Radar transmitter 100 generates a radar signal (radar transmission signal) and transmits the radar transmission signal in a defined transmission period by using a transmission array antenna formed of a plurality of (for example, Nₜₓ) transmission antennas 106.

Radar receiver 200 receives a reflected wave signal, which is the radar transmission signal reflected by a target (not illustrated), using a reception array antenna including a plurality of reception antennas 202 (e.g., Na). Radar receiver 200 performs signal processing on the reflected wave signals received at reception antennas 202 to, for example, detect the presence or absence of the target object, or estimate the distances through which the reflected wave signals arrive, the Doppler frequencies (for example, the relative velocities), and the directions of arrival, and outputs information on an estimation result (for example, positioning information).

Note that, the target is an object to be detected by radar apparatus 10, and includes a vehicle (including a four-wheel vehicle and a two-wheeled vehicle), a person, a block, or curb, for example.

### [Configuration of Radar Transmitter 100]

Radar transmitter 100 includes radar transmission signal generator 101, code generator 104, phase rotators 105, and transmission antennas 106.

Radar transmission signal generator 101 generates a radar transmission signal. Radar transmission signal generator 101 includes, for example, modulation signal generator 102 and Voltage Controlled Oscillator (VCO) 103. Hereinafter, the components of radar transmission signal generator 101 will be described.

Modulation signal generator 102 periodically generates, for example, saw-toothed modulation signals (e.g., modulation signals for VCO control) for each radar transmission period Tr.

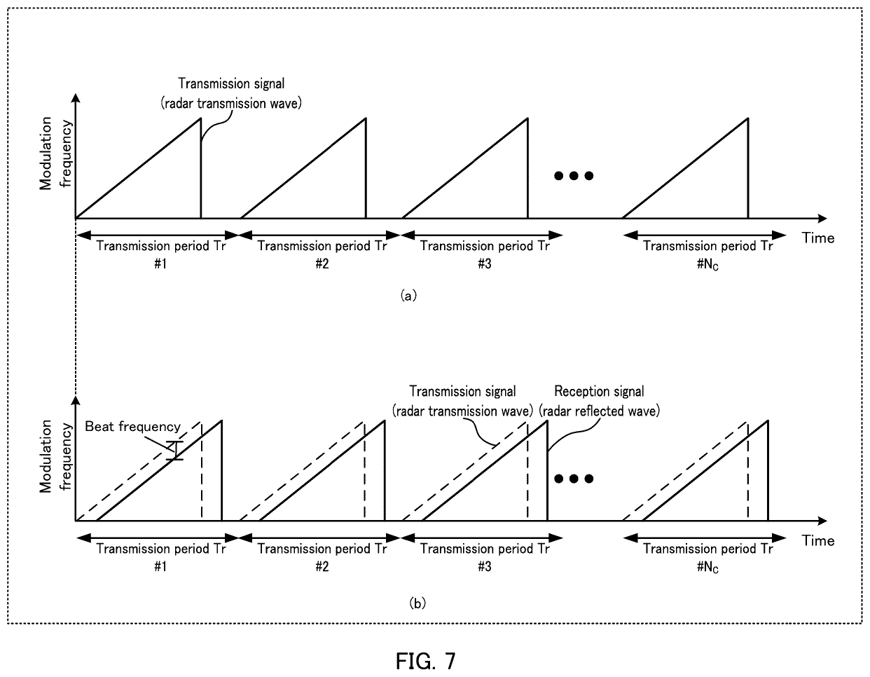

VCO 103 generates frequency-modulated signals (hereinafter referred to as, for example, frequency chirp signals or chirp signals) based on the modulation signals inputted from modulation signal generator 102, and outputs the frequency-modulated signals to phase rotators 105 and radar receiver 200 (mixer 204 described below) as the radar transmission signals (radar transmission waves), as illustrated at (a) of FIG. 7.

Code generator 104 generates respective different codes for transmission antennas 106 that perform code multiplexing transmission. Code generator 104 outputs phase rotation amounts corresponding to the generated codes to phase rotators 105. Further, code generator 104 outputs information on the generated code to radar receiver 200 (output switch 209 to be described later).

Phase rotators 105 apply the phase rotation amounts inputted from code generator 104 to the chirp signals inputted from VCO 103 and outputs the signals subjected to phase rotation to transmission antennas 106. For example, each of phase rotators 105 includes a phase shifter, a phase modulator, and the like (not illustrated). The output signals of phase rotators 105 are amplified to a defined transmission power and are radiated respectively from transmission antennas 106 to space. For example, radar transmission signals are code-multiplexed by application of the phase rotation amounts corresponding to the codes and are transmitted from a plurality of transmission antennas 106.

Next, one example of the codes (e.g., orthogonal codes) configured in radar apparatus 10 will be described.

Code generator 104 generates, for example, respective different codes for transmission antennas 106 that perform code multiplexing transmission.

By way of example, in the following, the number of transmission antennas 106 that perform code multiplexing transmission is denoted by “Nt” and the number of code multiplexing is denoted by “N_{CM}.” In FIG. 6, N_{CM}=Nt.

For example, code generator 104 configures, as codes for code multiplexing transmission, N_{CM} orthogonal codes among N_{allcode} (or N_{allcode}(Loc)) orthogonal codes included in code sequences with code length (e.g., the number of code elements, in other words) Loc (for example, the orthogonal code sequences that are orthogonal to each other (also simply referred to as codes or orthogonal codes)).

For example, number N_{CM} of code multiplexing is equal to or less than number N_{allcode} of orthogonal codes; N_{CM}≤N_{allcode} holds true. For example, N_{CM} orthogonal codes with code length Loc are represented as Code_{ncm}=[OC_{ncm}(1), OC_{ncm}(2), . . . , OC_{ncm}(Loc)]. Here, “OC_{ncm}(noc)” represents the nocth code element in ncmth orthogonal code Code_{ncm}. Further, “ncm” represents the index of an orthogonal code used for code multiplexing, and ncm=1, . . . , N_{CM}. Further, “noc” denotes the index of a code element, and noc=1, . . . , Loc.

As described above, N_{CM} orthogonal codes generated in code generator 104 are, for example, codes orthogonal to each other (in other words, uncorrelated codes). For example, a Walsh-Hadamard code may be used for an orthogonal code sequence. The code length of the Walsh-Hadamard code is a power of two, and an orthogonal code with each code length includes an orthogonal code equal in number to the code length. For example, the Walsh-Hadamard codes with code lengths of 2, 4, 8, and 16 include 2, 4, 8, and 16 orthogonal codes.

In the following, by way of example, code lengths Loc of the orthogonal code sequences with N_{CM} codes may be configured to satisfy following Expression 1:

(1)

Loc≥2^{ceil[log}^{₂}^{N}^{_{CM}}^{]} (Expression 1).

Here, ceil[x] is an operator (ceiling function) that outputs the smallest integer greater than or equal to real number x. In the case of the Walsh-Hadamard codes with code length Loc, the relation of N_{allcode}(Loc)=Loc holds. For example, since the Walsh-Hadamard codes with code lengths Loc=2, 4, 8, and 16 include 2, 4, 8, and 16 orthogonal codes, N_{allcode}(2)=2, N_{allcode}(4)=4, N_{allcode}(8)=8, and N_{allcode}(16)=16 hold. Code generator 104 uses, for example, N_{CM} orthogonal codes among N_{allcode}(Loc) codes included in a Walsh-Hadamard code with code length Loc.

Hereinafter, a description will be given of an example of orthogonal codes for each number N_{CM} of code multiplexing.

For example, in the case where number N_{CM} of code multiplexing is 3, code generator 104 determines three orthogonal codes among the Walsh-Hadamard codes with code length Loc=4 as the codes for code multiplexing transmission.

For example, code generator 104 may select Code₁=WH₄(3)=[1, 1, −1, −1], Code₂=WH₄(4)=[1, −1, −1, 1], and Code₃=WH₄(2)=[1, −1, 1, −1].

For example, code generator 104 may select N_{CM} orthogonal codes from among the Walsh-Hadamard codes with code length Loc in Expression 2 as codes for code multiplexing transmission. In this case, N_{CM}≤ Loc=N_{allcode}(Loc) holds.

(2)

Loc=2^{ceil[log}^{₂}^{N}^{_{CM}}^{]} (Expression 2)

Note that, code elements constituting an orthogonal code sequence are not limited to real numbers and may include complex number values.

Note also that the codes may also be other orthogonal codes different from the Walsh-Hadamard codes. For example, the codes may be orthogonal M-sequence codes or pseudo-orthogonal codes.

An example of the orthogonal codes in each case of number N_{CM} of code multiplexing has been described above.

Next, an exemplary phase rotation amount based on the codes for code multiplexing transmission generated in code generator 104 will be described.

For example, radar apparatus 10 performs code multiplexing transmission using different orthogonal codes for respective transmission antennas Tx #1 to Tx #NT that perform the code multiplexing transmission. For example, code generator 104 sets phase rotation amount ψ_{ncm}(m) based on orthogonal code Code_{ncm} that is to be applied to ncmth transmission antenna Tx #ncm at mth transmission period Tr, and outputs phase rotation amount ψ_{ncm}(m) to phase rotator 105. Here, ncm=1, . . . , N_{CM}.

For example, phase rotation amount ψ_{ncm}(m) cyclically applies phase amounts corresponding to Loc code elements OC_{ncm}(1), . . . , OC_{ncm}(Loc) of orthogonal code Code_{ncm} at each period of Loc (code length) times of transmission periods as given in following Expression 3:

(3)

ψ_{ncm}(m)=angle[OC_{ncm}(OC_INDEX)] (Expression 3).

Here, angle(x) is an operator outputting the radian phase of real number x, and for example, angle(1)=0, angle(−1)=π, angle(j)=π/2, and angle(−j)=−π/2. The character “j” is an imaginary unit. The character “OC_INDEX” represents an orthogonal code element index indicating an element of orthogonal code sequence Code_{ncm}, and cyclically varies in the range of from 1 to Loc at each transmission period (Tr), as given by following Expression 4:

(4)

OC_INDEX=mod(m−1,Loc)+1 (Expression 4).

Here, mod(x, y) denotes a modulo operator and is a function that outputs the remainder after x is divided by y. Further, m=1, . . . , Nc. Nc denotes the number of transmission periods used by radar apparatus 10 for radar positioning (hereinafter referred to as “radar-transmission-signal transmission times”). Further, radar apparatus 10, for example, performs radar-transmission-signal transmission times Nc of transmission, where Nc is an integer multiple of Loc (e.g., by a factor of Ncode). For example, Nc=Loc×Ncode.

Further, code generator 104 outputs, in each transmission period (Tr), orthogonal code element index OC_INDEX to output switch 209 of radar receiver 200.

Phase rotator 105 includes, for example, phase shifters or phase modulators corresponding respectively to Nₜₓ transmission antennas 106. For example, phase rotator 105 applies phase rotation amount ψ_{ncm}(m) inputted from code generator 104 to a chirp signal inputted from radar transmission signal generator 101 at each transmission period Tr.

For example, phase rotator 105 applies phase rotation amount ψ_{ncm}(m) based on orthogonal code Code_{ncm} to ncmth transmission antenna Tx #ncm for the chirp signal inputted from radar transmission signal generator 101 at each transmission period Tr. Here, ncm=1, . . . , N_{CM} and m=1, . . . , Nc.

Outputs from phase rotators 105 to Nix transmission antennas 106 are amplified to predetermined transmission powers, for example, and then radiated into space from Nₜₓ transmission antennas 106 (e.g., transmission array antenna).

By way of example, a description will be given of a case where code multiplexing transmission is performed with number N_{CM} of code multiplexing being equal to 3 and with number N_{Tx} of transmission antenna being equal to 3. Note that, number N_{Tx} of transmission antennas and number NM of code multiplexing are not limited these values.

For example, phase rotation amounts ψ₁(m), ψ₂(m), and ψ₃(m) are outputted from code generator 104 to phase rotator 105 at each mth transmission period Tr.

First (ncm=1) phase rotator 105 (for example, a phase shifter corresponding to first transmission antenna 106 (for example, Tx #1)) applies, at each transmission period Tr, phase rotation to the chirp signal generated in radar transmission signal generator 101 at each transmission period Tr as in following Expression 5. The output of first phase rotator 105 is transmitted from transmission antenna Tx #1. Here, cp(t) represents the chirp signal of mth transmission period Tr.

(5)

exp[jψ₁(1)]cp(t),exp[jψ₁(2)]cp(t),exp[jψ₁(3)]cp(t), . . . ,exp[jψ₁(Nc)]cp(t) (Expression 5)

Likewise, second (ncm=2) phase rotator 105 applies, at each transmission period Tr, phase rotation to the chirp signal generated in radar transmission signal generator 101 at each transmission period Tr as given by following Expression 6. The output of second phase rotator 105 is transmitted from transmission antenna Tx #2.

(6)

exp[jψ₂(1)]cp(t),exp[jψ₂(2)]cp(t),exp[jψ₂(3)]cp(t), . . . ,exp[jψ₂(Nc)]cp(t) (Expression 6)

Likewise, third (ncm=3) phase rotator 105 applies, at each transmission period Tr, phase rotation to the chirp signal generated in radar transmission signal generator 101 at each transmission period Tr as given by following Expression 7. The output of third phase rotator 105 is transmitted from transmission antenna Tx #3.

(7)

exp[jψ₃(1)]cp(t),exp[jψ₃(2)]cp(t),exp[jψ₃(3)]cp(t), . . . ,exp[jψ₃(Nc)]cp(t) (Expression 7)

Note that, when performing continuous radar positioning, radar apparatus 10 may configure, variably for each radar positioning (for example, per Nc transmission periods (Nc×Tr)), codes to be used as orthogonal code Code_{ncm}.

A configuration example of radar transmitter 100 has been described above.

### [Configuration of Radar Receiver 200]

In FIG. 6, radar receiver 200 includes Na reception antennas 202 (also referred to as Rx #1 to Rx #Na, for example), which constitute an array antenna. Radar receiver 200 further includes Na antenna system processors 201-1 to 201-Na, constant false alarm rate (CFAR) section 211, code demultiplexer 212, direction estimator 213.

Each of reception antennas 202 receives a reflected wave signal that is a radar transmission signal reflected from a target, and outputs the received reflected wave signal to the corresponding one of antenna system processors 201 as a reception signal.

Each of antenna system processors 201 includes reception radio 203 and signal processor 206.

Reception radio 203 includes mixer 204 and low pass filter (LPF) 205. Mixer 204 mixes the received reflected wave signal with a chirp signal inputted from radar transmission signal generator 101 which is a transmission signal. LPF 205 performs LPF processing on an output signal from mixer 204 to output a beat signal having a frequency depending on a delay time of the reflected wave signal. For example, as illustrated at the lower part of FIG. 7, the difference frequency between the frequency of a transmission chirp signal (transmission frequency-modulated wave) and the frequency of a reception chirp signal (reception frequency-modulated wave) is obtained as a beat frequency.

In each antenna system processor 201-z (where z is any of 1 to Na), signal processor 206 includes analog-to-digital (AD) converter 207, beat frequency analyzer 208, output switch 209, and Doppler analyzers 210.

The signal (for example, beat signal) outputted from LPF 205 is converted into discretely sampled data by AD converter 207 in signal processor 206.

Beat frequency analyzer 208 performs, in each transmission period Tr, FFT processing on N_{data} pieces of discretely sampled data obtained in a defined time range (range gate). Signal processor 206 thus outputs a frequency spectrum in which a peak appears at a beat frequency dependent on the delay time of the reflected wave signal (radar reflected wave). Note that, as the FFT processing, beat frequency analyzer 208 may perform multiplication by a window function coefficient such as the Han window or the Hamming window, for example. Radar apparatus 10 can suppress sidelobes that appear around the beat frequency peak by using the window function coefficient. In addition, when N_{data} pieces of discretely sampled data are not a power of 2, beat frequency analyzer 208 may include, for example, zero-padded data to obtain the FFT size of a power of 2 to perform FFT processing.

Here, a beat frequency response obtained from the mth chirp pulse transmission, which is outputted from beat frequency analyzer 208 in zth signal processor 206, is represented by RFT_{z}(f_{b}, m). Here, f_{b} denotes the beat frequency index and corresponds to an FFT index (bin number). For example, f_{b}=0, . . . , (N_{data}/2)−1, z=1, . . . , Na, and m=1, . . . , N_{C}. A beat frequency having smaller beat frequency index f_{b} indicates a shorter delay time of the reflected wave signal (for example, a shorter distance to the target object).

In addition, beat frequency index f_{b} may be converted into distance information R(f_{b}) using following Expression 8. Thus, in the following, beat frequency index f_{b} is also referred to as “distance index f_{b}.”

$$\begin{matrix}( Expression 8 ) & \\ R ( {f}_{b} ) = \frac{{C}_{0}}{2 {B}_{w}} {f}_{b} & ( 8 )\end{matrix}$$

Here, B_{w} denotes a frequency modulation bandwidth within the range gate for a chirp signal, and C₀ denotes the speed of light.

Output switch 209 performs selective switching to output the output of beat frequency analyzer 208 for each transmission period to OC_INDEXth Doppler analyzer 210 among Loc Doppler analyzers 210 based on orthogonal code element index OC_INDEX outputted from code generator 104. For example, output switch 209 selects OC_INDEXth Doppler analyzer 210 at mth transmission period Tr.

Signal processor 206 includes Loc Doppler analyzers 210-1 to 210-Loc. For example, data is inputted by output switch 209 to nocth Doppler analyzer 210 in each of Loc transmission periods (Loc×Tr). Accordingly, nocth Doppler analyzer 210 performs Doppler analysis for each distance index f_{b} using data of Ncode transmission periods among Nc transmission periods (for example, using beat frequency response RFT_{z}(f_{b}, m) inputted from beat frequency analyzer 208). Here, noc denotes the index of a code element, and noc=1, . . . , Loc.

For example, when Ncode is a power of 2, FFT processing may be applicable in the Doppler analysis. In this case, the FFT size is Ncode, and the maximum Doppler frequency at which no aliasing occurs and which is derived from the sampling theorem is ±1/(2Loc×Tr). Further, the Doppler frequency interval for Doppler frequency index fₛ is 1/(Ncode×Loc×Tr), and the range of Doppler frequency index fₛ is fₛ=−Ncode/2, . . . , 0, . . . , Ncode/2−1.

For example, output VFT_{z}^{noc}(f_{b}, fₛ) of Doppler analyzer 210 of zth signal processor 206 is given by following Expression 9. Here, j is the imaginary unit and z=1 to Na.

$$\begin{matrix}( Expression 9 ) & \\ {VFT}_{z}^{n o c} ( {f}_{b} , {f}_{s} ) = {\sum }_{s = 0}^{{N}_{code} - 1} {RFT}_{z} ( {f}_{b} , {L}_{OC} \times s + n o c ) exp [ - j \frac{2 π {sf}_{s}}{{N}_{code}} ] & ( 9 )\end{matrix}$$

Further, when Ncode is not a power of 2, zero-padded data may be included to perform FFT processing, with the data size (FFT size) being equal to a power of 2, for example. For example, when the FFT size in Doppler analyzer 210 for the case where the zero-padded data is included is denoted by N_{codewzero}, the output VFT_{z}^{noc}(f_{b}, fₛ) of Doppler analyzer 210 in zth signal processor 206 is given by following Expression 10:

$$\begin{matrix}( Expression 10 ) & \\ {VFT}_{z}^{n o c} ( {f}_{b} , {f}_{s} ) = {\sum }_{s = 0}^{{N}_{codewzero} - 1} {RFT}_{z} ( {f}_{b} , {L}_{OC} \times s + n o c ) exp [ - j \frac{2 π {sf}_{s}}{{N}_{c o d e w z e r o}} ] . & ( 10 )\end{matrix}$$

Here, noc denotes the index of a code element, and noc=1, . . . , Loc. Also, the FFT size is N_{codewzero}, and the maximum Doppler frequency at which no aliasing occurs and which is derived from the sampling theorem is +1/(2Loc×Tr). Further, the Doppler frequency interval of Doppler frequency index fₛ is 1/(N_{codewzero}×Loc×Tr), and the range of Doppler frequency index fₛ is fₛ=−N_{codewzero}/2, . . . , 0, . . . , N_{codewzero}/2−1.

The following description will be given of a case where Ncode is a power of 2, as an example. When zero-padding is used in Doppler analyzer 210, the following description is similarly applicable and similar effects can be obtained by replacement of Ncode with N_{codewzero} in the description.

In addition, for the FFT processing, Doppler analyzer 210 may perform multiplication by a window function coefficient such as the Han window or the Hamming window, for example. Radar apparatus 10 can suppress sidelobes generated around the beat frequency peak by applying a window function.

The processing in each component of signal processor 206 has been described above.

In FIG. 6, CFAR section 211 performs CFAR processing (for example, adaptive threshold judgement) using the outputs of Loc Doppler analyzers 210 in each of the first to Nath signal processors 206 and extracts distance indices f_{b_cfar} and Doppler frequency indices f_{s_cfar} that provide peak signals.

For example, CFAR section 211 performs power addition of outputs VFT_{z}^{noc}(f_{b}, fₛ) of Doppler analyzers 210 in first to Nath signal processors 206, for example, as given by following Expression 11, so as to perform two-dimensional CFAR processing in two dimensions formed by the distance axis and the Doppler frequency axis (corresponding to the relative velocity) or CFAR processing using two-dimensional and one-dimensional CFAR processing in combination. For example, processing disclosed in NPL 3 may be applied as the two-dimensional CFAR processing or the CFAR processing using two-dimensional and one-dimensional CFAR processing in combination.

$$\begin{matrix}( Expression 11 ) & \\ PowerFT ( {f}_{b} , {f}_{s} ) = {\sum }_{z = 1}^{{N}_{a}} {\sum }_{noc = 1}^{{L}_{oc}} {\vert {VFT}_{z}^{n o c} ( {f}_{b} , {f}_{s} ) \vert}^{2} & ( 11 )\end{matrix}$$

CFAR section 211 adaptively sets a threshold and outputs, to code demultiplexer 212, distance index f_{b_cfar} and Doppler frequency index f_{s_cfar} that provide a received power greater than the threshold, and received power information PowerFT(f_{b_cfar}, f_{s_cfar}).

Next, an operation example of code demultiplexer 212 will be described.

Code demultiplexer 212 performs separation processing of a code multiplexed signal based on distance index f_{b_cfar} and Doppler frequency index f_{s_cfar} extracted by CFAR section 211, for example.

For example, as given in following Expression 12, code demultiplexer 212 performs code demultiplexing processing on Doppler component VFTALL_{z}(f_{b_cfar}, f_{s_cfar}) that is the output of Doppler analyzer 210 corresponding to distance index f_{b_cfar} and Doppler frequency index f_{s_cfar} extracted by CFAR section 211.

(12)

DeMUL_{z}^{ncm}(f_{b_cfar},f_{s_cfar})=(Code_{ncm})*·{α(f_{s_cfar})⊗VFTALL_{z}(f_{b_cfar},f_{s_cfar})}^{T} (Expression 12)

Here, DeMul_{z}^{ncm}(f_{b_cfar}, f_{s_cfar}) is an output (e.g., code demultiplexing result) resulting from code demultiplexing of the code multiplexed signal using orthogonal code Code_{ncm} for the output of distance index f_{b_cfar} and Doppler frequency index f_{s_cfar} of Doppler analyzer 210 in zth antenna system processor 201. Note that, z=1, . . . , Na and ncm=1, . . . , N_{CM}.

Further, in Expression 12,

operator “⊗” (13)

represents a product between elements of vectors having the same number of elements. For example, for nth order vectors A=[a₁, . . . , aₙ] and B=[b₁, . . . , bₙ], the product between the elements is expressed by following Expression 13:

(14)

A⊗B=[a₁, . . . ,aₙ]⊗[b₁, . . . ,bₙ]=[a₁b₁, . . . ,aₙbₙ] (Expression 13)

Further, in Expression 12,

operator “●” (15)]

represents a vector dot product operator. In Expression 12, superscript “T” represents vector transposition, and superscript “*” (asterisk) represents a complex conjugate operator.

In Expression 12, “α(f_{s_cfar})” represents “Doppler phase correction vector.” Doppler phase correction vector α(f_{s_cfar}) corrects the Doppler phase rotation caused by a time difference between Doppler analyses of Loc Doppler analyzers 210 within Doppler aliasing range Dr when Doppler frequency index f_{s_cfar} extracted in CFAR section 211 is in an output range (for example, Doppler range) of Doppler analyzers 210 that does not include Doppler aliasing, for example.

For example, Doppler phase correction vector α(f_{s_cfar}) is expressed by following Expression 14. For example, Doppler phase correction vector α(f_{s_cfar}) as given by Expression 14 is a vector having, as an element, a Doppler phase correction factor. The Doppler phase correction factor corrects phase rotations of Doppler components having Doppler frequency indices f_{s_cfar} and being within Doppler aliasing range Dr. The phase rotations are caused by the time lags of Tr, 2Tr, . . . , (Loc−1)Tr of the outputs of from output VFT_{z}²(f_{b_cfar}, f_{s_cfar}) of second Doppler analyzer 210 to output VFT_{z}^{Loc}(f_{b_cfar}, f_{s_cfar}) of Locth Doppler analyzer 210, for example, with reference to the Doppler analysis time for analysis on output VFT_{z}¹(f_{b_cfar}, f_{s_cfar}) of first Doppler analyzer 210.

$$α ( {f}_{s \_ cfar} ) = [ 1 , exp [ - j \frac{2 π {f}_{s \_ cfar}}{{N}_{code}} \frac{1}{L o c} , exp [ - j \frac{2 π {f}_{s \_ cfar}}{{N}_{c o d e}} \frac{2}{Loc} , … , exp [ - j \frac{2 π {f}_{s \_ cfar}}{{N}_{c o d e}} \frac{L o c - 1}{L o c} ] \qquad ( 16 )$$

Note that, VFTALL_{z}(f_{b_cfar}, f_{s_cfar}) in Expression 12 is a representation in vector format of component VFT_{z}^{noc}(f_{b_cfar}, f_{s_cfar}) (where noc=1, . . . , Loc) corresponding to distance index f_{b_cfar} and Doppler frequency index f_{s_cfar} extracted in CFAR section 211, the component being from among outputs VFT_{z}^{noc}(f_{b}, fₛ) of Loc Doppler analyzers 210 in zth antenna system processor 201, for example, as given by following Expression 15.

(17)

VFTALL_{z}(f_{b_cfar},f_{s_cfar})=[VFT_{z}¹(f_{b_cfar},f_{s_cfar}),VFT_{z}²(f_{b_cfar},f_{s_cfar}) . . . ,VFT_{z}^{Loc}(f_{b_cfar},f_{s_cfar})] (Expression 15)

An operation example of code demultiplexer 212 has been described above. With reference to the configuration illustrated in FIG. 6, a description has been given of the operation of code demultiplexer 212 on the assumption that the maximum Doppler frequency at which no aliasing occurs and which is derived from the sampling theorem is ±1/(2Loc×Tr), and a target object detected by radar apparatus 10 is within this range.

Note that the configuration of radar apparatus 10 is not limited to the configuration illustrated in FIG. 6, and the range of detectable Doppler frequencies can be further expanded. For example, an aliasing determiner that determines whether or not a Doppler frequency component exceeding the maximum Doppler frequency of +1/(2Loc×Tr) is included in the output of the Doppler analyzer disclosed in FIG. 1 of PTL 1 may be provided to perform aliasing judgement processing, and the code demultiplexer may perform code demultiplexing using the judgment result.

However, in order to perform the aliasing judgement processing in the aliasing determiner of PTL 1, number N_{CM} of code multiplexing of the codes generated by the code generator in the radar transmitter is set smaller than number N_{allcode} of orthogonal codes this and is expressed as N_{CM}<N_{allcode}. For example, code length Loc of an orthogonal code is larger than number N_{CM} of code multiplexing.

By using such a configuration, the Doppler range in which detection is possible can be further expanded, and for example, the maximum Doppler frequency in which detection is possible can be ±1/(2×Tr). Therefore, it is possible to operate the code demultiplexer on the assumption that the target object detected by the radar apparatus is within the Doppler frequency range of ±1/(2×Tr).

Radar apparatus 10 may employ an arrangement of transmission antennas 106 and reception antennas 202 that can suppress grating lobes or sidelobes to increase angular resolution, for example, by increasing the array gain and increasing the aperture length by the virtual reception array.

Hereinafter, an example of the antenna arrangement of transmission antennas 106 and reception antennas 202, and an example of the direction estimation processing of direction estimator 213 in a case of application of each arrangement example will be described.

Further, in the following arrangement example and variations, the arrangement of transmission antennas 106 may be replaced with the antenna arrangement of reception antennas 202, and the arrangement of reception antennas 202 may be replaced with the arrangement of transmission antennas 106. In radar apparatus 10, even when the antenna arrangement of transmission antennas 106 and the antenna arrangement of reception antennas 202 are replaced with each other, it is possible to obtain the same effects as those in the following arrangement example.

In addition, the horizontal direction and the vertical direction in the following arrangement example and variations may be interchanged. In the case of the antenna arrangement in which the horizontal direction and the vertical direction are replaced with each other, radar apparatus 10 can obtain an effect of the following arrangement example in which the horizontal direction and the vertical direction are replaced with each other.

Note that the horizontal direction and the vertical direction in the arrangement example do not have to strictly coincide with the horizontal direction and the vertical direction, and the entire arrangement example may be inclined at a predetermined angle while maintaining the relative positional relation between the transmission antennas and the reception antennas included in the arrangement example. Also in this case, since the relative positional relation between the transmission antennas and the reception antennas included in the arrangement example is maintained, the same effects can be obtained.

The antenna arrangement (for example, MIMO antenna arrangement) of radar apparatus 10 may be, for example, an arrangement satisfying the following arrangement conditions.

### [Arrangement Condition 1]

N_{Tx} transmission antennas 106 are arranged in a predetermined arrangement direction at spacings of a wavelength equal to or greater than one wavelength. When three or more antennas are arranged, the antennas may be arranged at equal spacings. Note that some of N_{Tx} transmission antennas 106 may be arranged at different spacings. Further, radar apparatus 10 may include transmission antennas other than N_{Tx} transmission antennas 106.

Na reception antennas 202 include a “first oblique antenna group” of antennas arranged in a “first oblique direction” and a “second oblique antenna group” of antennas arranged in a “second oblique direction,” and the first oblique direction and the second oblique direction are not parallel to each other. For example, the first oblique direction and the second oblique direction are different directions. Radar apparatus 10 may include reception antennas other than Na reception antennas 202. Also, some of Na reception antennas 202 may be arranged at different spacings.

The first oblique antenna group and the second oblique antenna group may each include at least two reception antennas 202.

In addition, each of the first oblique direction and the second oblique direction may be a direction that does not coincide with a predetermined arrangement direction of transmission antennas 106. For example, the first oblique direction (e.g., corresponding to the first direction) in which the first oblique antenna group (e.g., corresponding to the first antenna group) is disposed, the second oblique direction (e.g., corresponding to the second direction) in which the second oblique antenna group (e.g., corresponding to the second antenna group) is disposed, and a direction in which a plurality of (e.g., N_{Tx}) transmission antennas 106 are arranged (e.g., corresponding to the third direction) may be different from one another.

Grating lobes can be suppressed by arranging the first oblique antenna group and the second oblique antenna group satisfying Arrangement Condition 1 at arbitrary positions. For example, as illustrated in the following arrangement example or variations, arrangement in which horizontal directions of both the first oblique antenna group and the second oblique antenna group do not overlap each other allows arrangement of antenna elements having a large size in the vertical direction.

Hereinafter, an example of Arrangement Condition 1 will be described. Hereinafter, an arrangement example satisfying Arrangement Condition 1 and an example of a direction estimation result of computer simulation in the arrangement example will be described.

Note that, in the following, by way of example, a direction coinciding with the horizontal direction is described as the direction in which a plurality of transmission antennas 106 are arranged, but the arrangement direction of transmission antennas 106 is not limited to the direction coinciding with the horizontal direction. For example, Variation 8 of Arrangement Example 1 to be described later illustrates an arrangement example in the case of a direction different from the horizontal direction.

### Arrangement Example 1

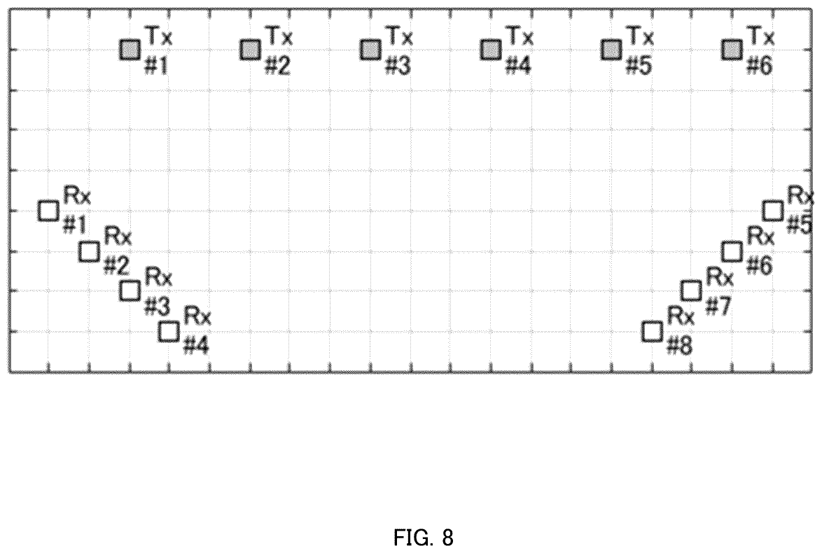

FIG. 8 is a diagram illustrating an arrangement example (for example, a MIMO antenna arrangement example) of transmission antennas 106 (for example, represented by Tx) and reception antennas 202 (for example, represented by Rx) under Arrangement Condition 1. In FIG. 8, the scales of the horizontal axis and the vertical axis are, for example, basic spacing D_{H} in the horizontal direction and basic spacing D_{V} in the vertical direction. Note that the scales of the horizontal axis and the vertical axis are the same for the MIMO antenna arrangements in the following other examples. By way of example, D_{H} and D_{V} may be spacings of 0.5 wavelengths.

In the example of FIG. 8, number N_{Tx} of transmission antennas is six (e.g., Tx #1, Tx #2, Tx #3, Tx #4, Tx #5 and Tx #6), and number Na of reception antennas is eight (e.g., Rx #1, Rx #2, Rx #3, Rx #5, Rx #6, Rx #7, and Rx #8).

In FIG. 8, N_{Tx} (=6) transmission antennas Tx #1 to #6 are arranged at equal spacings of 1.5 wavelengths in the horizontal direction (for example, the predetermined arrangement direction). For example, in Arrangement Example 1, all of the plurality of (e.g., N_{Tx}) transmission antennas 106 may be arranged in the predetermined direction (e.g., corresponding to the third direction). Further, in Arrangement Example 1, for example, the spacing between adjacent transmission antennas of the plurality of transmission antennas 106 may be a spacing of a wavelength equal to or greater than one wavelength of the radar transmission signal.

In addition, in FIG. 8, Na (=8) reception antennas Rx #1 to #8 include the first oblique antenna group of antennas Rx #1 to #4 arranged in the first oblique direction and the second oblique antenna group of antennas Rx #5 to #8 arranged in the second oblique direction. Here, in FIG. 8, the first oblique direction and the second oblique direction are not parallel to each other, differ from each other, and satisfy Arrangement Condition 1. As illustrated in FIG. 8, the first oblique direction, the second oblique direction, and the arrangement direction (e.g., horizontal direction) of transmission antennas 106 are not parallel to one another and differ from one another. Further, for example, as illustrated in FIG. 8, the first oblique direction and the second oblique direction are directions different from the vertical direction and the horizontal direction.

For example, antennas Rx #1 to #4 of the first oblique antenna group illustrated in FIG. 8 are horizontally shifted from one another by spacings of 0.5 wavelengths from left to right in the figure, and are also vertically shifted downward from one another by spacings of 0.5 wavelengths at the same time. Further, antennas Rx #5 to #8 of the second oblique antenna group illustrated in FIG. 8 are horizontally shifted from one another by spacings of 0.5 wavelengths from the right to the left in the figure, and are also vertically shifted downward from one another by spacings of 0.5 wavelengths at the same time.

As described above, in FIG. 8, the antenna arrangement of the first oblique antenna group of antennas arranged in the first oblique direction and the antenna arrangement of the second oblique antenna group of antennas arranged in the second oblique direction have line symmetry with respect to a line orthogonal to the third direction or a line parallel to the vertical direction. For example, the first oblique antenna group of antennas Rx #1 to #4 and the second oblique antenna group of antennas Rx #5 to #8 are arrangement having horizontal inversion symmetry (which is also referred to as left-right inversion symmetry or mirror symmetry).

Further, in FIG. 8, in each of the plurality of transmission antennas Tx #1 to #6, the first oblique antenna group of antennas Rx #1 to #4, and the second oblique antenna group of antennas Rx #5 to #8, the distance between adjacent antennas is equal.

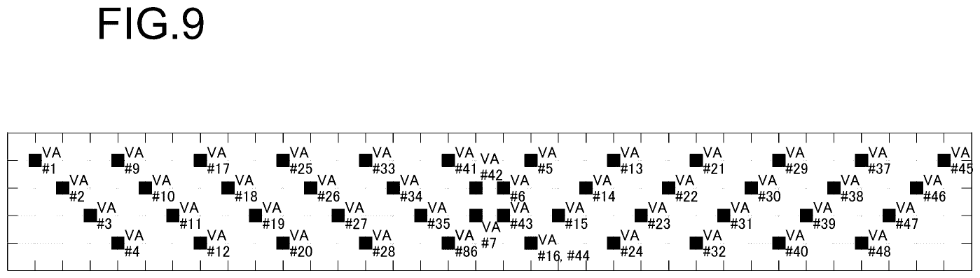

FIG. 9 is a diagram illustrating an arrangement example of a virtual reception array obtained by the antenna arrangement illustrated in FIG. 8. In FIG. 9, the scales of the horizontal axis and the vertical axis are, for example, basic spacing D_{H} in the horizontal direction and basic spacing D_{V} in the vertical direction. Note that the scales on the horizontal axis and the vertical axis are the same in virtual reception array arrangements in the following other examples.

Here, the arrangement of the virtual reception array may be expressed by following Expression 16, for example, based on the positions of transmission antennas 106 constituting the transmission array antenna (for example, the positions of feed points) and the positions of reception antennas 202 constituting the reception array antenna (for example, the positions of feed points).

$$\begin{matrix}( Expression 16 ) & \\ \{ \begin{matrix}{X}_{V \_ \# k} = ( {X}_{T \_ \# [ ceil ( k / Na ) ]} - {X}_{T \_ \#1} ) + ( {X}_{R \_ \# [ mod ( k - 1 , Na ) + 1 ]} - {X}_{R \_ \#1} ) \\ {Y}_{V \_ \# k} = ( {Y}_{T \_ \# [ ceil ( k / Na ) ]} - {Y}_{T \_ \#1} ) + ( {Y}_{R \_ \# [ mod ( k - 1 , Na ) + 1 ]} - {Y}_{R \_ \#1} )\end{matrix} & ( 18 )\end{matrix}$$

Here, the position coordinates of transmission antennas 106 (e.g., Tx #n) constituting the transmission array antenna are represented as (X_{T_#n}, Y_{T_#n}) (e.g., n=1, . . . , N_{Tx}), the position coordinates of reception antennas 202 (e.g., Rx #m) constituting the reception array antenna are represented as (X_{R_#m}, Y_{R_#m}) (e.g., m=1, . . . , Na), and the position coordinates of virtual antennas VA #k constituting a virtual reception array antenna are represented as (X_{V_#k}, Y_{V_#k}) (e.g., k=1, . . . , N_{Tx}×Na).

In Expression 16, for example, VA #1 is expressed as the position reference (0, 0) of the virtual reception array.

For example, from the arrangement of transmission antennas Tx #1 to Tx #6 and the arrangement of reception antennas Rx #1 to Rx #8 as illustrated in FIG. 8, the position coordinates of virtual antennas VA #1 to #48 constituting the virtual reception array antenna are calculated from Expression 16. As an example, the position coordinates of virtual antennas VA #1 to #16 are

$$( {X}_{V \_ \#1} , {Y}_{V \_ \#1} ) = ( 0 , 0 ) , ( {X}_{V \_ \#2} , {Y}_{V \_ \#2} ) = ( {D}_{H} , - {D}_{V} ) , ( {X}_{V \_ \#3} , {Y}_{V \_ \#3} ) = ( 2 {D}_{H} , - 2 {D}_{V} ) , ( {X}_{V \_ \#4} , {Y}_{V \_ \#4} ) = ( 3 {D}_{H} , - 3 {D}_{V} ) , ( {X}_{V \_ \#5} , {Y}_{V \_ \#5} ) = ( 18 {D}_{H} , 0 ) , ( {X}_{V \_ \#6} , {Y}_{V \_ \#6} ) = ( 17 {D}_{H} , - {D}_{V} ) , ( {X}_{V \_ \#7} , {Y}_{V \_ \#7} ) = ( 16 {D}_{H} , - 2 {D}_{V} ) , ( {X}_{V \_ \#8} , {Y}_{V \_ \#8} ) = ( 15 {D}_{H} , - 3 {D}_{V} ) , ( {X}_{V \_ \#9} , {Y}_{V \_ \#9} ) = ( 3 {D}_{H} , 0 ) , ( {X}_{V \_ \#10} , {Y}_{V \_ \#10} ) = ( 4 {D}_{H} , - {D}_{V} ) , ( {X}_{V \_ \#11} , {Y}_{V \_ \#11} ) = ( 5 {D}_{H} , - 2 {D}_{V} ) , ( {X}_{V \_ \#12} , {Y}_{V \_ \#12} ) = ( 6 {D}_{H} , - 3 {D}_{V} ) , ( {X}_{V \_ \#13} , {Y}_{V \_ \#13} ) = ( 21 {D}_{H} , 0 ) , ( {X}_{V \_ \#14} , {Y}_{V \_ \#14} ) = ( 20 {D}_{H} , - {D}_{V} ) , ( {X}_{V \_ \#15} , {Y}_{V \_ \#15} ) = ( 19 {D}_{H} , - 2 {D}_{V} ) , ( {X}_{V \_ \#16} , {Y}_{V \_ \#16} ) = ( 18 {D}_{H} , - 3 {D}_{V} ) .$$

In FIG. 9, VA #16 and VA #44 are arranged at the same positions in an overlapping manner. In addition, VA #8 and VA #36 are arranged at the same positions in an overlapping manner.

Here, the case of FIGS. 8 and 9 is described in which D_{H} and D_{V} are set to 0.52, but D_{H} and D_{V} may also be set, for example, to values of approximately 0.452 to 0.82 (e.g., any value ranging from 0.5 to 0.8 times the wavelength of the radar transmission signal). Each of D_{H} and D_{V} may be set according to the viewing angle of radar apparatus 10 in the horizontal direction or vertical direction. For example, when the viewing angle in the horizontal or vertical direction is a wide viewing angle ranging from about +70 degrees to about 90 degrees, D_{H} or D_{V} may be about 0.52. Alternatively, when the viewing angle in the horizontal or vertical direction is a narrow viewing angle ranging from +20 degrees to 40 degrees, D_{H} or D_{V} may be set to a wider spacing of, for example, about 0.72. The setting of D_{H} and D_{V} is the same for the following arrangement examples (or variations). Note that λ represents the wavelength of the carrier frequency of the radar transmission signal.

For example, when a chirp signal is used as the radar transmission signal, A is the wavelength of the center frequency in the frequency sweep band of the chirp signal.

Next, an example of direction estimation processing performed by direction estimator 213 in the case where the above-described antenna arrangement is applied will be described.

In FIG. 1, direction estimator 212 performs target direction estimation processing based on code demultiplexing result DeMul₂^{ncm}(f_{b_cfar}, f_{s_cfar}) for the output of Doppler analyzer 210 corresponding to distance index f_{b_cfar} and Doppler frequency index f_{s_cfar} inputted from code demultiplexer 213.

For example, direction estimator 213 generates virtual reception array correlation vector h(f_{b_cfar}, f_{s_cfar}) given by following Expression 17 to perform the direction estimation processing.

Virtual reception array correlation vector h(f_{b_cfar}, f_{s_cfar}) includes N_{Tx}×Na elements, the number of which is the product of number N_{Tx} of transmission antennas and number Na of reception antennas. Virtual reception array correlation vector h(f_{b_cfar}, f_{s_cfar}) is used in processing for performing, on reflected wave signals from a target, direction estimation based on a phase difference between reception antennas 202. Here, z=1, . . . , Na.

For example, in the example of FIG. 8 for the MIMO antenna arrangement of Arrangement Example 1, N_{Tx}=6 and Na=8. Thus, virtual reception array correlation vector h(f_{b_cfar}, f_{s_cfar}) includes 48 elements, and the elements correspond respectively to reception signals of VA #1 to VA48 in the virtual reception array arrangement illustrated in FIG. 9. For example, VA #1 corresponds to first element DeMul₁¹(f_{b_cfar}, f_{s_cfar} of column vector elements h(f_{b_cfar}, f_{s_cfar}). Similarly, the second element corresponds to the reception signal of VA #2, . . . , and the 48th element corresponds to the reception signal of VA #48.

$$\begin{matrix}( Expression 17 ) & \\ h ( {f}_{b \_ cfar} , {f}_{s \_ cfar} ) = [ \begin{matrix}{DeMUL}_{1}^{1} ( {f}_{b \_ cfar} , {f}_{s \_ cfar} ) \\ {DeMUL}_{2}^{1} ( {f}_{b \_ cfar} , {f}_{s \_ cfar} ) \\ ⋮ \\ {DeMUL}_{Na}^{1} ( {f}_{b \_ cfar} , {f}_{s \_ cfar} ) \\ {DeMUL}_{1}^{2} ( {f}_{b \_ cfar} , {f}_{s \_ cfar} ) \\ ⋮ \\ {DeMUL}_{Na}^{2} ( {f}_{b \_ cfar} , {f}_{s \_ cfar} ) \\ ⋮ \\ {DeMUL}_{1}^{{N}_{Tx}} ( {f}_{b \_ cfar} , {f}_{s \_ cfar} ) \\ ⋮ \\ {DeMUL}_{Na}^{{N}_{Tx}} ( {f}_{b \_ cfar} , {f}_{s \_ cfar} )\end{matrix} ] & ( 19 )\end{matrix}$$

Next, direction estimator 213 performs the direction estimation processing in the horizontal and vertical directions using, for example, virtual reception array correlation vector h(f_{b_cfar}, f_{s_cfar}), which is a reception signal of the virtual reception array composed of the above-described transmission and reception antenna arrangement.

For example, direction estimator 213 multiplies virtual reception array correlation vector h(f_{b_cfar}, f_{s_cfar}) by array correction value h_cal_{[y]} that corrects the phase deviation and the amplitude deviation between the transmission array antennas and the reception array antennas, as given in following Expression 18, thereby outputting virtual reception array correlation vector h__{after_cal}(f_{b_cfar}, f_{s_cfar}) in which the inter-antenna deviations are corrected. Then, direction estimator 213 performs the direction estimation processing in the horizontal direction and the vertical direction based on phase differences of incoming reflected waves between the reception antennas. Here, y=1, . . . , (N_{Tx}×Na).

$${h}_{\_ after \_ cal} ( {f}_{b \_ cfar} , {f}_{s \_ cfar} ) = CA \times h ( {f}_{b \_ cfar} , {f}_{s \_ cfar} ) = [ \begin{matrix}{h}_{1} ( {f}_{b \_ cfar} , {f}_{s \_ cfar} ) \\ {h}_{2} ( {f}_{b \_ cfar} , {f}_{s \_ cfar} ) \\ ⋮ \\ {h}_{{N}_{Tx} \times Na} ( {f}_{b \_ cfar} , {f}_{s \_ cfar} )\end{matrix} ] \qquad ( 20 )$$

$$\begin{matrix}( Expression 18 ) & \\ CA = [ \begin{matrix}{h\_cal}_{[ 1 ]} & 0 & … & 0 \\ 0 & {h\_cal}_{[ 2 ]} & ⋱ & … \\ ⋮ & ⋱ & ⋱ & 0 \\ 0 & … & 0 & {h\_cal}_{[ {N}_{Tx} \times Na ]}\end{matrix} ] & ( 21 )\end{matrix}$$

Note that, “CA” is a (N_{Tx}×Na)-order square matrix including an array correction coefficient for correcting the phase deviation and the magnitude deviation between the transmission antennas and the reception antennas, and a coefficient for reducing the influence of coupling of elements between the antennas. When the coupling between the antennas of the virtual reception array is negligible, CA is a diagonal matrix, and the diagonal components include array correction value h_cal_{[y]} that corrects the phase and amplitude deviations between the transmission antennas and the reception antennas.

Virtual reception array correlation vector h__{after_cal}(f_{b_cfar}, f_{s_cfar}) in which the inter-antenna deviations are corrected is a column vector composed of N_{Tx}×Na elements. In the following description, such elements are expressed as follows and used for the direction estimation processing. Note that each of the elements is a complex value, and represents an amplitude component and a phase component received by each virtual reception antenna.

h₁(f_{b_cfar},f_{s_cfar}), . . . ,h_{N}_{_{Tx}}_{×Na}(f_{b_cfar},f_{s_cfar}) (22)

Direction estimator 213 performs direction estimation in the horizontal and vertical directions using virtual reception array correlation vector h__{after_cal}(f_{b_cfar}, f_{s_cfar}) in which the inter-antenna deviations are corrected. In the direction estimation in the horizontal and vertical directions, direction estimator 213 calculates a spatial profile, for example, with direction-of-arrival estimation evaluation function value P (θ, Φ, f_{b_cfar}, f_{s_cfar}) in which azimuth direction θ and elevation direction Φ are variable within defined angular ranges. Direction estimator 213 extracts a predetermined number of local maximum peaks in the calculated spatial profile in descending order and outputs the azimuth and elevation directions of the local maximum peaks as direction-of-arrival estimation values (for example, positioning outputs).

Note that, there are various methods with direction-of-arrival estimation evaluation function value P (θ, Φ, f_{b_cfar}, f_{s_cfar}) depending on direction-of-arrival estimation algorithms. For example, an estimation method using an array antenna disclosed in NPL 4 may be used.

For example, a beamformer method can be given by following Expression 19. Here, superscript H denotes the Hermitian transpose operator. In addition, a technique such as Capon or MUSIC is also applicable.

(23)

P(θᵤ,ϕᵥ,f_{b_cfar},f_{s_cfar})=|a^{H}(θᵤ,ϕᵥ)h__{after_cal}(f_{b_cfar},f_{s_cfar})|² (Expression 19)

Here, azimuth direction θᵤ is a vector that is changed at azimuth interval β₁ within azimuth range θ min to θ max over which direction-of-arrival estimation is performed. For example, θᵤ may be set as follows.

θᵤ=θ min+uβ₁,u=0, . . . ,NU

NU=floor[(θ max−θ min)/β₁]

Here, floor(x) is a function that returns the largest integer value not greater than real number x.

In addition, elevation direction Φᵥ is a vector that is changed at azimuth interval ß2 within azimuth range Φ min to Φ max over which the direction-of-arrival estimation is performed. For example, Φᵥ may be set as follows.

Φᵥ=Φ min+vβ₂,v=0, . . . ,NV

NV=floor[(Φ max−Φ min)/β₂]

In the present embodiment, radar apparatus 10 may calculate in advance directional vector a(θᵤ, Φᵥ), for example, based on virtual reception array arrangement VA #1, . . . , VA #(N_{Tx}×Na). Here, direction vector a(θᵤ, Φᵥ) is a (N_{Tx}×Na)th order column vector with elements of complex responses of the virtual reception array antenna obtained when radar reflected waves arrive from azimuth direction θ and elevation direction Φ. Complex responses a(θᵤ, Φᵥ) of the virtual reception array antenna represent phase differences calculated geometrically and optically for the element spacings between the antennas.

Here, as an example, the normal direction of a normal to the front surface is referred to as a reference (azimuth θ=0 degrees and elevation Φ=0 degrees) with respect to the antenna surface illustrated in Arrangement Example 1.

Next, an example of a direction estimation result (computer simulation result) in the case where the antenna arrangement according to above-described Arrangement Example 1 is applied will be described.

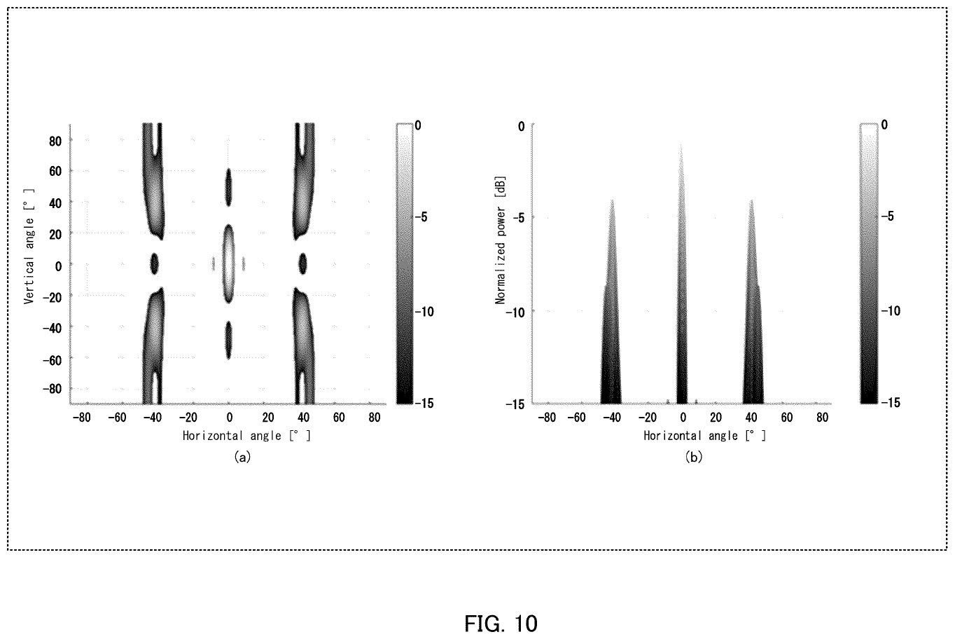

FIG. 10 illustrates a direction estimation result obtained when a MIMO array arrangement (D_{H}=0.5%, D_{V}=0.52) of Arrangement Example 1 is used and the beamformer method is used as a direction-of-arrival estimation algorithm of direction estimator 213. By way of example, FIG. 10 illustrates plotted outputs of the direction-of-arrival estimation evaluation function values as obtained within the range of +90 degrees in the horizontal direction and within the range of +90 degrees in the vertical direction on the assumption that the target true value is at horizontal 0 degrees and vertical 0 degrees. Here, the figure shows the result obtained when each single antenna of the transmission antennas and the reception antennas has omni-directivity, and direction estimation results (computer simulation results) in the following other examples also illustrate results in the case of omni-directivity.

Note that (a) in FIG. 10 is a diagram illustrating normalized power values in two-dimensional directions of the horizontal direction as the horizontal axis and the vertical direction as the vertical axis in a grayscale color map. Further, with respect to (a) of FIG. 10, (b) of FIG. 10 illustrates a grayscale color map in which the horizontal axis denotes the horizontal direction, and the vertical axis denotes the normalized power values. Note that, in FIG. 10, the normalized power values may be expressed by, for example, a decibel value (dB) normalized by the peak power, and the same applies to plots of direction estimation results in the other examples below.

Here, in Arrangement Example 1 illustrated in FIG. 8, transmission antennas 106 are arranged at spacings of 1.5 wavelengths (1.5λ) in the horizontal direction, reception antennas 202 are arranged at spacings of a wavelength equal to or higher than 6 wavelengths in the horizontal direction, and the virtual antennas in the virtual reception array arrangement illustrated in FIG. 9 are arranged at spacings of a wavelength equal to or greater than one wavelength in the horizontal direction. The antenna spacings are antenna spacings in which grating lobes can be generated. For example, when the target direction is 0 degrees in the horizontal direction, grating lobes may be generated at −41.8 degrees and 41.8 degrees in the horizontal direction.

Note that, in Arrangement Example 1, it is possible to suppress the grating lobes even when reception antennas 202 are arranged, for example, at spacings of a wavelength equal to or higher than 6.5 in the horizontal direction and the virtual antennas of the virtual reception array arrangement are arranged in the horizontal direction at spacings of a wavelength equal to or greater than one wavelength. For example, as illustrated in FIG. 10, it can be seen that the grating lobes are suppressed in directions that differ from the peak direction of the target-true-value direction.

In the following, a description will be given of a principle of suppressing the grating lobes by the MIMO antenna arrangement in Arrangement Example 1.

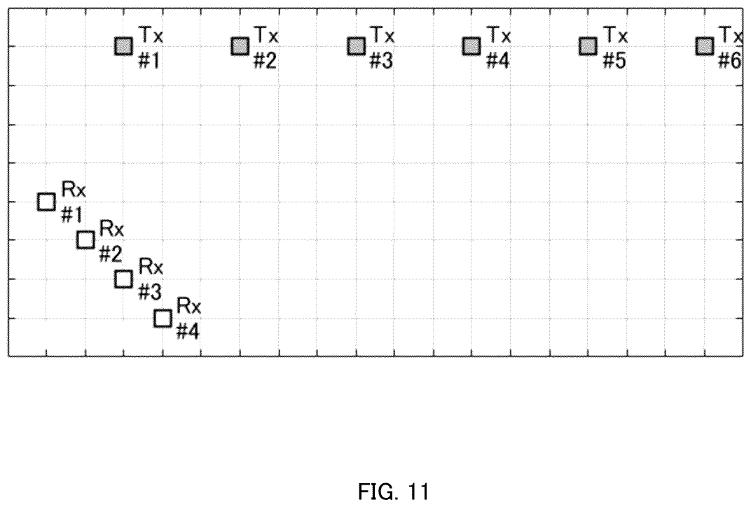

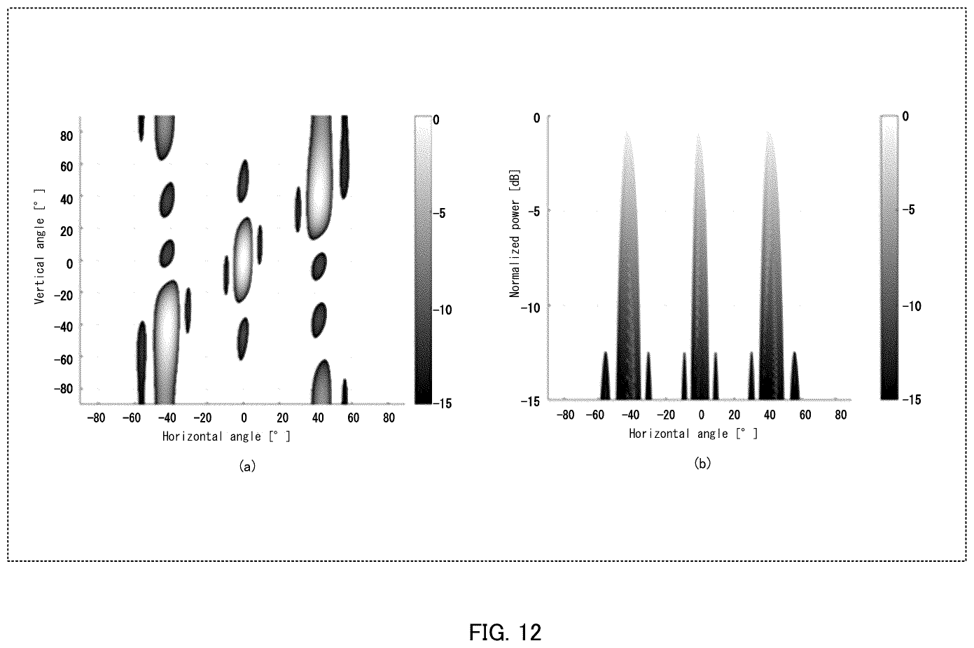

FIG. 11 illustrates an antenna arrangement (hereinafter referred to as “Comparative Arrangement 1”) in which the first oblique antenna group of antennas Rx #1 to #4 among reception antennas 202 of Arrangement Example 1 illustrated in FIG. 8 are used for comparison with Arrangement Example 1. In addition, FIG. 12 illustrates the direction estimation result obtained using the beamformer method when Comparative Arrangement 1 is applied. Like FIG. 10, FIG. 12 illustrates plotted outputs of the direction-of-arrival estimation evaluation function values as obtained within the range of +90 degrees in the horizontal direction and within the range of +90 degrees in the vertical direction on the assumption that the target true value is at horizontal 0 degrees and vertical 0 degrees.

Note that, when the first oblique antenna group of antennas Rx #1 to #4 among reception antennas 202 of Arrangement Example 1 are used as in Comparative Arrangement 1, the virtual reception array arrangement corresponds to VA #1 to #4, #9 to #12, #17 to #20, #25 to #28, #33 to #36, and #41 to #44 of FIG. 9.

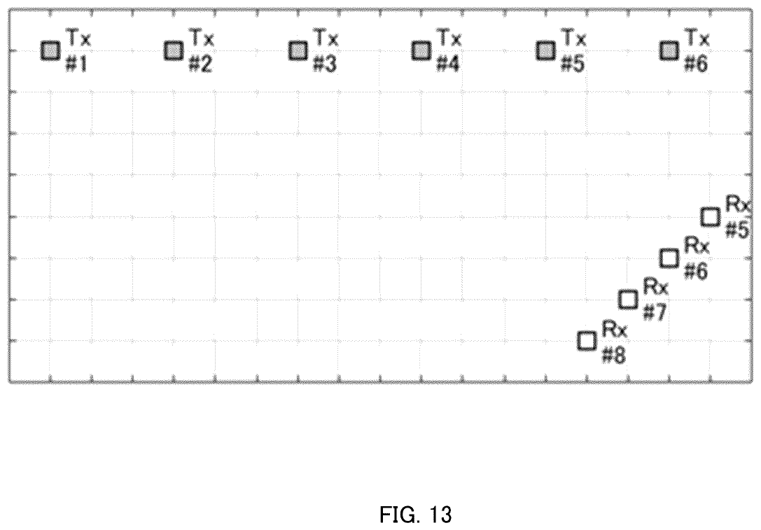

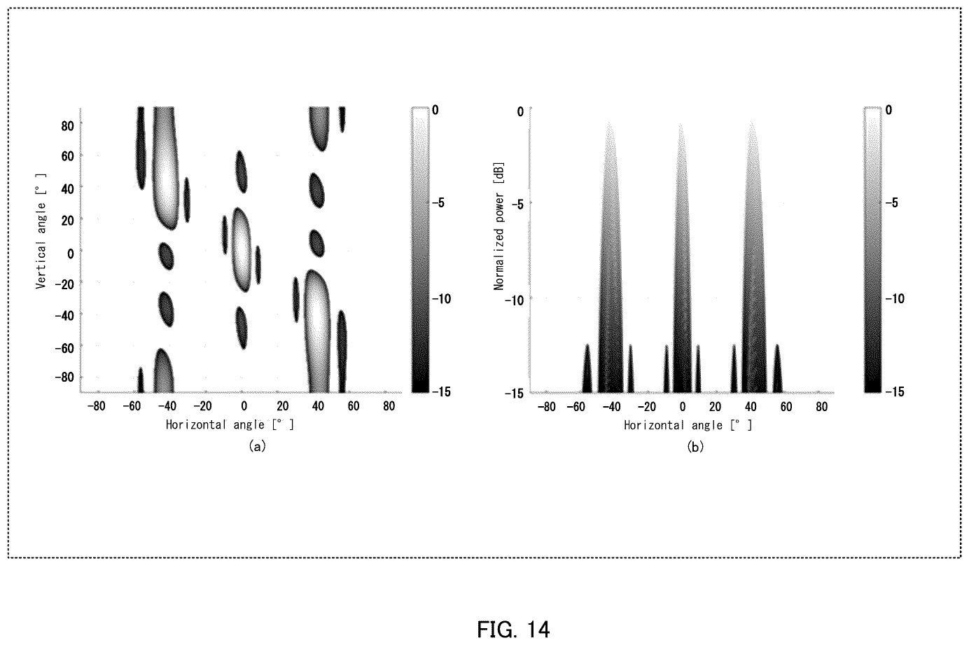

Similarly, FIG. 13 illustrates an antenna arrangement (hereinafter referred to as “Comparative Arrangement 2”) in which the second oblique antenna group of antennas Rx #5 to #8 among reception antennas 202 of Arrangement Example 1 illustrated in FIG. 8 are used for comparison with Arrangement Example 1. In addition, FIG. 14 illustrates the direction estimation result obtained using the beamformer method when Comparative Arrangement 2 is applied. Like FIG. 10, FIG. 14 illustrates plotted outputs of the direction-of-arrival estimation evaluation function values as obtained within the range of +90 degrees in the horizontal direction and within the range of +90 degrees in the vertical direction on the assumption that the target true value is at horizontal 0 degrees and vertical 0 degrees.

Note that, when the second oblique antenna group of antennas Rx #5 to #8 among reception antennas 202 of Arrangement Example 1 are used as in Comparative Arrangement 2, the virtual reception array arrangement corresponds to VA #5 to #8, #13 to #16, #21 to #24, #29 to #32, #37 to #40, and #45 to #48 of FIG. 9.

For example, when the first oblique antenna group of antennas Rx #1 to #4 among reception antennas 202 of Arrangement Example 1 illustrated in FIG. 8 are used as in Comparative Arrangement 1 illustrated in FIG. 11, grating lobes are generated in two directions of a direction (at −41.8 degrees in the horizontal direction and at −41.8 degrees in the vertical direction) and a direction (at +41.8 degrees in the horizontal direction and at +41.8 degrees in the vertical direction) in the direction estimation result (e.g., (a) and (b) of FIG. 12) obtained using the beamformer method as the direction-of-arrival estimation algorithm of direction estimator 213 with respect to the target true values (e.g., at horizontal 0 degrees and vertical 0 degrees).

Further, for example, when the second oblique antenna group of antennas Rx #5 to #8 among reception antennas 202 of Arrangement Example 1 illustrated in FIG. 8 are used as in Comparative Arrangement 2 illustrated in FIG. 13, grating lobes are generated in two directions of a direction (at +41.8 degrees in the horizontal direction and at +41.8 degrees in the vertical direction) and a direction (at −41.8 degrees in the horizontal direction and at −41.8 degrees in the vertical direction) in the direction estimation result (e.g., (a) and (b) of FIG. 14) obtained using the beamformer method as the direction-of-arrival estimation algorithm of direction estimator 213 with respect to the target true values (e.g., at horizontal 0 degrees and vertical 0 degrees).

Here, the arrangement direction of reception antennas Rx #1 to #4 (for example, corresponding to the first oblique antenna group) of Comparative Arrangement 1 illustrated in FIG. 11 and the arrangement direction of reception antennas Rx #5 to #8 (for example, corresponding to the second oblique antenna group) of Comparative Arrangement 2 illustrated in FIG. 13 are not parallel to each other and are different from each other. Therefore, as illustrated in FIGS. 12 and 14, there are characteristics that the horizontal and vertical two-dimensional angular directions in which the grating lobes are generated are not identical to each other and are deviated from each other between Comparative Arrangement 1 and Comparative Arrangement 2.

On the other hand, as illustrated in FIGS. 12 and 14, the angular directions (e.g., horizontal 0 degrees and vertical 0 degrees) of the main lobes corresponding to the target true values coincide with each other between Comparative Arrangement 1 and Comparative Arrangement 2.

Therefore, as illustrated in FIG. 8, generation directions (two-dimensional angular directions) of the grating lobes generated in Comparative Arrangement 1 including the first oblique antenna group and the grating lobes generated in Comparative Arrangement 2 including the second oblique antenna group do not coincide with each other and are likely to be distributed in Arrangement Example 1 including the first oblique antenna and the second oblique antenna. Therefore, in Arrangement Example 1, as illustrated at (a) and (b) of FIG. 10, the peak levels in the grating-lobe directions are more likely to be suppressed than the peak in the target-true-value direction.

Note that, for example, as illustrated in FIG. 8, when the arrangement directions of the first oblique antenna group and the second oblique antenna group have horizontal inversion symmetry, the virtual reception array arrangements corresponding respectively to Comparative Arrangement 1 and Comparative Arrangement 2 have horizontal inversion symmetry. Thus, in Comparative Arrangement 1 and Comparative Arrangement 2, the horizontal and vertical two-dimensional directions in which the grating lobes are generated have horizontal inversion symmetry, and as illustrated in FIGS. 12 and 14, deviations in the horizontal and vertical two-dimensional angular directions in which the grating lobes are generated become larger.

Therefore, in Arrangement Example 1, when the arrangement directions (for example, the oblique direction) of the first oblique antenna group and the second oblique antenna group have horizontal inversion symmetry, for example, as illustrated in FIG. 8, the directions in which the grating lobes are generated have horizontal inversion symmetry, and the spacing (or deviation) between the directions of the suppressed grating lobes is likely to be larger as illustrated in FIG. 10.

It is preferable that the arrangement in which the arrangement directions of the first oblique antenna group and the second oblique antenna group have horizontal inversion symmetry include a smaller number of antennas of radar apparatus 10, for example. For example, the smaller the number of antennas of radar apparatus 10, the wider the beam width of the main beam in the direction estimation is likely to be. Thus, when the directions of the suppressed grating lobes are close to each other, the power of the grating lobes may increase as a result of power overlap between the grating lobes, which is caused by the larger beam width due to the smaller number of antennas of radar apparatus 10. Therefore, as the number of antennas of radar apparatus 10 decreases, the suppression performance for suppressing the grating lobes deteriorates, and the probability of erroneous detection in radar apparatus 10 tends to increase. As a countermeasure, when the number of antennas of radar apparatus 10 is small, for example, the power overlap between the grating lobes can be suppressed by the arrangement in which the arrangement directions of the first oblique antenna group and the second oblique antenna group have horizontal inversion symmetry, and thus the suppression performance for suppressing the grating lobes can be improved.

Further, as illustrated in FIG. 8, Arrangement Example 1 is the arrangement in which transmission antennas 106 are arranged in a row in the horizontal direction, and reception antennas 202 are arranged in rows in the oblique directions. For example, as illustrated in FIG. 8, in Arrangement Example 1, both transmission antennas 106 and reception antennas 202 are arranged such that the antenna elements do not vertically overlap one another. Therefore, in Arrangement Example 1, an antenna element having a larger size in the vertical direction (for example, a size equal to or greater than one wavelength) can be placed.

Therefore, in Arrangement Example 1, an antenna gain in the vertical direction can be improved by narrowing the directivity in the vertical direction using, for example, a sub-array antenna composed of a plurality of antenna elements arranged in the vertical direction.

Note that the spacing between transmission antennas 106 and reception antennas 202 may be sufficiently larger than the antenna element size, or the transmission and reception antennas may be shifted to each other in the horizontal direction so as not to overlap each other in the vertical direction.

As described above, in Arrangement Example 1, the antenna arrangement is an antenna arrangement in which the antenna elements with any size in the upper-lower direction (for example, in the vertical direction) can be used, and is an antenna arrangement in which grating lobes generated in the virtual reception array can be suppressed.

It should be noted that even when the first oblique antenna group and the second oblique antenna group illustrated in FIG. 8 are arranged at any respective positions, the same grating-lobe suppression effect can be obtained. For example, in Arrangement Example 1, the arrangement of the first oblique antenna group of antennas Rx #1 to Rx #4 and the second oblique antenna group of antennas Rx #5 to Rx #8 are set such that the positions of the first oblique antenna group and the second oblique antenna group in the horizontal direction do not overlap each other. Accordingly, it becomes possible to arrange antenna elements having a vertically larger size.

As described above, an example of the direction estimation result (computer simulation result) in Arrangement Example 1 and the effect of Arrangement Example 1 have been described.

In FIG. 6, direction estimator 213 may output, for example, the direction estimation result, and may further output, as a positioning result, distance information based on the distance index f_{b_cfar} (for example, information converted based on Expression 8), and Doppler velocity information of the target based on Doppler frequency index f_{s_cfar} of the target. Direction estimator 213 may output the positioning result, for example, to a control apparatus of a vehicle in the case of an in-vehicle radar or to an infrastructure control apparatus in the case of an infrastructure radar (not illustrated).

Following Expression 20 may be used to convert Doppler frequency index f_{s_cfar} into relative velocity component v_{d}(f_{s_cfar}). Here, λ is the wavelength of the carrier frequency of an RF signal outputted from a transmission radio (not illustrated). Further, Δ_{f} denotes the Doppler frequency interval in FFT processing performed in Doppler analyzer 210. For example, in the present embodiment, Δ_{f}=1/{Loc×N_{code}×Tr}.

$$\begin{matrix}( Expression 20 ) & \\ {v}_{d} ( {f}_{s \_ cfar} ) = \frac{λ}{2} {f}_{s \_ cfar} {Δ}_{f} & ( 24 )\end{matrix}$$

The exemplary operation of radar apparatus 10 has been described above.

As described above, in Arrangement Example 1, in radar apparatus 10, reception antenna 202 includes, for example, the first oblique antenna group disposed in the first oblique direction and the second oblique antenna group disposed in the second oblique direction. Further, in the antenna arrangement of radar apparatus 10, the first oblique direction, the second oblique direction, and a predetermined direction (for example, the horizontal direction) in which the plurality of transmission antennas 106 are arranged are different from one another.

According to the configuration of the present antenna arrangement, radar apparatus 10 can use antenna elements having any size in the upper-lower direction (for example, vertical size) in the MIMO array arrangement, and can suppress grating lobes generated in the virtual reception array.

Further, in Arrangement Example 1, as described above, the difference in the arrangement directions of the first oblique antenna group and the second oblique antenna group of reception antennas 202 provides the suppression effect for suppressing the grating lobes. Therefore, in Arrangement Example 1, for example, the element spacings of transmission antennas 106 can be arbitrarily set. In addition, in Arrangement Example 1, the spacing between the first oblique antenna group and the second oblique antenna group can be arbitrarily set. Thus, for example, the aperture length of the virtual reception array can be increased in accordance with the setting of at least one of the element spacings between transmission antennas 106 and the spacing between the first oblique antenna group and the second oblique antenna group. Accordingly, the angular measurement accuracy and the angular separation performance of radar apparatus 10 in the vertical and horizontal directions can be improved.

Therefore, according to Arrangement Example 1, the grating lobes can be suppressed, and the angular measurement accuracy or the resolution of radar apparatus 10 can be improved.

In Arrangement Example 1, the antenna elements may be further added to at least one of transmission antenna 106 and reception antenna 202 of the antenna configuration illustrated in FIG. 8. For example, transmission antennas 106 and reception antennas 202 of radar apparatus 10 may include the antenna elements arranged in FIG. 8. In this case of further addition of the antenna element, for example, a virtual antenna is additively added at the position given by Expression 16. For example, the addition of at least one antenna element of transmission antennas 106 or reception antennas 202 results in an arrangement in which a further virtual antenna is added to the virtual reception array arrangement illustrated in FIG. 9. Even in the case of the antenna arrangement including Arrangement Example 1, the effects of the above-described Arrangement Example 1 are retained, and the same effects as those of Arrangement Example 1 can be obtained.

For example, an antenna may be further added to the antenna configuration of Arrangement Example 1. By adding the antenna, the grating lobe level or the sidelobe level suppressed by above-described Arrangement Example 1 is more likely to be further suppressed. Accordingly, erroneous detection at the time of angle measurement in radar apparatus 10 can be reduced, and the angular measurement performance can be improved. Note that the addition of the antenna can be similarly applied to the following arrangement examples or variations, and the same effects can be obtained.

Further, in the MIMO array arrangement of Arrangement Example 1, an arrangement in which the horizontal direction and the vertical direction are interchanged may be applied. In this case, as the virtual reception array arrangement, an arrangement in which the horizontal direction and the vertical direction are interchanged can be obtained, and angle separation performance in which the horizontal direction and the vertical direction are interchanged can be obtained. Interchanging the horizontal direction and the vertical direction of the MIMO array arrangement can be similarly applied to the arrangement examples or variations in the following. In the virtual reception array arrangements in the following arrangement examples, it is possible to obtain an arrangement in which the horizontal direction and the vertical direction are interchanged.

In the following, variations of Arrangement Example 1 will be described.

### Variation 1 of Arrangement Example 1

In Variation 1 of Arrangement Example 1, for example, the spacing between the first oblique antenna group and the second oblique antenna group (for example, the minimum spacing) may be larger than the aperture length of N_{Tx} transmission antennas 106.

For example, in Arrangement Example 1, as illustrated in FIG. 8, the minimum spacing (for example, the spacing between Rx #4 and Rx #8) between the first oblique antenna group of antennas Rx #1 to #4 and the second oblique antenna group of antennas Rx #5 to #8 is narrower than the aperture length (for example, the spacing between Tx #1 and Tx #6) of N_{Tx} transmission antennas 106.

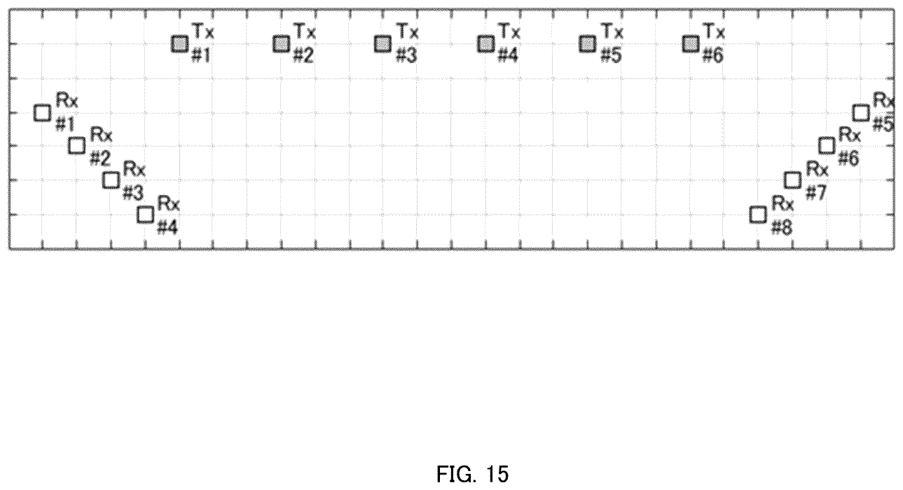

In Variation 1 of Arrangement Example 1, for example, as illustrated in FIG. 15 (hereinafter, also referred to as “Arrangement Example 1-1”), the minimum spacing (for example, the spacing between Rx #4 and Rx #8) between the first oblique antenna group of antennas Rx #1 to #4 and the second oblique antenna group of antennas Rx #5 to #8 may be wider than the aperture length (for example, the spacing between Tx #1 and Tx #6) of N_{Tx} transmission antennas 106 (for example, corresponding to the third antenna group).

For example, in Arrangement Example 1-1 illustrated in FIG. 15, the minimum spacing between the first oblique antenna group and the second oblique antenna group (the spacing between Rx #4 and Rx #8) is set to a spacing larger than the aperture length (for example, the spacing between Tx #1 and Tx #6) of N_{Tx} (=6) transmission antennas 106. Note that, in Arrangement Example 1-1 illustrated in FIG. 15, configurations different from the spacing between the first oblique antenna group and the second oblique antenna group may be the same as in Arrangement Example 1 (for example, FIG. 8).

From the arrangement of transmission antennas Tx #1 to Tx #6 and the arrangement of reception antennas Rx #1 to Rx #8 as illustrated in FIG. 15, the position coordinates of virtual antennas VA #1 to #48 constituting the virtual reception array antenna are calculated based on Expression 16.

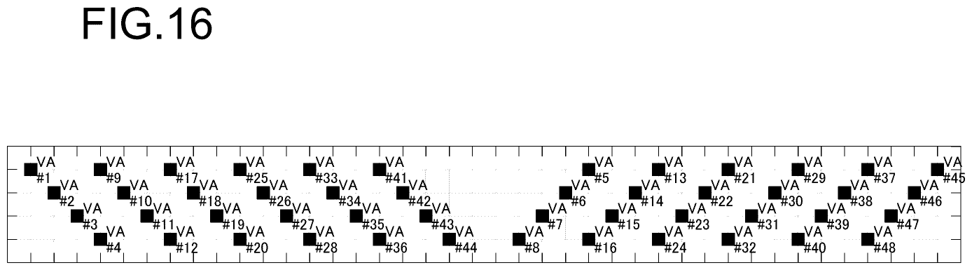

FIG. 16 is a diagram illustrating an arrangement example of the virtual reception array obtained by the antenna arrangement illustrated in FIG. 15. As illustrated in FIG. 16, the aperture length of the virtual reception array in the horizontal direction is wider than that of FIG. 9.

Next, an example of a direction estimation result (computer simulation result) in the case where the antenna arrangement according to above-described Arrangement Example 1-1 is applied will be described.

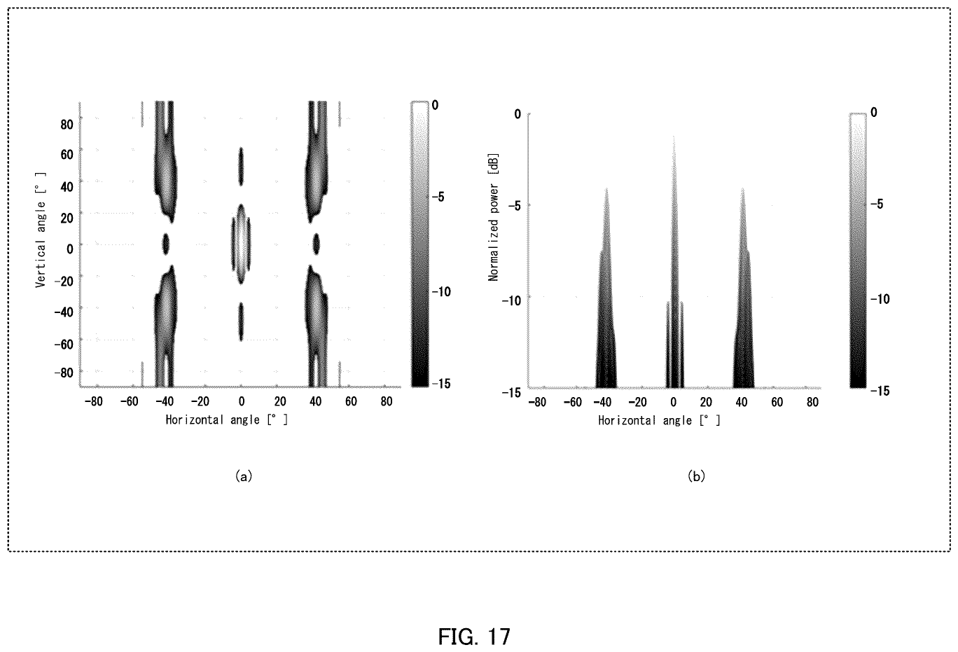

FIG. 17 illustrates a direction estimation result obtained when a MIMO array arrangement (D_{H}=0.52, D_{V}=0.52) of Arrangement Example 1-1 is used and the beamformer method is used as a direction-of-arrival estimation algorithm of direction estimator 213. By way of example, FIG. 17 illustrates plotted outputs of the direction-of-arrival estimation evaluation function values as obtained within the range of +90 degrees in the horizontal direction and within the range of 190 degrees in the vertical direction on the assumption that the target true value is at horizontal 0 degrees and vertical 0 degrees.

Note that (a) in FIG. 17 is a diagram illustrating normalized power values in two-dimensional directions of the horizontal direction as the horizontal axis and the vertical direction as the vertical axis in a grayscale color map. Further, with respect to (a) of FIG. 17, (b) of FIG. 17 illustrates a grayscale color map in which the horizontal axis denotes the horizontal direction, and the vertical axis denotes the normalized power values. In FIG. 17, the normalized power values may be represented by, for example, a decibel value (dB) normalized by the peak power.

As illustrated at (a) and (b) of FIG. 17, in Arrangement Example 1-1 as in Arrangement Example 1 (for example, FIG. 10), peak levels in the grating-lobe directions are suppressed as compared with the peak in the target-true-value direction.

Further, in Arrangement Example 1-1, the virtual reception array arrangement (for example, the aperture length of the virtual reception array) is widened in the horizontal direction as compared with Arrangement Example 1. Thus, as illustrated in FIG. 17, the peak in the target-true-value direction becomes sharper in the horizontal direction as compared with FIG. 10. Thus, the horizontal angular measurement accuracy or the horizontal estimation accuracy in radar apparatus 10 can be improved.

Note that, as illustrated in FIG. 17, in Arrangement Example 1-1 unlike Arrangement Example 1 (for example, FIG. 10), sidelobes of −10 dB may occur laterally (horizontally) along the peak in the target-true-value direction. The occurrence of the sidelobes is caused by, for example, a larger spacing (for example, the minimum spacing) between the first oblique antenna group and the second oblique antenna group than in Arrangement Example 1.

As described above, in Arrangement Example 1-1, by increasing the spacing between the first oblique antenna group and the second oblique antenna group, it is possible to improve the horizontal angular measurement accuracy or the horizontal estimation accuracy, but the sidelobe level at the lateral (horizontal) sides of the peak in the target-true-value direction is increased. For example, the spacing between the first oblique antenna group and the second oblique antenna group (for example, the minimum spacing) may be set within a suitable range in accordance with a requirement such as a detection target assumed by radar apparatus 10.

Note that the arrangement directions (e.g., oblique directions) of the first oblique antenna group and the second oblique antenna group may be inverted respectively from those in the arrangement of FIG. 15. The arrangement directions may be inverted in the left-right direction (e.g., horizontal direction), or the arrangement directions may be inverted in the up-down direction (e.g., vertical direction). Even in these cases, the same effects as those of above-described Arrangement Example 1-1 can be obtained. Note that the change of the arrangement direction of each of the first oblique antenna group and the second oblique antenna group can be similarly applied to the following arrangement examples.

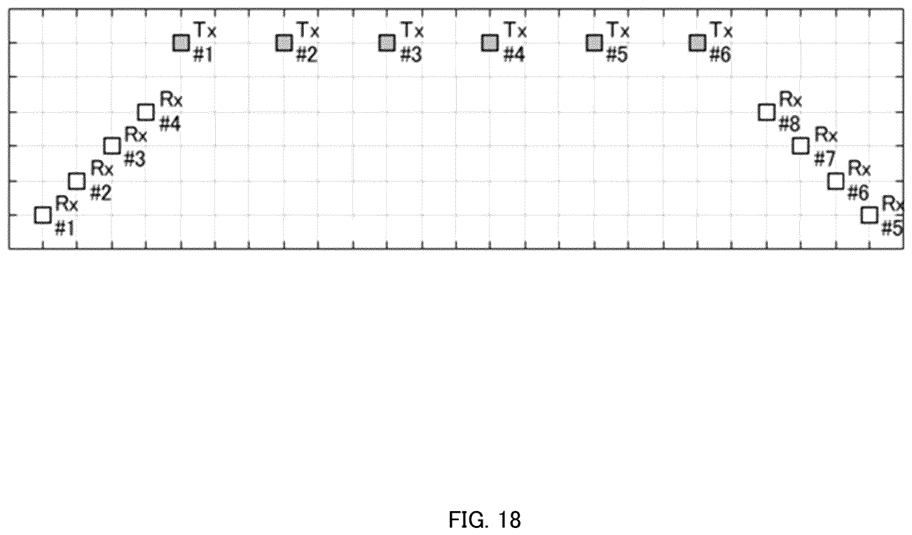

As an example, FIG. 18 illustrates an arrangement in which the arrangement directions of the first oblique antenna group and the second oblique antenna group in Arrangement Example 1-1 illustrated in FIG. 15 are inverted (hereinafter, referred to as “Arrangement Example 1-1a”).

In Arrangement Example 1-1 illustrated in FIG. 15, the first oblique antenna group and the second oblique antenna group are horizontally symmetrical. Therefore, Arrangement Example 1-1a illustrated in FIG. 18 is also an arrangement in which the arrangement directions of the first oblique antenna group and the second oblique antenna group are inverted in the left-right direction respectively to the arrangement directions in Arrangement Example 1-1, and is also an arrangement in which the first oblique antenna group and the second oblique antenna group are inverted upside down respectively from those in Arrangement Example 1-1.

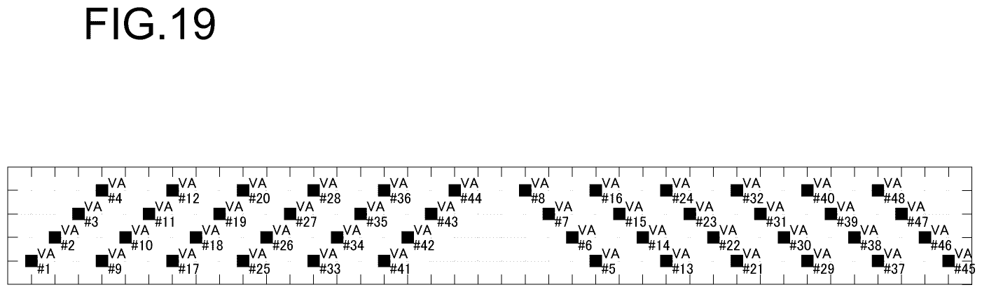

From the arrangement of transmission antennas Tx #1 to Tx #6 and the arrangement of reception antennas Rx #1 to Rx #8 illustrated in FIG. 18, the position coordinates of virtual antennas VA #1 to #48 constituting the virtual reception array antenna are calculated based on Expression 16. For example, FIG. 19 is a diagram illustrating an arrangement example of a virtual reception array obtained by the antenna arrangement illustrated in FIG. 18.

Further, in the arrangement such as Arrangement Example 1-1 or Arrangement Example 1-1a, for example, even when the size of each of transmission antennas 106 in the vertical direction is large, reception antennas 202 can be arranged on the opposite sides of transmission antennas 106 (for example, opposite sides in the horizontal direction; the left side of transmission antenna Tx #1, and the right side of transmission antenna Tx #6). Accordingly, it is also possible to obtain an effect of reducing the mounting area of the antennas.

### Variation 2 of Arrangement Example 1

In Variation 2 of Arrangement Example 1, for example, the spacing between the first oblique antenna group and the second oblique antenna group (for example, the minimum spacing) may be such that the groups are closer to each other as compared with Arrangement Example 1. Further, in Variation 2 of Arrangement Example 1, for example, one antenna included in the plurality of reception antennas 202 may be included in each of the first oblique antenna group and the second oblique antenna group in an overlapping manner. For example, the first oblique antenna group and the second oblique antenna group may include one or more shared antennas.

For example, in Arrangement Example 1, as illustrated in FIG. 8, the minimum spacing (for example, the spacing between Rx #4 and Rx #8) between the first oblique antenna group of antennas Rx #1 to #4 and the second oblique antenna group of antennas Rx #5 to #8 is narrower than the aperture length (for example, the spacing between Tx #1 and Tx #6) of N_{Tx} transmission antennas 106.

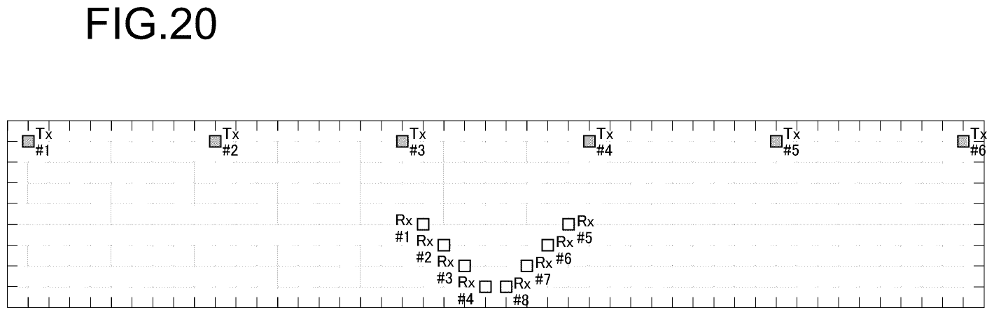

In Variation 2 of Arrangement Example 1, for example, as illustrated in FIG. 20 (hereinafter, referred to as “Arrangement Example 1-2a”), the minimum spacing (for example, the spacing between Rx #4 and Rx #8) between the first oblique antenna group of antennas Rx #1 to #4 and the second oblique antenna group of antennas Rx #5 to #8 may be disposed such that the groups are closer to each other as compared with FIG. 8.

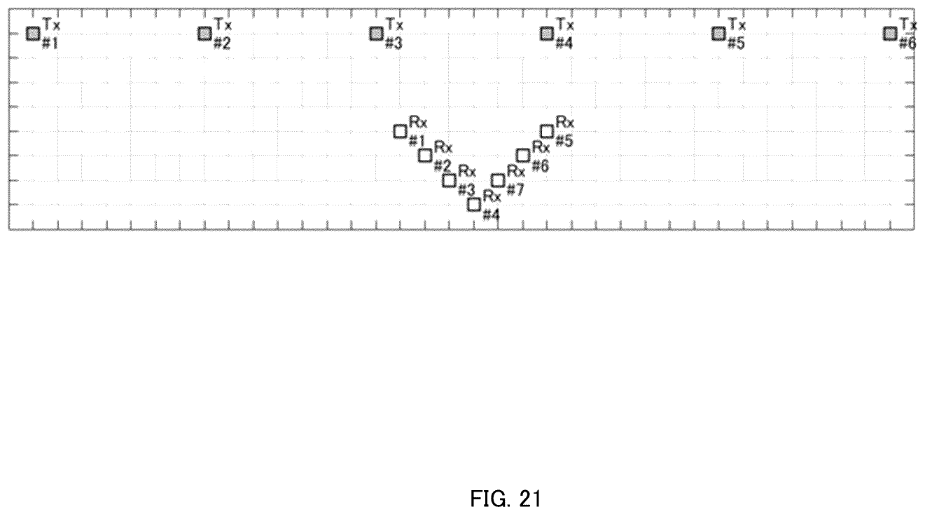

Alternatively, in Variation 2 of Arrangement Example 1, for example, as illustrated in FIG. 21 (hereinafter, referred to as “Arrangement Example 1-2b”), some antennas (for example, Rx #4) of the first oblique antenna group of antennas Rx #1 to #4 and the second oblique antenna group of antennas Rx #4 to #7 may overlap.

For example, in Arrangement Example 1-2a illustrated in FIG. 20, N_{Tx} transmission antennas Tx #1 to #6 are arranged at equal spacings of 4.5 wavelengths (for example, 9D_{H}) in the horizontal direction, and the minimum spacing between the first oblique antenna group and the second oblique antenna group (for example, the spacing between Rx #4 and Rx #8) is set to horizontal basic spacing D_{H}. In FIG. 20, horizontally, the aperture length (e.g., 7D_{H}) of reception antennas 202 (Rx #1 to #8) is narrower than the element spacing (e.g., 9D_{H}) between transmission antennas 106.

Further, for example, in Arrangement Example 1-2b illustrated in FIG. 21, N_{Tx} transmission antennas Tx #1 to #6 are arranged at equal spacings of 3.5 wavelengths (for example, 7D_{H}) in the horizontal direction, and the first oblique antenna group includes Rx #1 to #4 and the second oblique antenna group includes Rx #4 to #7 among Na (=7) reception antennas Rx #1 to #7. In FIG. 21, horizontally, the aperture length (e.g., 6D_{H}) of reception antennas 202 (Rx #1 to #7) is narrower than the element spacing (e.g., 7D_{H}) between transmission antennas 106.

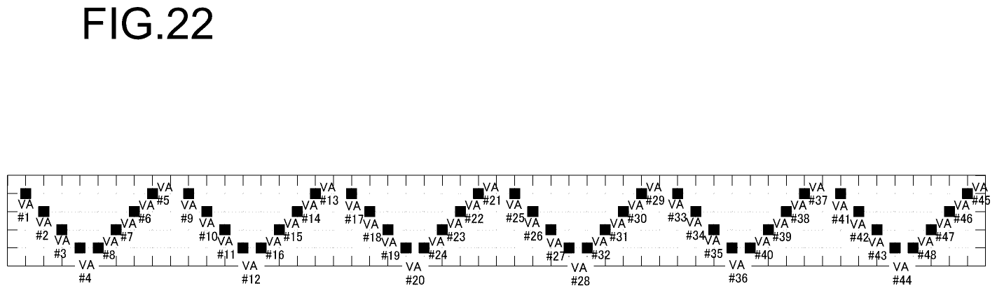

From the arrangement of transmission antennas Tx #1 to Tx #6 and the arrangement of reception antennas Rx #1 to Rx #8 as illustrated in FIG. 20, the position coordinates of virtual antennas VA #1 to #48 constituting the virtual reception array antenna are calculated based on Expression 16. FIG. 22 is a diagram illustrating an arrangement example of a virtual reception array obtained by the antenna arrangement illustrated in FIG. 20.

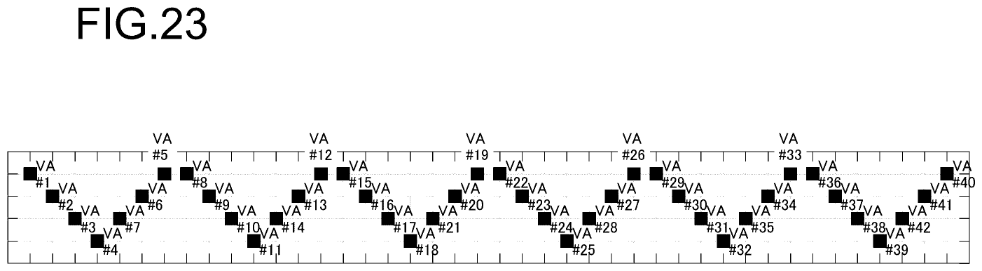

Further, from the arrangement of transmission antennas Tx #1 to Tx #6 and the arrangement of reception antennas Rx #1 to Rx #7 as illustrated in FIG. 21, the position coordinates of virtual antennas VA #1 to #42 constituting the virtual reception array antenna are calculated based on Expression 16. FIG. 23 is a diagram illustrating an arrangement example of a virtual reception array obtained by the antenna arrangement illustrated in FIG. 21.

Next, an example of a direction estimation result (computer simulation result) in the case where the antenna arrangements according to above-described Arrangement Example 1-2a and Arrangement Example 1-2b is applied will be described.

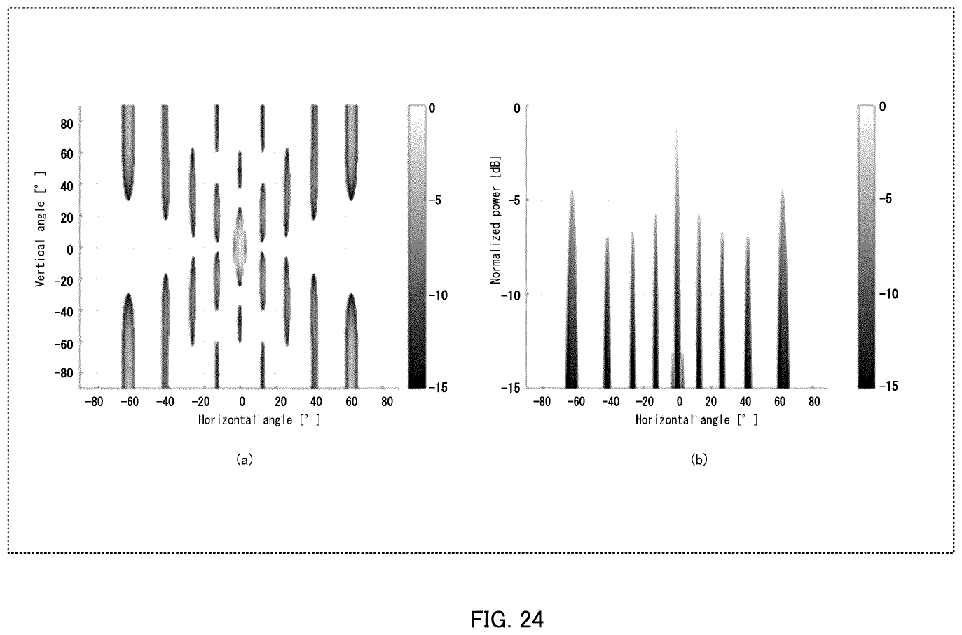

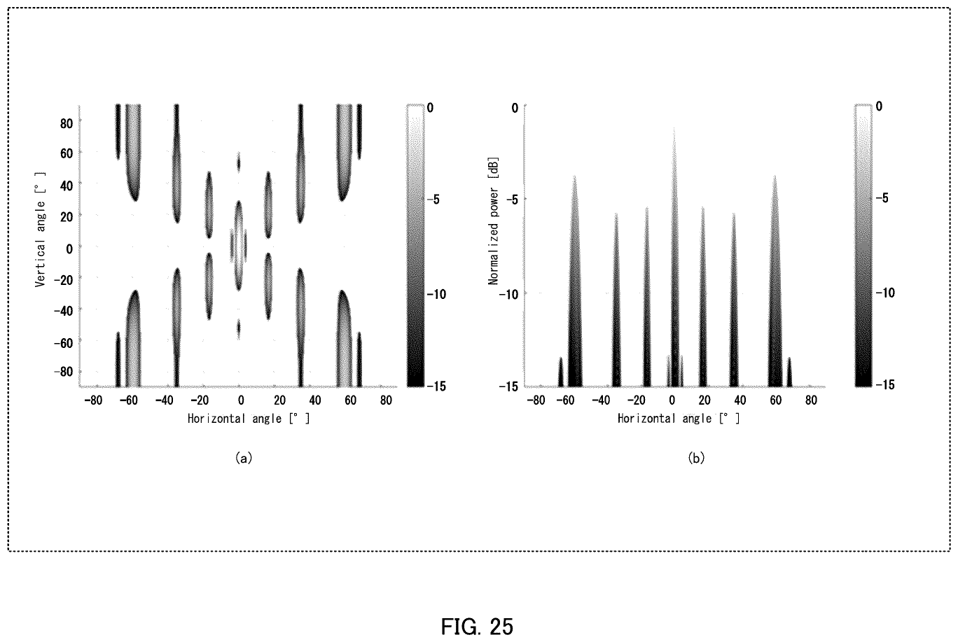

FIGS. 24 and 25 illustrate direction estimation results obtained when MIMO array arrangements (D_{H}=0.52, D_{V}=0.52) of Arrangement Examples 1-2a and 1-2b are used and the beamformer method is used as a direction-of-arrival estimation algorithm of direction estimator 213. By way of example, FIGS. 24 and 25 illustrate plotted outputs of the direction-of-arrival estimation evaluation function values as obtained within the range of +90 degrees in the horizontal direction and within the range of +90 degrees in the vertical direction on the assumption that the target true value is at horizontal 0 degrees and vertical 0 degrees.

Note that (a) in FIG. 24 and (a) in FIG. 25 are diagrams illustrating normalized power values in two-dimensional directions of the horizontal direction as the horizontal axis and the vertical direction as the vertical axis in a grayscale color map. Further, with respect to (a) in FIG. 24 and (a) in FIG. 25, (b) in FIG. 24 and (b) in FIG. 25 illustrate grayscale color maps in which the horizontal axis denotes the horizontal direction, and the vertical axis denotes the normalized power values. Note that, in FIGS. 24 and 25, the normalized power values may be expressed by, for example, a decibel value (dB) normalized by the peak power.

As illustrated in FIGS. 24 and 25, in Arrangement Examples 1-2a and 1-2b as in Arrangement Example 1 (for example, FIG. 10), peak levels in the grating-lobe directions are suppressed as compared with the peak in the target-true-value direction.

In the arrangements such as Arrangement Example 1-2a and Arrangement Example 1-1b, for example, even when the size of each of transmission antennas 106 in the vertical direction is large, reception antennas 202 can be arranged between the elements of transmission antennas 106. Accordingly, it is possible to obtain an effect of reducing the mounting area of the antennas.

Further, since the virtual antennas are arranged without overlap in the arrangements such as Arrangement Example 1-2a and Arrangement Example 1-1b, an arrangement can be achieved in which the element spacings between transmission antennas 106 are wider than the horizontal aperture length of reception antennas 202. As a result, the horizontal aperture length of the virtual antennas is widened, the peak in the target-true-value direction becomes sharper in the horizontal direction, and the horizontal angular measurement accuracy or horizontal resolution is improved. In addition, as compared with the case where the element spacings of transmission antennas 106 are made wider in Arrangement Example 1, the arrangements of Arrangement Example 1-2a and Arrangement Example 1-1b can suppress more a variation in horizontal spacings between the virtual antennas and can also obtain the effect of reducing more an increase in sidelobes near the main lobe.

Further, in Arrangement Example 1-2a, the spacings between transmission antennas 106 are wider than in Arrangement Example 1-2b, and the horizontal direction aperture length in the virtual reception array arrangement is widened. Therefore, since the peak in the target-true-value direction becomes sharper in the horizontal direction due to the enlargement of the element spacings of transmission antennas 106 in Arrangement Example 1-2a, the horizontal angular measurement accuracy or the horizontal estimation accuracy in radar apparatus 10 can be improved. Note that, although more grating lobes may be generated by enlarging the element spacings between transmission antennas 106, it can be confirmed that the grating lobes are suppressed by Arrangement Example 1-2a as illustrated in FIG. 24.

Further, in Arrangement Example 1-2b, the number of reception antennas 202 is smaller than in Arrangement Example 1-2a. Therefore, in Arrangement Example 1-2b, the antenna configuration in radar apparatus 10 can be simplified and the grating lobes can be suppressed as a result of a smaller number of reception antennas 202.

Note that, the description with reference to FIG. 21 has been given in which the antenna (e.g., Rx #4) at the end of each of the first oblique antenna group and the second oblique antenna group overlaps, but the present disclosure is not limited thereto. For example, the antenna included in both of the first oblique antenna group and the second oblique antenna group in an overlapping manner may be an antenna that differs from the antenna at the end of each oblique antenna group.

### Variation 3 of Arrangement Example 1

The inclinations of the first oblique antenna group and the second oblique antenna group (for example, the position change in the vertical direction with respect to the horizontal direction) are not limited to FIG. 8, and other inclination may be set.

For example, in Variation 3 of Arrangement Example 1, an example in which the inclinations of the first oblique antenna group and the second oblique antenna group are set to be gentler than those in Arrangement Example 1 will be described.

For example, in Arrangement Example 1, as illustrated in FIG. 8, antennas Rx #1 to #4 in the first oblique antenna group are arranged to be horizontally shifted from one another by a spacing of 0.5 wavelengths from left to right in the figure, and are arranged to be also vertically shifted from one another by a spacing of 0.5 wavelengths at the same time, and antennas Rx #5 to #8 in the second oblique antenna group are horizontally shifted from one another by a spacing of 0.5 wavelengths from right to left in the figure, and are also vertically shifted from one another by a spacing of 0.5 wavelengths at the same time.

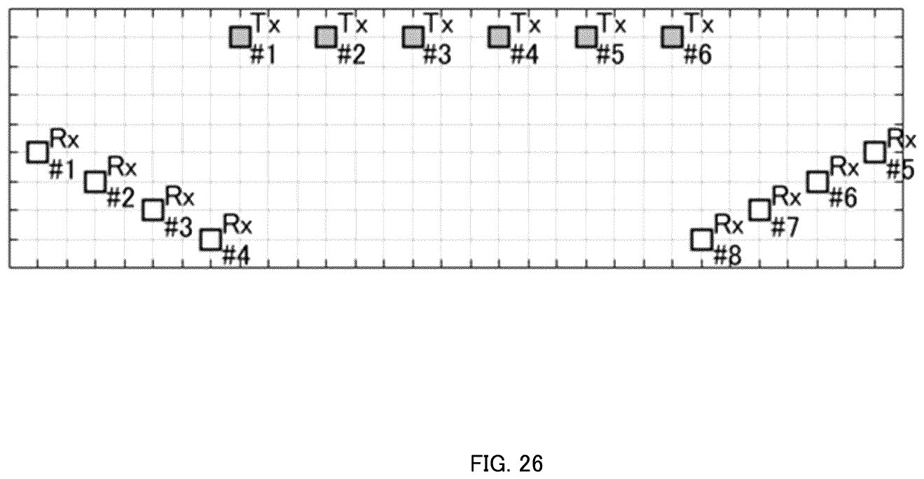

In Variation 3 of Arrangement Example 1, for example, as illustrated in FIG. 26 (hereinafter, referred to as “Arrangement Example 1-3”), antennas Rx #1 to #4 in the first oblique antenna group are arranged to be horizontally shifted from one another by a spacing of one wavelength from left to right in the figure, and are arranged to be also vertically shifted downward from one another by a spacing of 0.5 wavelengths at the same time. As illustrated in FIG. 26, antennas Rx #5 to #8 in the second oblique antenna group are arranged to be horizontally shifted from one another by a spacing of one wavelength from right to left in the figure, and are arranged to be also vertically shifted downward from one another by a spacing of 0.5 wavelengths. Note that, in Arrangement Example 1-3 illustrated in FIG. 26, configurations different from the inclinations of the first oblique antenna group and the second oblique antenna group may be the same as those for Arrangement Example 1 (for example, FIG. 8).

As described above, in FIG. 26, the position change in the vertical direction with respect to the horizontal direction between the adjacent antennas of the first oblique antenna group and the second oblique antenna group is smaller than that of FIG. 8. For example, in FIG. 26, the inclinations of the first oblique antenna group and the second oblique antenna group are less than those in FIG. 8.

From the arrangement of transmission antennas Tx #1 to Tx #6 and the arrangement of reception antennas Rx #1 to Rx #8 as illustrated in FIG. 26, the position coordinates of virtual antennas VA #1 to #48 constituting the virtual reception array antenna are calculated based on Expression 16.

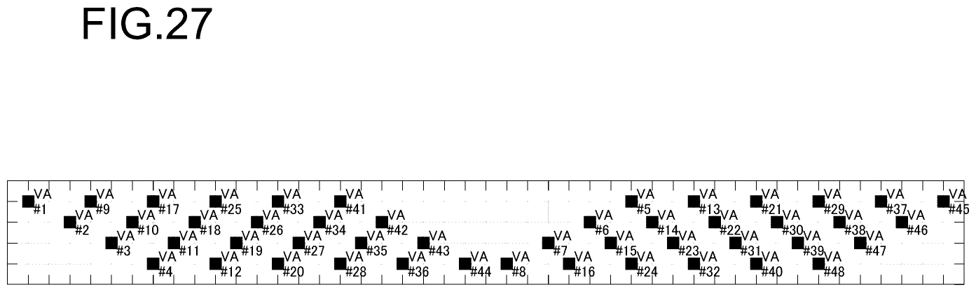

FIG. 27 is a diagram illustrating an arrangement example of a virtual reception array obtained by the antenna arrangement illustrated in FIG. 26. The aperture length of the virtual reception array illustrated in FIG. 27 is wider than that of Arrangement Example 1 (FIG. 9) due to the gentleness of the inclinations of the first oblique antenna group and the second oblique antenna group.

Next, an example of a direction estimation result (computer simulation result) in the case where the antenna arrangement according to above-described Arrangement Example 1-3 is applied will be described.

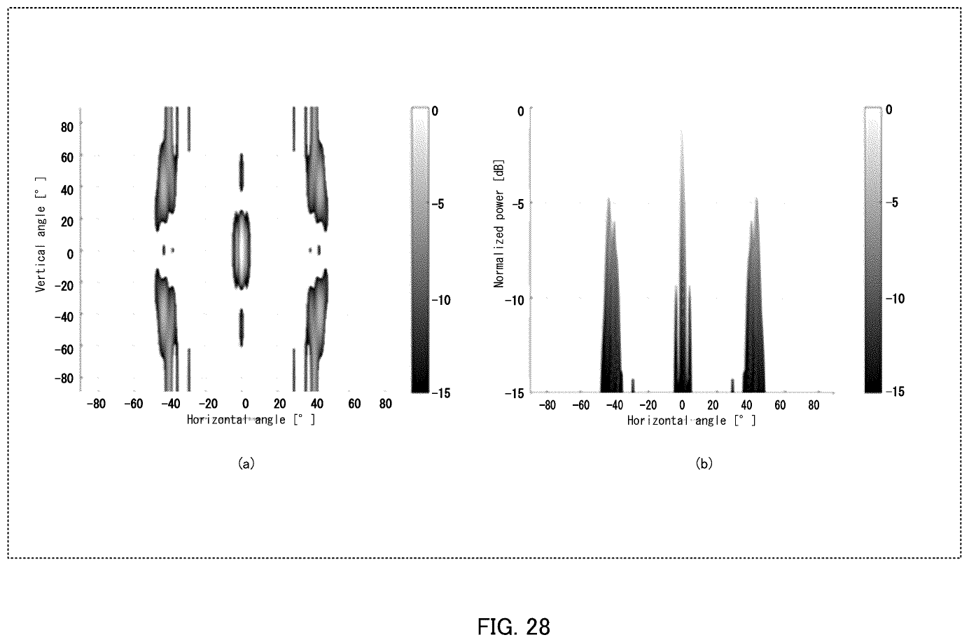

FIG. 28 illustrates a direction estimation result obtained when a MIMO array arrangement (D_{H}=0.52, D_{V}=0.5%) of Arrangement Example 1-3 is used and the beamformer method is used as a direction-of-arrival estimation algorithm of direction estimator 213. By way of example, FIG. 28 illustrates plotted outputs of the direction-of-arrival estimation evaluation function values as obtained within the range of +90 degrees in the horizontal direction and within the range of +90 degrees in the vertical direction on the assumption that the target true value is at horizontal 0 degrees and vertical 0 degrees.

Note that (a) in FIG. 28 is a diagram illustrating normalized power values in two-dimensional directions of the horizontal direction as the horizontal axis and the vertical direction as the vertical axis in a grayscale color map. Further, with respect to (a) of FIG. 28, (b) of FIG. 28 illustrates a grayscale color map in which the horizontal axis denotes the horizontal direction, and the vertical axis denotes the normalized power values. In FIG. 28, the normalized power values may be represented by, for example, a decibel value (dB) normalized by the peak power.

As illustrated in FIG. 28, in Arrangement Example 1-3, as in Arrangement Example 1 (FIG. 10), the peak levels in the grating-lobe directions are suppressed as compared with the peak in the target-true-value direction.

Further, since the virtual reception array arrangement (for example, the aperture length of the virtual reception array) is widened in the horizontal direction in Arrangement Example 1-3 as compared with Arrangement Example 1, the peak in the target-true-value direction becomes sharper in the horizontal direction as illustrated in FIG. 28. Accordingly, the horizontal angular measurement accuracy or the horizontal estimation accuracy in radar apparatus 10 can be improved.

Further, in Arrangement Example 1-3, for example, it is possible to obtain an effect of allowing an antenna arrangement not only in the case where the antenna size in the vertical direction of transmission antenna 106 is large (for example, in the case of a wavelength equal to or greater than one wavelength), but also in the case where the antenna size in the horizontal direction is large (for example, in the case of a wavelength equal to or greater than one wavelength). For example, the larger the horizontal antenna size, the narrower the horizontal viewing angle. Accordingly, the directivity gain can increase, and the radar performance for detecting a farther target within a narrower (e.g., limited) horizontal viewing angle can be enhanced.

Note that, as illustrated in FIG. 28, in Arrangement Example 1-3 unlike Arrangement Example 1 (for example, FIG. 10), sidelobes of −10 dB may occur laterally (horizontally) along the peak in the target-true-value direction. The occurrence of the sidelobes is caused by, for example, a larger spacing (for example, the minimum spacing) between the first oblique antenna group and the second oblique antenna group than in Arrangement Example 1.

For example, by increasing the spacing between the first oblique antenna group and the second oblique antenna group, it is possible to improve the horizontal angular measurement accuracy or the horizontal estimation accuracy, but the sidelobe level at the lateral (horizontal) sides of the peak in the target-true-value direction is increased. For example, the spacing between the first oblique antenna group and the second oblique antenna group (for example, the minimum spacing) may be set within a suitable range in accordance with a requirement such as a detection target assumed by radar apparatus 10.

Further, the description with reference to FIG. 26 has been given in which the spacing between the first oblique antenna group and the second oblique antenna group (e.g., the minimum spacing) is wider than the aperture length of transmission antennas 106, but the present disclosure is not limited thereto. The spacing between the first oblique antenna group and the second oblique antenna group (e.g., the minimum spacing) may be set to be equal to or smaller than the aperture length of transmission antennas 106.

Further, Variation 3 of Arrangement Example 1 has been described in relation to the case in which the inclinations of the first oblique antenna group and the second oblique antenna group are set to be gentler than in Arrangement Example 1, but the present disclosure is not limited thereto. The inclinations of the first oblique antenna group and the second oblique antenna group may be set to be steeper than in Arrangement Example 1. In a case where the inclinations of the first oblique antenna group and the inclination of the second oblique antenna group are made steeper, Variation 4 of Arrangement Example 1 or Arrangement Example 2 described later may be applied.

### Variation 4 of Arrangement Example 1

For example, in Arrangement Example 1 illustrated in FIG. 8, the first oblique antenna group of antennas Rx #1 to #4 and the second oblique antenna group of antennas Rx #5 to #8 are arranged to have horizontal inversion symmetry has been described, but the present disclosure is not limited thereto. The first oblique antenna group and the second oblique antenna group do not have to be arranged to have inversion symmetry. For example, the arrangement directions of the first oblique antenna group and the arrangement direction of the second oblique antenna group may be not parallel to each other and different from each other.

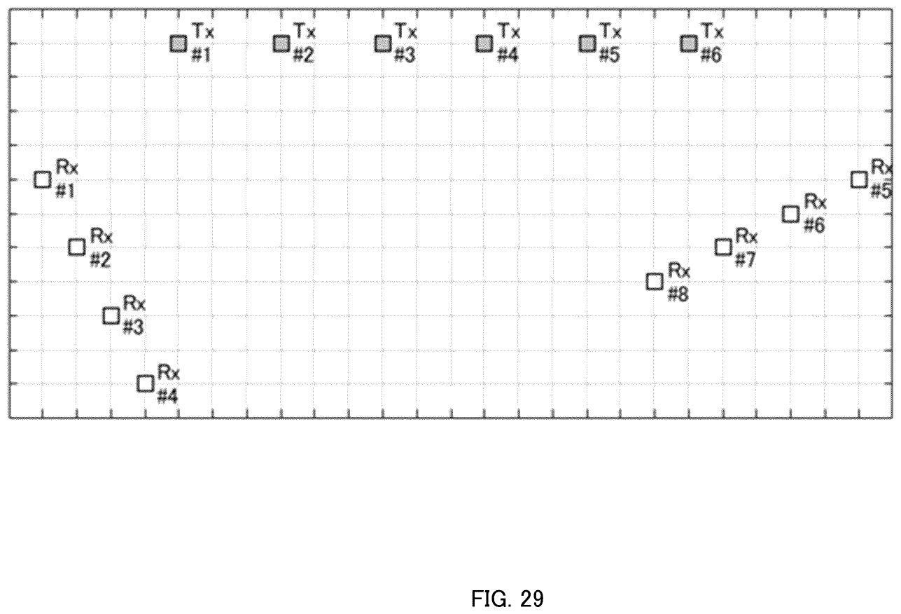

For example, as illustrated in FIG. 29 (hereinafter, referred to as “Arrangement Example 1-4a”), the first oblique antenna group of antennas Rx #1 to #4 and the second oblique antenna group of antennas Rx #5 to #8 may have asymmetric inclinations (for example, may have position changes in the vertical direction with respect to the horizontal direction), or different antenna spacings may be configured for the horizontal direction and the vertical direction, respectively.

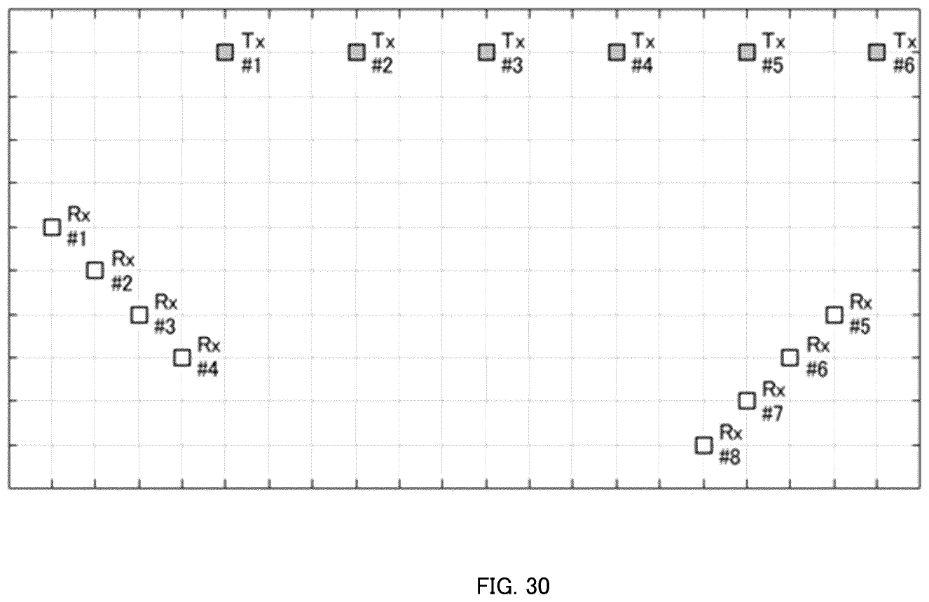

Further, for example, as illustrated in FIG. 30 (hereinafter, referred to as “Arrangement Example 1-4b”), the positions of the first oblique antenna group and the second oblique antenna group may be vertically shifted from each other.

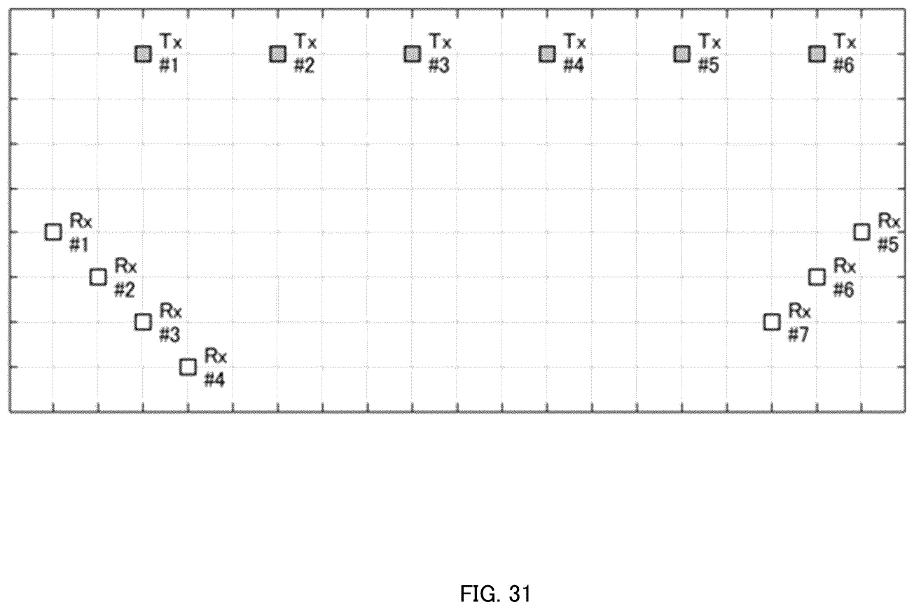

Further, for example, as illustrated in FIG. 31 (hereinafter, referred to as “Arrangement Example 1-4c”), the number of antennas included in each of the first oblique antenna group and the second oblique antenna group may be different from each other.

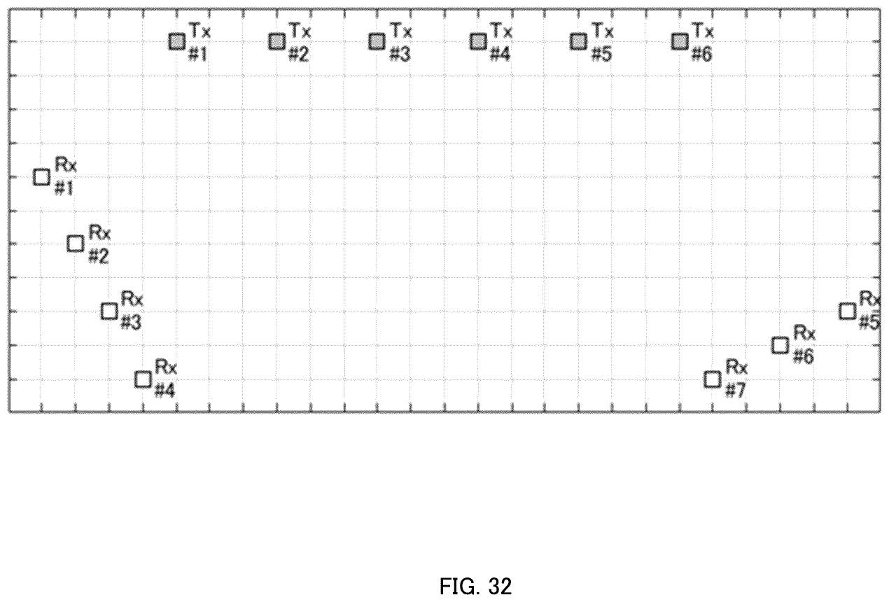

Further, for example, any two or three of Arrangement Example 1-4a (asymmetric inclinations), Arrangement Example 1-4b (vertically shifted positions), and Arrangement Example 1-2c (number of antennas) may be combined. For example, FIG. 32 (hereinafter referred to as “Arrangement Example 1-4d”) indicates an arrangement in which Arrangement Example 1-4a, Arrangement Example 1-4b, and Arrangement Example 1-4c are combined.

Note that, when the first oblique antenna group and the second oblique antenna group have asymmetric inclinations as illustrated in FIG. 29, for example, the arrangement direction of the first oblique antenna group and the arrangement direction of the second oblique antenna group may be arranged to have rotational symmetry by about 90 degrees with respect to each other. In this case, for example, the directions in which the grating lobes are generated due to the relationship between transmission antennas 106 and the first oblique antenna group and the directions in which the grating lobes are generated due to the relationship between transmission antennas 106 and the second oblique antenna group are directions having rotational symmetry by about 90 degrees with respect to each other in the two-dimensional plane of the horizontal and vertical directions. Therefore, it is likely that the distance between the grating lobes is larger.

It is preferable that the arrangement in which the arrangement directions of the first oblique antenna group and the second oblique antenna group have rotational symmetry by about 90 degrees with respect to each other include a smaller number of antennas of radar apparatus 10, for example. For example, the smaller the number of antennas of radar apparatus 10, the wider the beam width of the main beam in the direction estimation is likely to be. Thus, when the directions of the suppressed grating lobes are close to each other, the power of the grating lobes may increase as a result of power overlap between the grating lobes, which is caused by the larger beam width due to the smaller number of antennas of radar apparatus 10. Therefore, as the number of antennas of radar apparatus 10 decreases, the suppression performance for suppressing the grating lobes deteriorates, and the probability of erroneous detection in radar apparatus 10 tends to increase. As a countermeasure, when the number of antennas of radar apparatus 10 is small, for example, it is possible to suppress the power overlap between the grating lobes by the arrangement in which the arrangement direction of the first oblique antenna group and the arrangement direction of the second oblique antenna group have rotational symmetry by about 90 degrees with respect to each other. Accordingly, the suppression performance for suppressing the grating lobes can be improved.

From the arrangement of transmission antennas Tx #1 to Tx #6 and the arrangement of reception antennas Rx #1 to Rx #8 or reception antennas Rx #1 to Rx #7 as illustrated in FIGS. 29 to 32, the position coordinates of virtual antennas VA #1 to VA #48 or VA #1 to VA #42 constituting the virtual reception array antenna are calculated based on Expression 16.

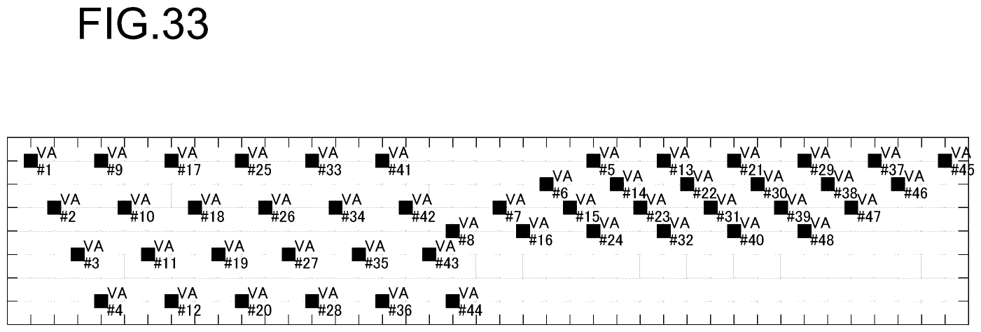

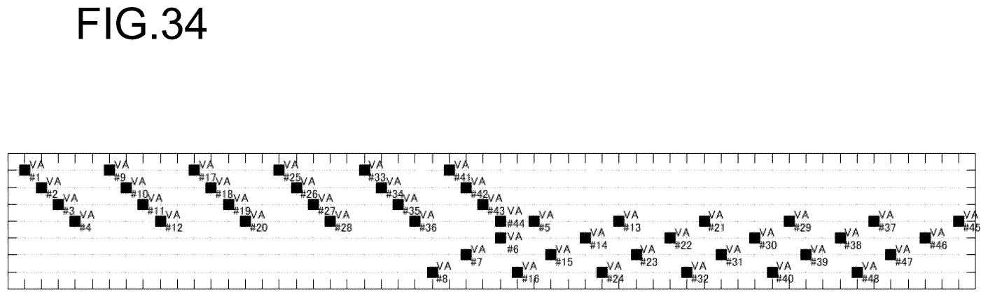

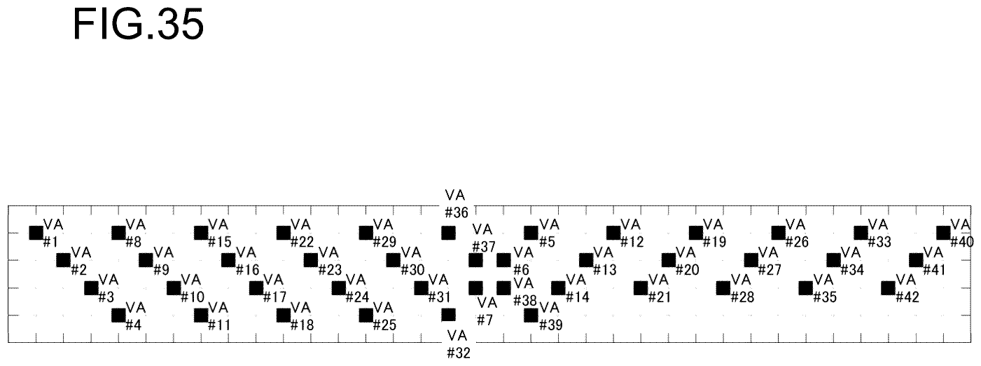

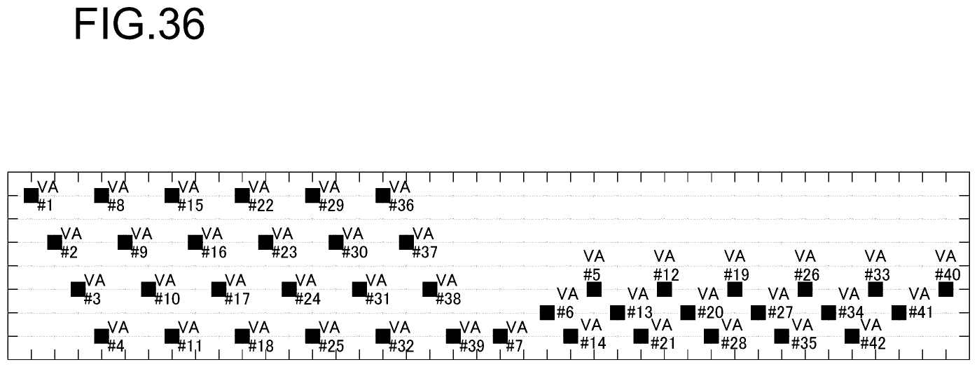

FIGS. 33 to 36 are diagrams illustrating arrangement examples of the virtual reception arrays obtained by the antenna arrangements illustrated in FIGS. 29 to 32, respectively.

Next, an example of the direction estimation result (computer simulation result) obtained when the antenna arrangement according to each of above-described Arrangement Example 1-4a to Arrangement Example 1-4d is applied will be described.

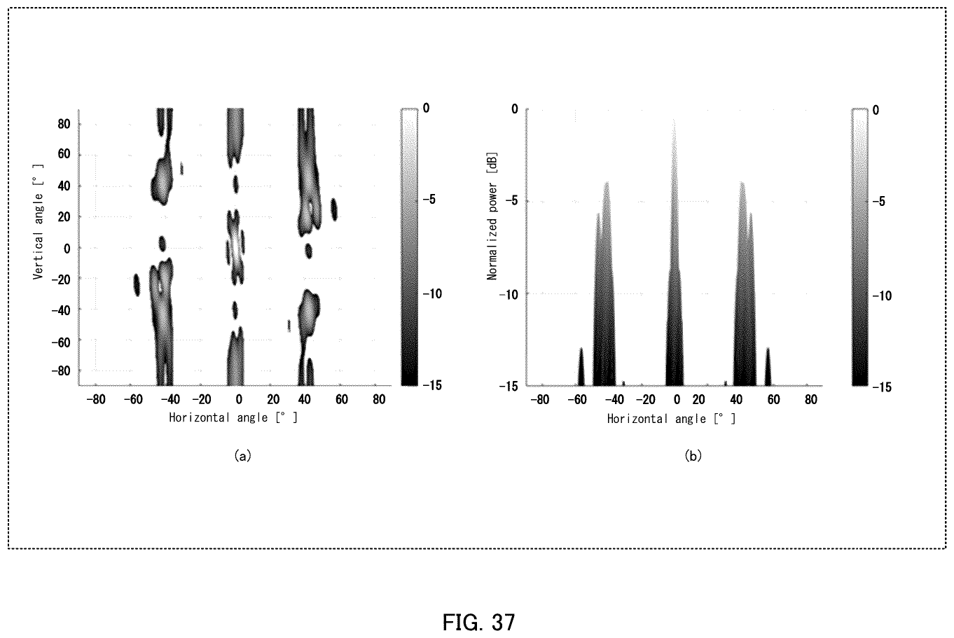

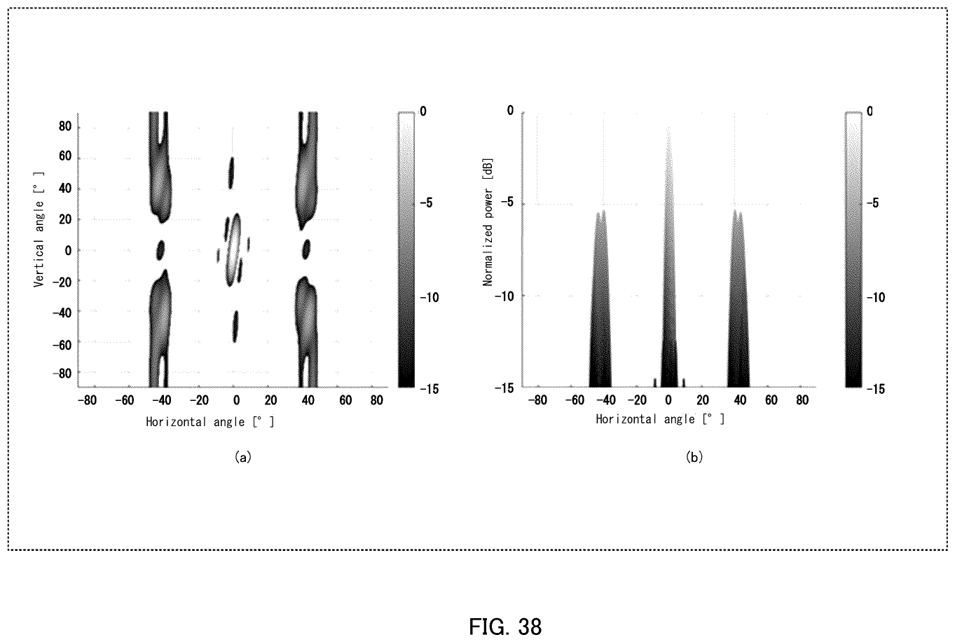

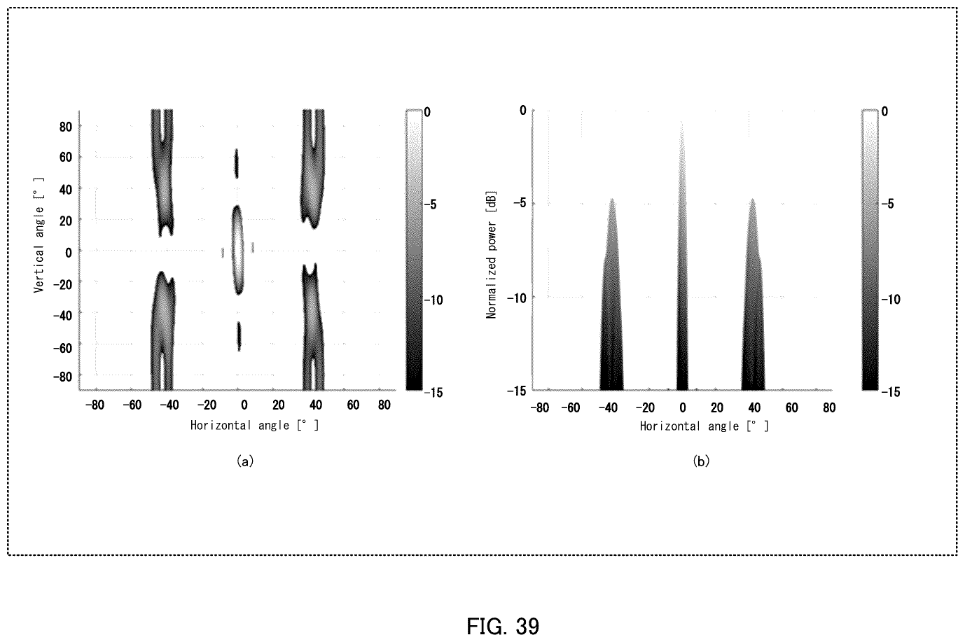

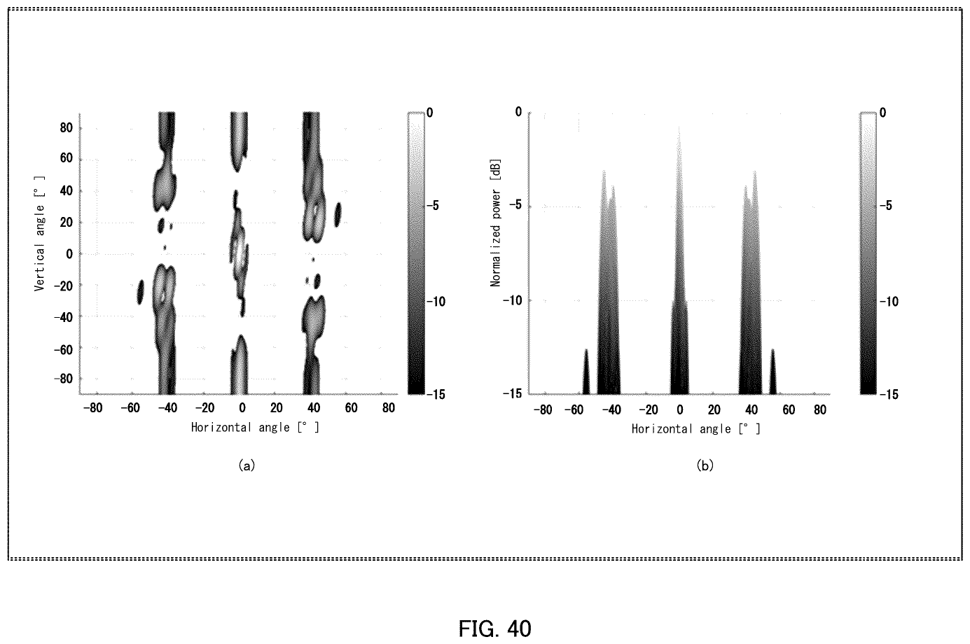

FIGS. 37 to 40 illustrate respective direction estimation results obtained when MIMO array arrangements (D_{H}=0.52, D_{V}=0.52) of Arrangement Examples 1-4a (FIG. 29) to 1-4d (FIG. 32) are used and the beamformer method is used as a direction-of-arrival estimation algorithm of direction estimator 213. By way of example, FIGS. 37 to 40 illustrate plotted outputs of the direction-of-arrival estimation evaluation function values as obtained within the range of +90 degrees in the horizontal direction and within the range of +90 degrees in the vertical direction on the assumption that the target true value is at horizontal 0 degrees and vertical 0 degrees.

Note that parts (a) in FIGS. 37 to 40 are diagrams illustrating normalized power values in two-dimensional directions of the horizontal direction as the horizontal axis and the vertical direction as the vertical axis in a grayscale color map. Further, with respect to parts (a) of FIGS. 37 to 40, parts (b) of FIGS. 37 to 40 illustrate grayscale color maps in which the horizontal axis denotes the horizontal direction, and the vertical axis denotes the normalized power values. In FIGS. 37 to 40, the normalized power values may be represented by, for example, a decibel value (dB) normalized by the peak power.

As illustrated in each of FIGS. 37 to 40, according to Arrangement Example 1-4, as in Arrangement Example 1 (FIG. 10), the peak levels in the grating-lobe directions are suppressed to about −5 dB as compared with the peak in the target-true-value direction.

### Variation 5 of Arrangement Example 1

Arrangement Example 1 and Variations 1 to 4 have been described in relation to the cases where, for example, the transmission antenna spacing is set to an integer multiple of basic spacing D_{H} in the horizontal direction, the inclination in the oblique direction of reception antennas 202 is set by an integer multiple of basic spacing D_{H} in the horizontal direction and by an integer multiple of basic spacing D_{V} in the vertical direction.

For example, N_{Tx} transmission antennas 106 are arranged horizontally at transmission antenna spacing dT×D_{H}.

In addition, in Na reception antennas 202, the first oblique antenna group and the second oblique antenna group are arranged in respective different oblique directions. In addition, the first oblique antenna group is arranged in an oblique direction in which the antennas are horizontally shifted from one another by spacings of dRH₁×D_{H} and are also vertically shifted from one another by spacings of Dr. In addition, the second oblique antenna group is arranged in an oblique direction in which the antennas are horizontally shifted from one another by spacings of dRH₂×D_{H} and are also vertically shifted from one another by spacings of D_{V}.

Here, dT is an integer equal to or greater than 2, and each of dRH₁ and dRH₂ is an integer equal to or greater than 1. Basic spacing D_{H} and basic spacing D_{V} may be values, for example, within a range of 0.45 to 0.8 times the wavelength of the radar transmission signal. dRH₁ and dRH₂ may be the same as or different from each other. dRH₁ and dRH₂ may also be collectively referred to as “dRH.” For example, in the case of dRH₁=dRH₂, the first oblique antenna group and the second oblique antenna group are arranged to have horizontal symmetry. In the case of dRH₁+dRH₂, the first oblique antenna group and the second oblique antenna group are arranged horizontally asymmetrically.

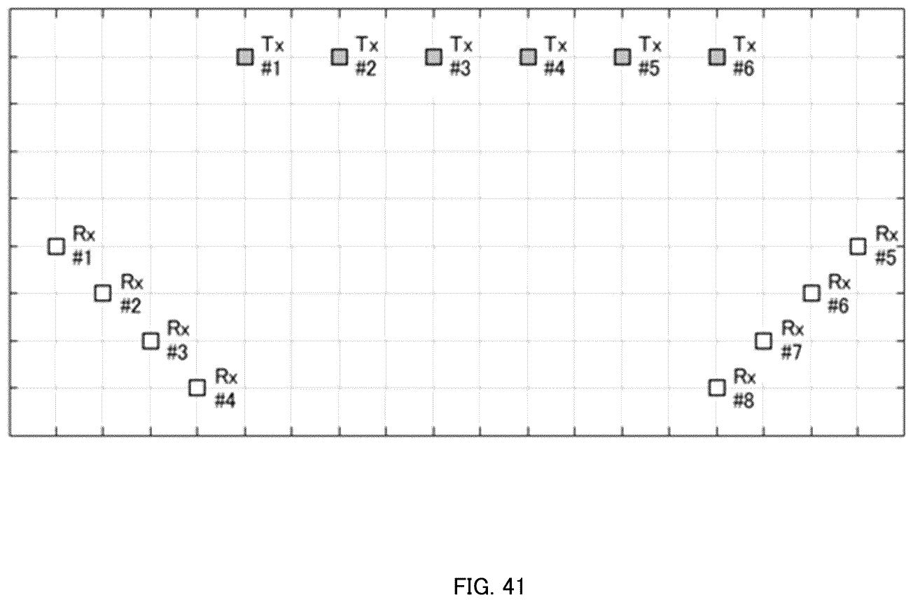

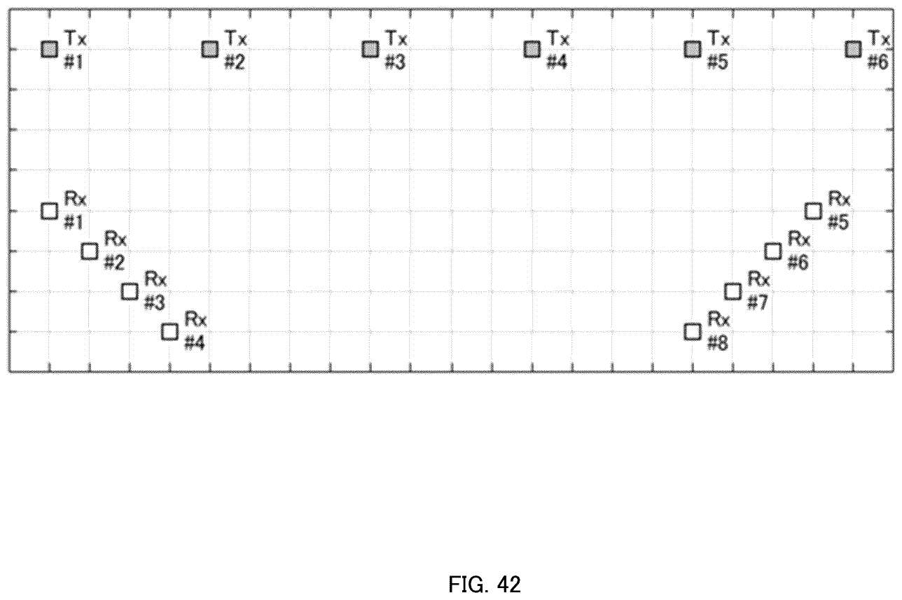

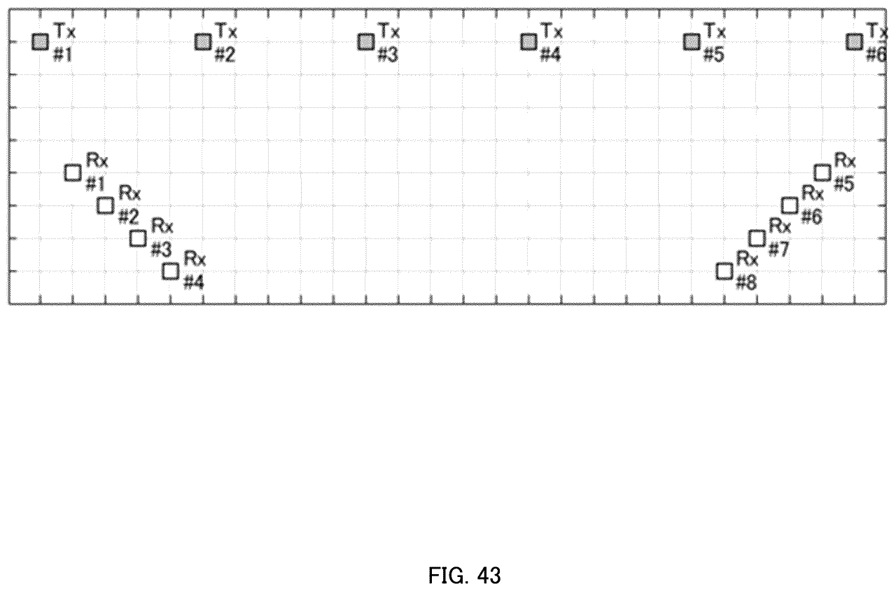

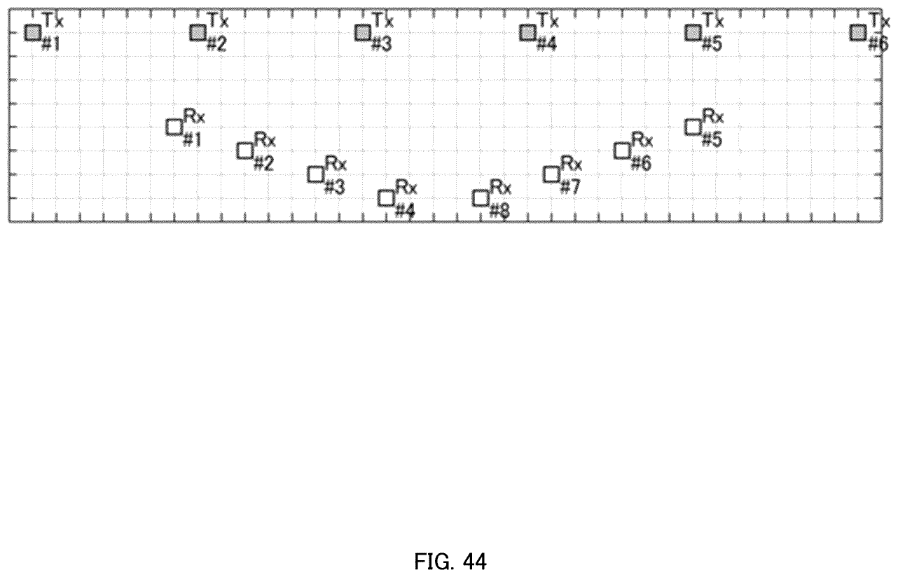

For example, in each of FIGS. 41 to 44, dRH₁=dRH₂ and the figures represent an exemplary antenna arrangement in the case of dT=2, 4, 5, or 7. In FIGS. 41 to 43, the case where dRH₁=dRH₂=1 is illustrated, and the case where dRH₁=dRH₂=2 is illustrated in FIG. 44. Hereinafter, the antenna arrangement examples of FIGS. 41 to 44 are also referred to as “Arrangement Example 1-5a,” “Arrangement Example 1-5b,” “Arrangement Example 1-5c,” and “Arrangement Example 1-5d,” respectively.

Here, with increasing dT, it becomes more likely that the direction of the grating lobe generated due to the relationship between transmission antennas 106 and the first oblique antenna group coincides with the direction of the grating lobe generated due to the relationship between transmission antennas 106 and the second oblique antenna group. Therefore, for example, the first oblique antenna group and the second oblique antenna group may also be arranged closer to each other as dT increases as illustrated in FIGS. 41 to 44. By bringing the first oblique antenna group and the second oblique antenna group close to each other, the spacings between adjacent virtual antennas in the virtual reception array can be narrowed, and thus the grating lobes can be suppressed.

From the arrangement of transmission antennas Tx #1 to Tx #6 and the arrangement of reception antennas Rx #1 to Rx #8 as illustrated in FIGS. 41 to 44, the position coordinates of virtual antennas VA #1 to VA #48 constituting the virtual reception array antenna are calculated based on Expression 16.

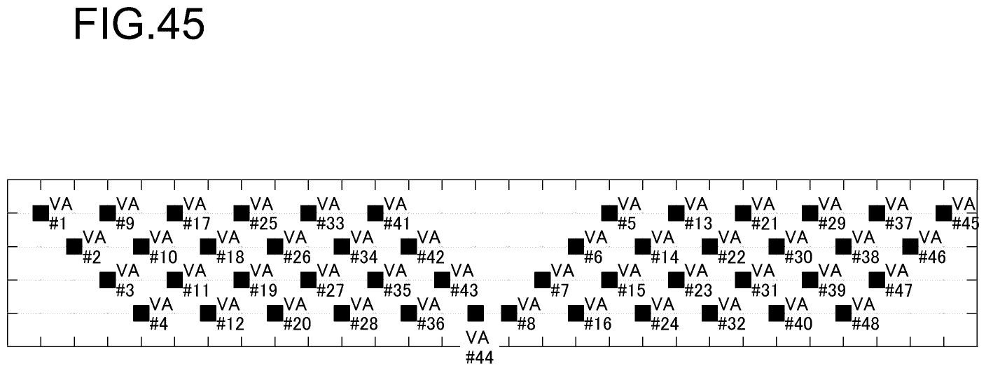

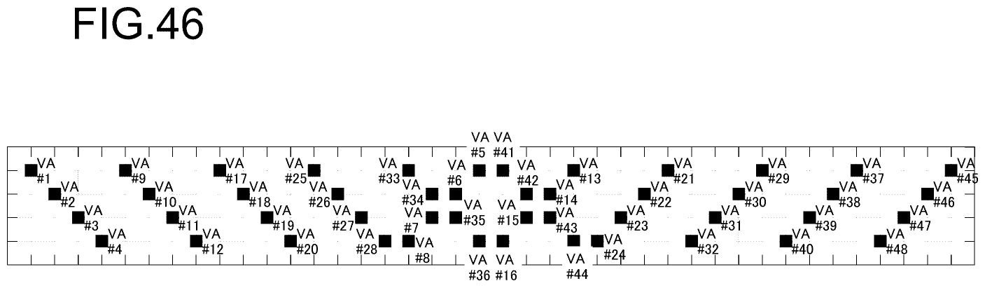

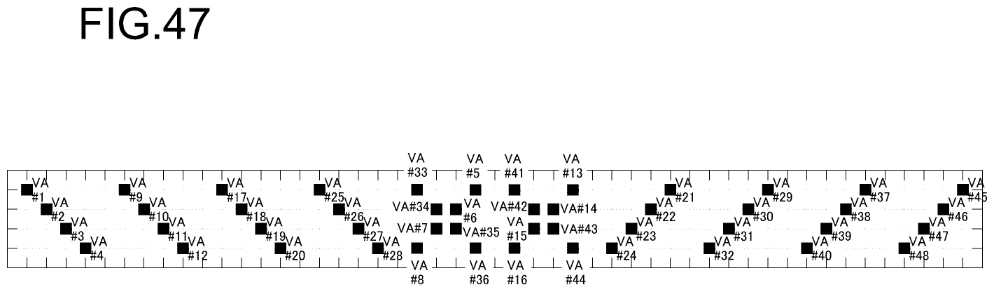

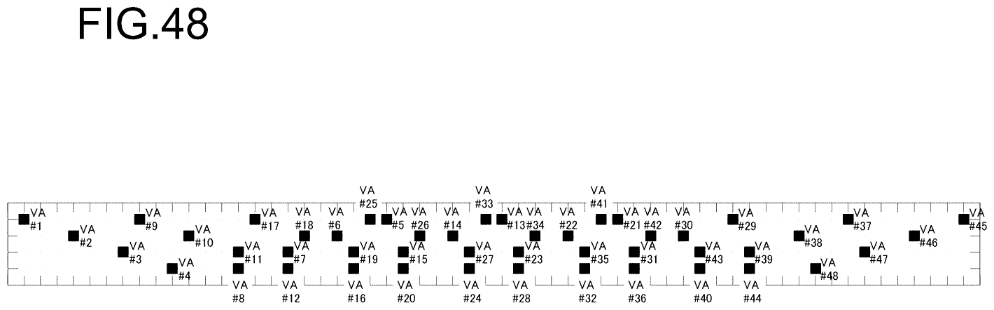

FIGS. 45 to 48 are diagrams illustrating arrangement examples of virtual reception arrays obtained by the antenna arrangements illustrated in FIGS. 41 to 44, respectively.

Next, an example of a direction estimation result (computer simulation result) when the antenna arrangement according to each of above-described Arrangement Examples 1-5a to 1-5d is applied will be described.

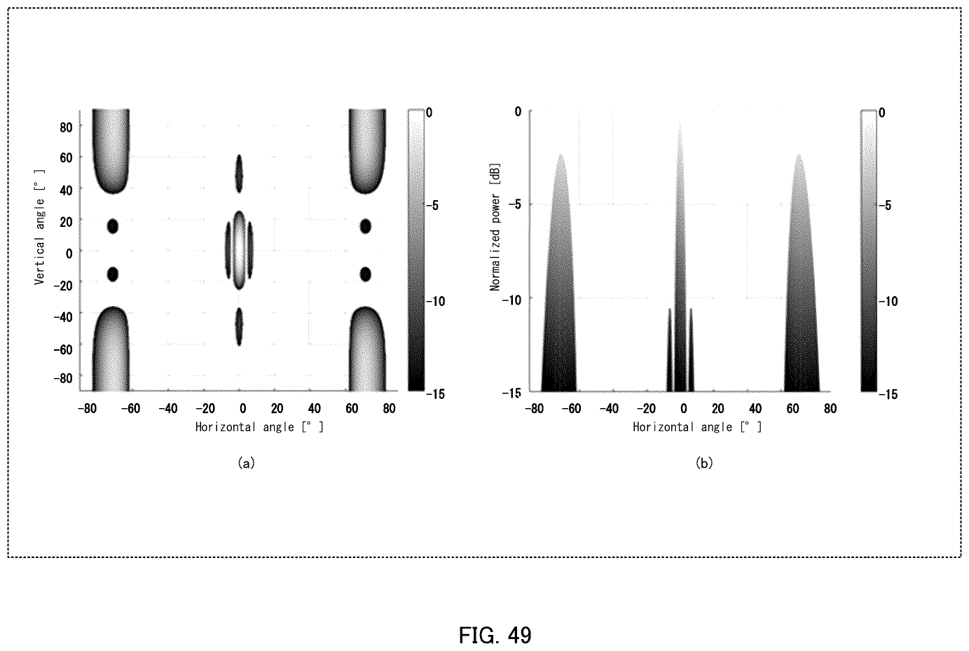

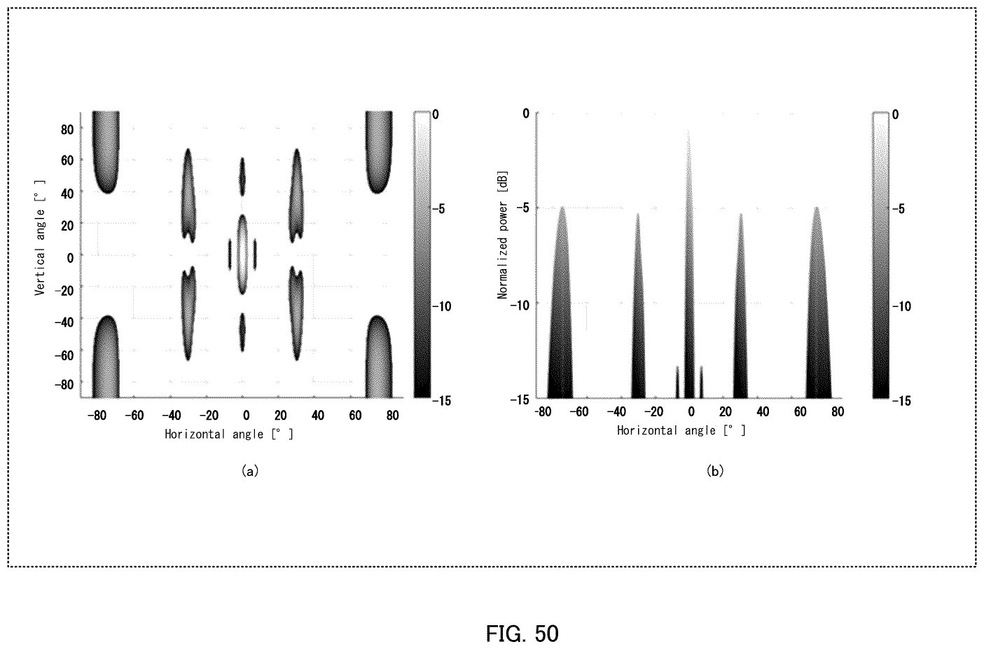

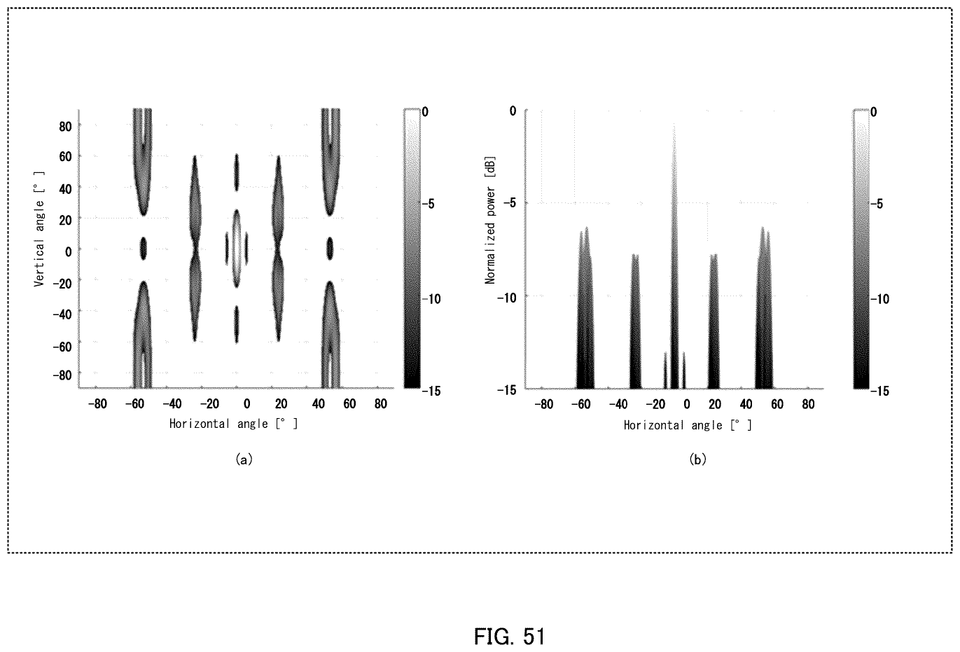

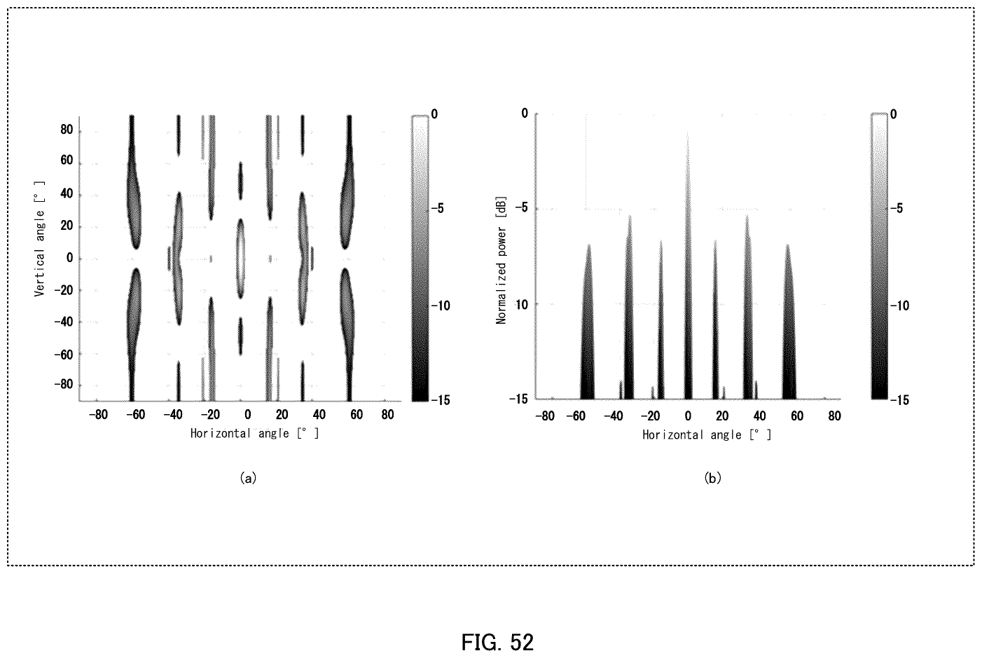

FIGS. 49 to 52 illustrate respective direction estimation results obtained when MIMO array arrangements (D_{H}=0.52, D_{V}=0.52) of Arrangement Examples 1-5a to 1-5d illustrated in FIGS. 41 to 44 are used and the beamformer method is used as a direction-of-arrival estimation algorithm of direction estimator 213. By way of example, FIGS. 49 to 52 illustrate plotted outputs of the direction-of-arrival estimation evaluation function values as obtained within the range of +90 degrees in the horizontal direction and within the range of ±90 degrees in the vertical direction on the assumption that the target true value is at horizontal 0 degrees and vertical 0 degrees.

Note that parts (a) in FIGS. 49 to 52 are diagrams illustrating normalized power values in two-dimensional directions of the horizontal direction as the horizontal axis and the vertical direction as the vertical axis in a grayscale color map. Further, with respect to parts (a) of FIGS. 49 to 52, parts (b) of FIGS. 49 to 52 illustrate grayscale color maps in which the horizontal axis denotes the horizontal direction, and the vertical axis denotes the normalized power values. In FIGS. 49 to 52, the normalized power values may be represented by, for example, a decibel value (dB) normalized by the peak power.

As illustrated in FIGS. 49 to 52, in Arrangement Examples 1-5a to 1-5d, as in Arrangement Example 1 (FIG. 10), the peak levels in the grating-lobe directions are suppressed as compared with the peak in the target-true-value direction.

Further, for example, as illustrated in Arrangement Example 1-5a (dT=2), Arrangement Example 1-5b (dT=4), Arrangement Example 1-5c (dT=5), and Arrangement Example 1-5d (dT=7), the virtual reception array arrangements (for example, the aperture lengths of the virtual reception arrays) are wider in the horizontal direction with increasing dT, and thus, the peak in the target-true-value direction becomes sharper in the horizontal direction as illustrated in each of FIGS. 49 to 52. Accordingly, the horizontal angular measurement accuracy or the horizontal estimation accuracy in radar apparatus 10 can be improved.

Further, for example, the spacing at which the grating lobes are generated is narrower with increasing dT, and more grating lobes are likely to be generated. However, as illustrated in FIGS. 49 to 52, it can be confirmed that the grating lobes are suppressed as low as −3 dB to 6 dB in each of Arrangement Example 1-5a to Arrangement Example 1-5d.

Note that, with respect to the inclinations of the first oblique antenna group and the second oblique antenna group, when the antennas are horizontally shifted from one another by a spacing of dRH₁×D_{H} or dRH₂×D_{H}, and are also vertically shifted from one another by a spacing (e.g., dRV×D_{V}; dRV is applied in the case of an integer equal to or greater than 2) of an integer multiple which is larger than the spacing of D_{V}, the direction of the grating lobes in the vertical direction generated due to the relationship between transmission antennas 106 and the first oblique antenna group is likely to coincide with the direction of the grating lobes in the vertical direction generated due to the relationship between transmission antennas 106 and the second oblique antenna group.

Thus, for example, the first oblique antenna group may be arranged in an oblique direction such that the antennas are horizontally shifted from one another by a spacing of dRH₁×D_{H}, and are also vertically shifted from one another by a spacing of D_{V} (or dRV×D_{V} and dRV=1), and the second oblique antenna group may be arranged in an oblique direction such that the antennas are horizontally shifted from one another by a spacing of dRH₂×D_{H} and are also vertically shifted from one another by a spacing of D_{V} (or dRV×D_{V} and dRV=1).

In addition, with respect to the inclinations of the first oblique antenna group and the second oblique antenna group, when the antennas are horizontally shifted from one another by a spacing of dRH₁×D_{H} or dRH₂×D_{H} and are also vertically shifted from one another by a spacing of an integral multiple larger than the spacing of D_{V} at the same time, Arrangement Example 1-4a or below-described Arrangement Example 2 and variations may, for example, be applied. In the virtual reception array having the configuration using Arrangement Example 2 and the variations described later, antenna spacings in the vertical direction are widened and the aperture length in the vertical direction can be increased. Thus, the angular measurement accuracy or the resolution in the vertical direction in radar apparatus 10 can be improved (an example will be described later).

Note that, Arrangement Example 1 and Variations 1 to 5 have been described in relation to the example in which the transmission antenna spacings are set to an integer multiple of horizontal basic spacing D_{H}, and, with respect to the inclinations of reception antennas 202, the horizontal spacings set to an integer multiple of horizontal basic spacing D_{H} and the vertical spacings set to an integer multiple of vertical basic spacing D_{V} are used. However, the arrangement is not limited to this, and may be an arrangement in which the spacings are not an integer multiple of Dr or D_{H}.

For example, N_{Tx} transmission antennas 106 may be arranged horizontally at transmission antenna spacing αD_{H}. Further, for example, Na reception antennas 202 may be arranged in an oblique direction such that the first oblique antenna group and the second oblique antenna group are arranged in different oblique directions not parallel to each other, and the antennas are horizontally shifted from one another by a spacing of βD_{H} and are also vertically shifted from one another by a spacing of γD_{V}.

Here, α, β, and γ represent positive real values, and αD_{H} may be a real value denoting a wavelength equal to or higher than one wavelength and βD_{H} and γD_{V} may be real values denoting wavelengths equal to or higher than 0.45 to 0.8 wavelengths. Such real values result in the same effects as those of the above-described embodiment.

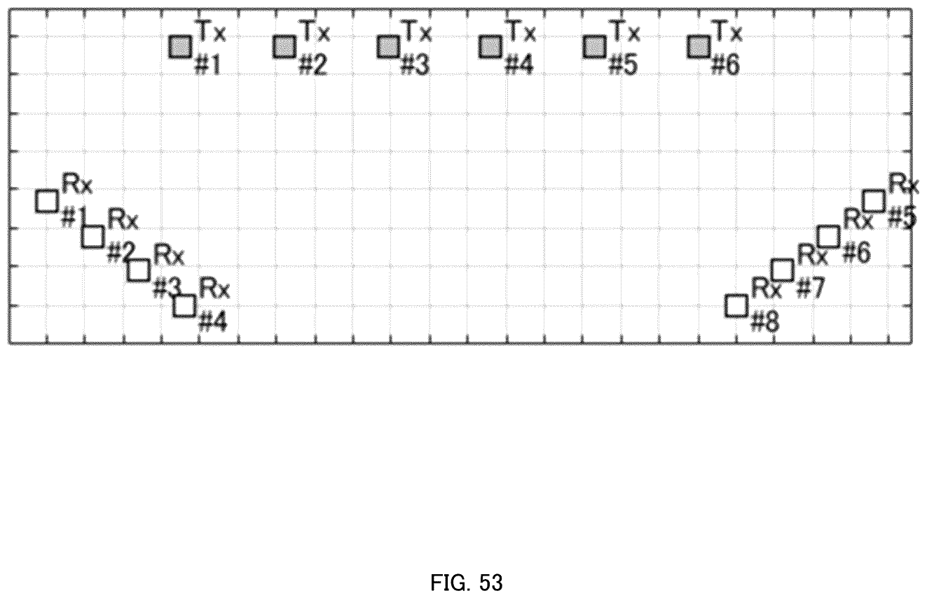

By way of example, in the antenna arrangement illustrated in FIG. 53 (hereinafter, referred to as “Arrangement Example 1-5e”), when D_{V}=0.5 wavelengths and D_{H}=0.5 wavelengths, αD_{H}=2.7 wavelengths, βD_{V}=0.45 wavelengths, and γD_{H}=0.6 wavelength are set.

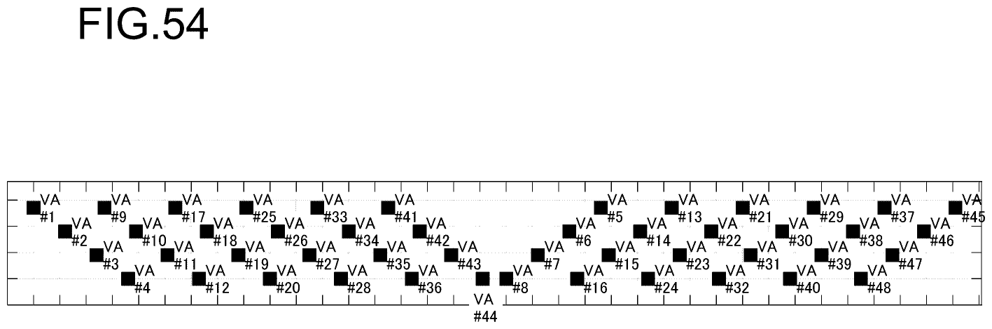

From the arrangement of transmission antennas Tx #1 to Tx #6 and the arrangement of reception antennas Rx #1 to Rx #8 as illustrated in FIG. 53, the position coordinates of virtual antennas VA #1 to #48 constituting the virtual reception array antenna are calculated based on Expression 16. FIG. 54 is a diagram illustrating an arrangement example of a virtual reception array obtained by the antenna arrangement illustrated in FIG. 53.

Next, an example of a direction estimation result (computer simulation result) in the case where the antenna arrangement according to above-described Arrangement Example 1-5e is applied will be described.

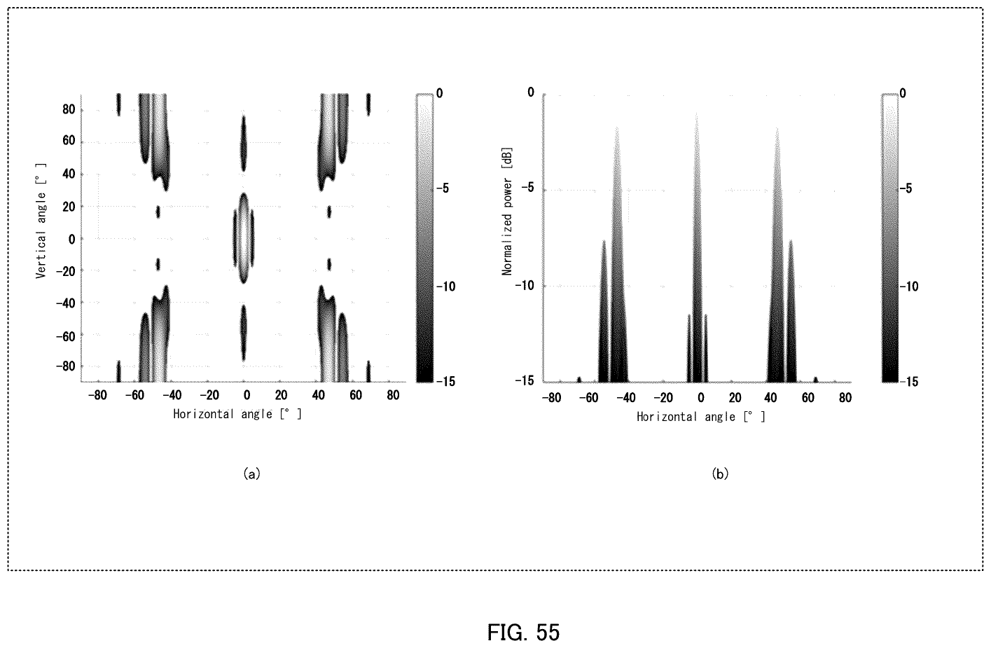

FIG. 55 illustrates a direction estimation result obtained when a MIMO array arrangement (D_{H}=0.5λ, D_{V}=0.5%) of Arrangement Example 1-5e illustrated in FIG. 53 is used and the beamformer method is used as a direction-of-arrival estimation algorithm of direction estimator 213. By way of example, FIG. 55 illustrates plotted outputs of the direction-of-arrival estimation evaluation function values as obtained within the range of ±90 degrees in the horizontal direction and within the range of ±90 degrees in the vertical direction on the assumption that the target true value is at horizontal 0 degrees and vertical 0 degrees.

Note that (a) in FIG. 55 is a diagram illustrating normalized power values in two-dimensional directions of the horizontal direction as the horizontal axis and the vertical direction as the vertical axis in a grayscale color map. Further, with respect to (a) of FIG. 55, (b) of FIG. 55 illustrates a grayscale color map in which the horizontal axis denotes the horizontal direction, and the vertical axis denotes the normalized power values. In FIG. 55, the normalized power values may be represented by, for example, a decibel value (dB) normalized by the peak power.

As illustrated in FIG. 55, according to Arrangement Example 1-5e, as in Arrangement Example 1 (FIG. 10), the peak levels in the grating-lobe directions are suppressed as compared with the peak in the target-true-value direction.

### Variation 6 of Arrangement Example 1

In at least either transmission antennas 106 or reception antennas 202 (for example, the first oblique antenna group and the second oblique antenna group), the spacings between adjacent antennas are not limited to equal spacings, and may include one or more unequal spacings.

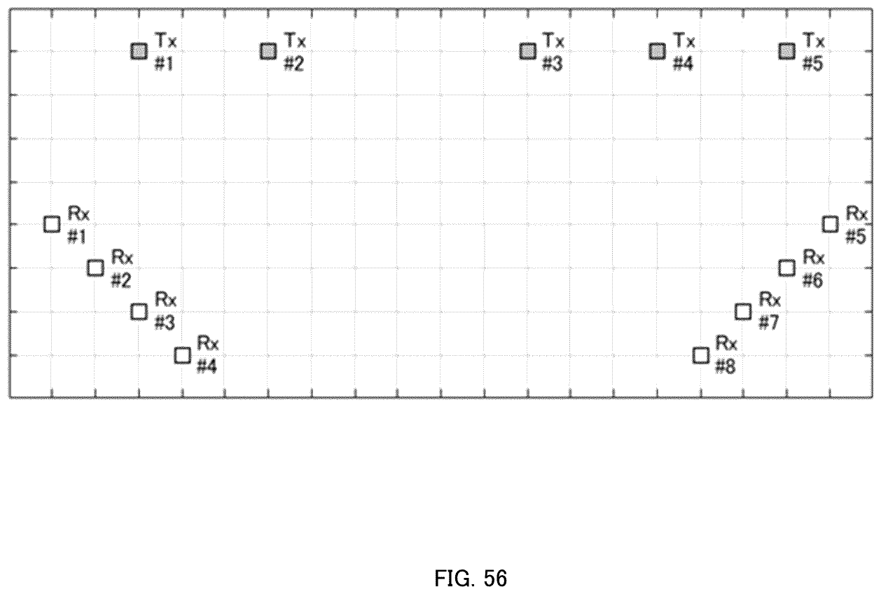

In the antenna arrangement example illustrated in FIG. 56 (hereinafter, referred to as “Arrangement Example 1-6a”), transmission antennas 106 may be arranged at unequal spacings (or non-uniform spacings). In FIG. 56, configurations differing from the arrangement spacings of transmission antennas 106 may be the same as those in Arrangement Example 1 (for example, FIG. 8).

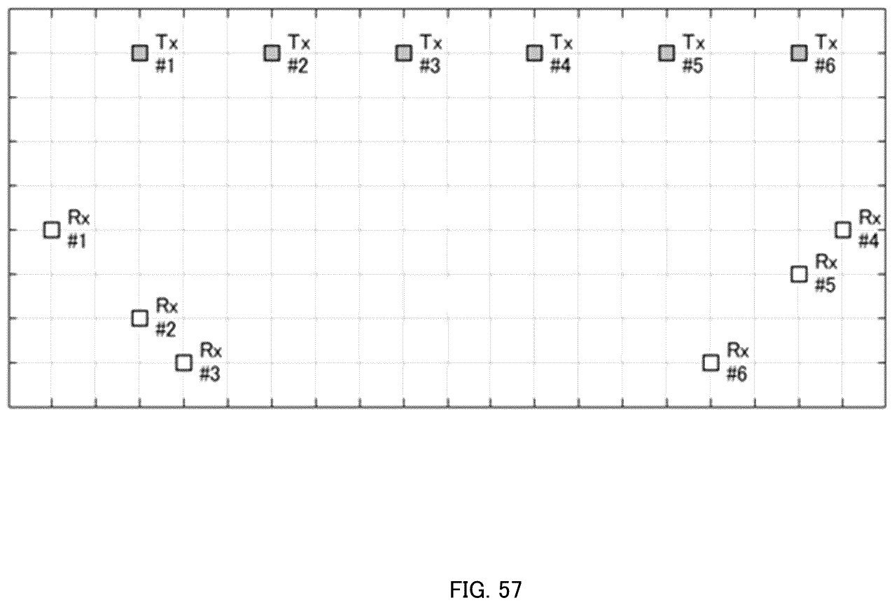

Further, in the antenna arrangement example illustrated in FIG. 57 (hereinafter, referred to as “Arrangement Example 1-6b”), the first oblique antenna group and the second oblique antenna group may be arranged at unequal spacings (or non-uniform spacings). In FIG. 57, configurations differing from the arrangement spacings of the first oblique antenna group and the second oblique antenna group may be the same as those in Arrangement Example 1 (for example, FIG. 8).

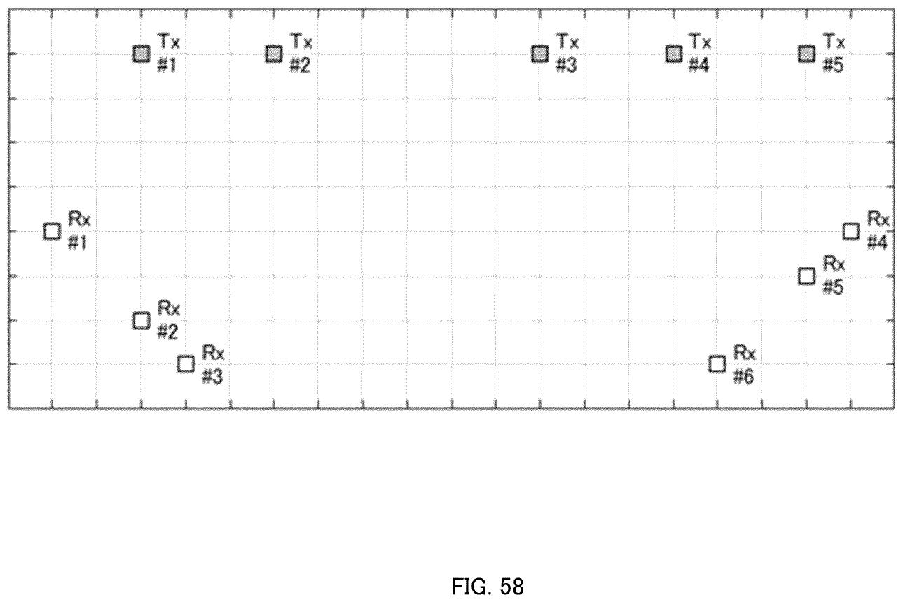

Further, in the antenna arrangement example illustrated in FIG. 58 (hereinafter, referred to as “Arrangement Example 1-6c”), transmission antennas 106, the first oblique antenna group, and the second oblique antenna group may be arranged at unequal spacings (or non-uniform spacings). In FIG. 58, configurations differing from the arrangement spacings of transmission antennas 106, the first oblique antenna group, and the second oblique antenna group may be the same as those in Arrangement Example 1 (for example, FIG. 8).

Also in the antenna arrangements illustrated in FIGS. 56 to 58, the peak levels in the grating-lobe directions are suppressed as compared with the peak in the target-true-value direction.

Note that the arrangement is not limited to the above-described arrangement examples, and either the first oblique antenna group or the second oblique antenna group may be arranged at non-uniform spacings, for example, or either the first oblique antenna group or the second oblique antenna group and transmission antennas 106 may be arranged at non-uniform spacings.

### Variation 7 of Arrangement Example 1

In Variation 7 of Arrangement Example 1, for example, a multi-stage configuration may be applied to the antenna arrangements described in Arrangement Example 1 and Variations 1 to 6 of Arrangement Example 1.

The multi-stage configuration includes, for example, a configuration in which transmission antennas 106 are arranged in two stages in the vertical direction, a configuration in which transmission antennas 106 are arranged in two stages in the horizontal direction, a configuration in which the first oblique antenna group and the second oblique antenna group of reception antennas 202 are arranged in two stages in the vertical direction, and a configuration in which the first oblique antenna group and the second oblique antenna group of reception antennas 202 are arranged in two stages in the horizontal direction. Alternatively, the multi-stage configuration may be a configuration in which these configurations are combined with one another.

Also in the case of the multi-stage configuration, the effects according to above-described Arrangement Example 1 can be maintained. Further, the horizontal multi-stage configuration increases the aperture length of the virtual reception array in the horizontal direction, and improves the horizontal angular measurement accuracy or horizontal resolution in radar apparatus 10. Further, for example, the aperture length of the virtual reception array in the vertical direction is widened by the vertical multi-stage configuration, and the angular measurement accuracy or the resolution in the vertical direction in radar apparatus 10 can be improved. In addition, for example, the aperture lengths of the virtual reception array in the vertical direction and the horizontal direction are widened by the horizontal and vertical multi-stage configurations, and the angular measurement accuracy or the resolution in the vertical direction and the horizontal direction in radar apparatus 10 can be improved.

Note that, in the case of the multi-stage configurations, a common arrangement for transmission antennas Tx or reception antennas Rx may be configured in multiple stages in at least one of the vertical direction and the horizontal direction, or different arrangements for transmission antennas Tx or reception antennas Rx may be configured in multiple stages in at least one of the vertical direction and the horizontal direction.

Hereinafter, an example of the antenna arrangement in Arrangement Example 1-7 will be described.

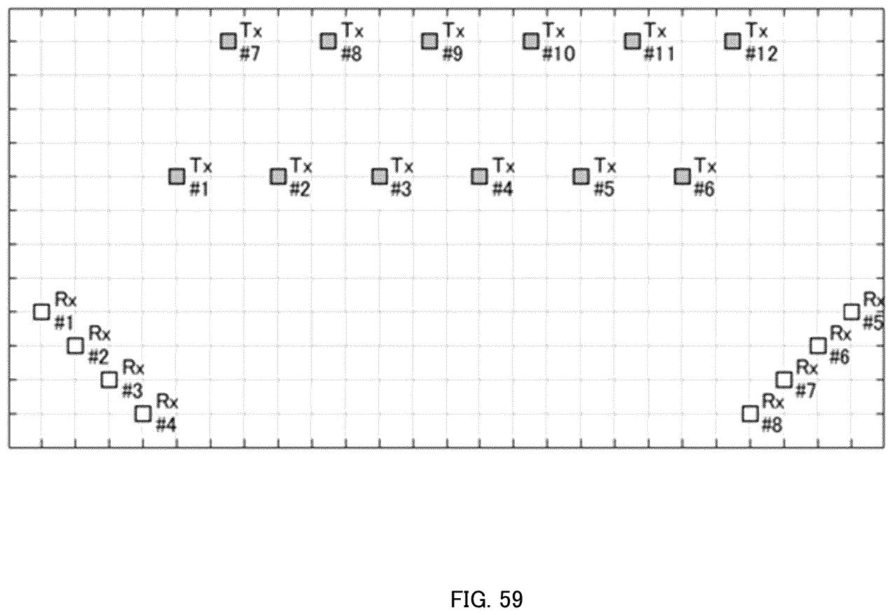

For example, in FIG. 59 (hereinafter referred to as “Arrangement Example 1-7a”), Tx #1 to Tx #6 and Tx #7 to Tx #12 having the same arrangement as Tx #1 to Tx #6 are vertically shifted from each other and arranged in multiple stages. For example, in FIG. 59, the plurality of transmission antennas 106 include a plurality of sets of six horizontally arranged antennas (e.g., a set of Tx #1 to #6 and a set of Tx #7 to #12).

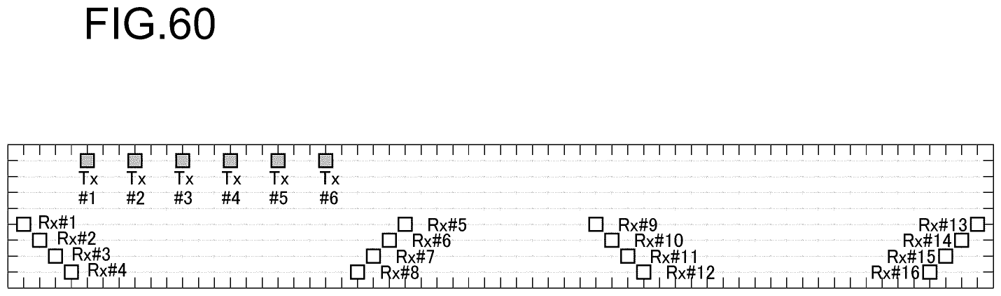

Further, for example, in FIG. 60 (hereinafter referred to as “Arrangement Example 1-7b”), Rx #1 to Rx #8 and Rx #9 to Rx #16 having the same arrangement as Rx #1 to Rx #8 are horizontally shifted from each other and arranged in multiple stages. For example, in FIG. 60, the plurality of reception antennas 202 include a plurality of sets of the first oblique antenna group and a plurality of sets of the second oblique antenna group (for example, sets of Rx #1 to #8 and sets of Rx #9 to #16).

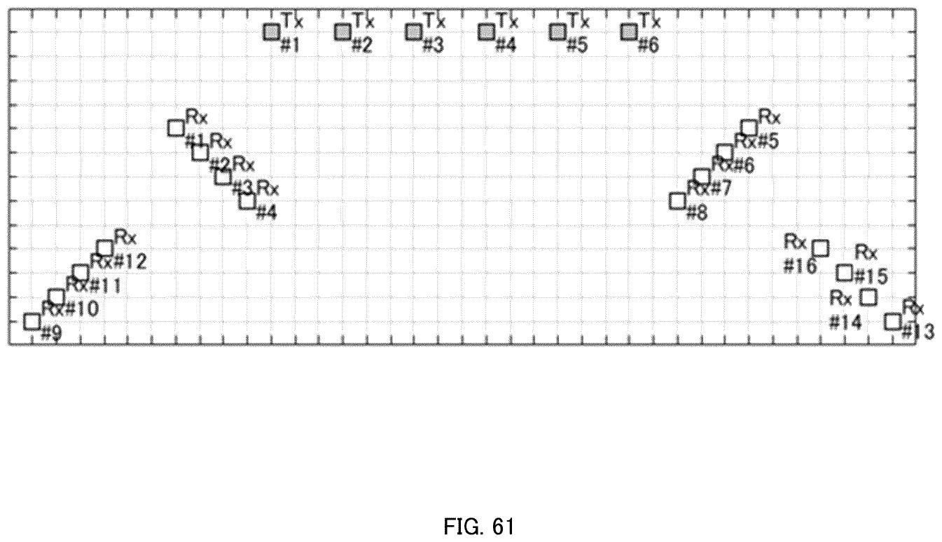

Further, for example, in FIG. 61 (hereinafter, referred to as “Arrangement Example 1-7c”), Rx #1 to Rx #8 and Rx #9 to Rx #16 arranged differently from Rx #1 to Rx #8 are vertically arranged in multiple stages. For example, in FIG. 61, the plurality of reception antennas 202 include a plurality of sets of the first oblique antenna group and a plurality of sets of the second oblique antenna group (for example, sets of Rx #1 to #8 and sets of Rx #9 to #16).

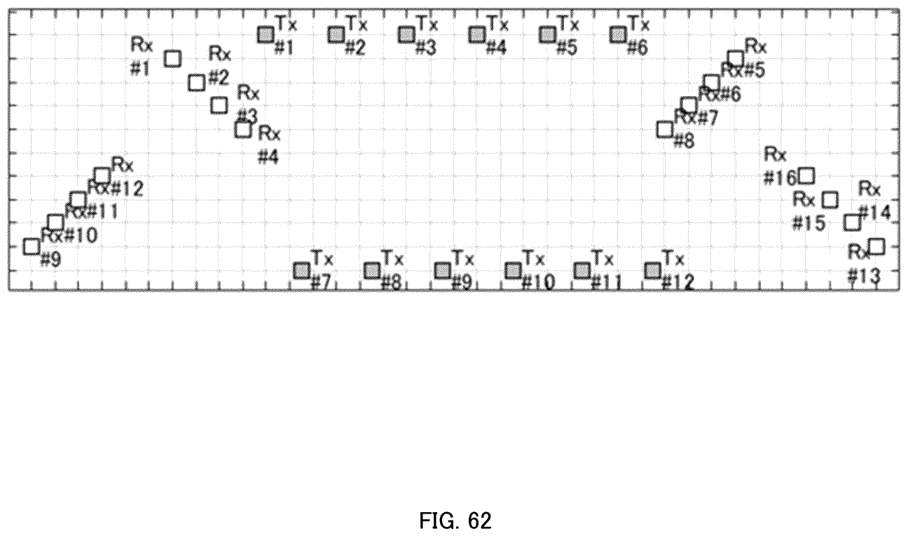

In addition, for example, in FIG. 62 (hereinafter, referred to as “Arrangement Example 1-7d”), Tx #1 to Tx #6 and Tx #7 to Tx #8 arranged the same as Tx #1 to Tx #6 are vertically shifted from each other and arranged in multiple stages, and Rx #1 to Rx #8 and Rx #9 to Rx #16 arranged differently from Rx #1 to Rx #8 are arranged in multiple stages in the vertical direction. For example, in FIG. 62, the plurality of transmission antennas 106 include a plurality of sets of six horizontally arranged antennas (e.g., a set of Tx #1 to #6, and a set of Tx #7 to #12). In addition, in FIG. 62, the plurality of reception antennas 202 include a plurality of sets of the first oblique antenna group and a plurality of sets of the second oblique antenna group (for example, sets of Rx #1 to #8 and sets of Rx #9 to #16).

From the arrangement of the transmission antennas and the arrangement of the reception antennas as illustrated in FIGS. 59 to 62, the position coordinates of the virtual antennas constituting the virtual reception array antenna are calculated based on Expression 16.

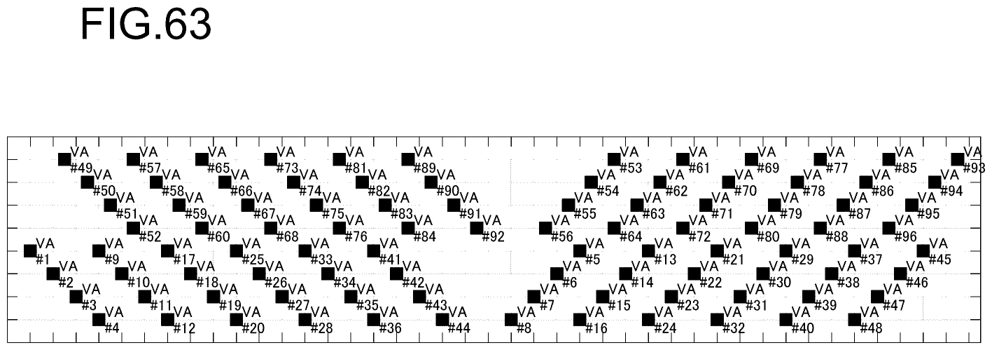

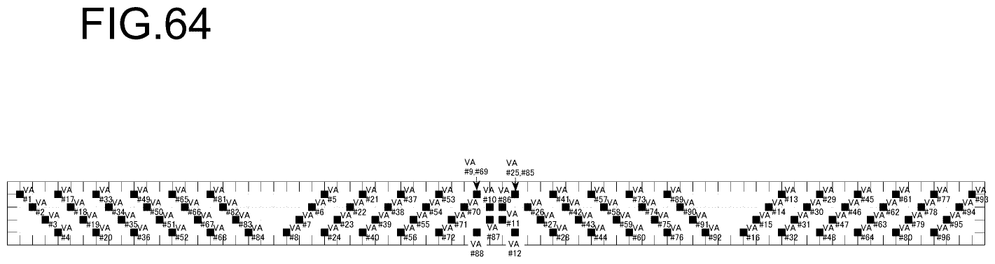

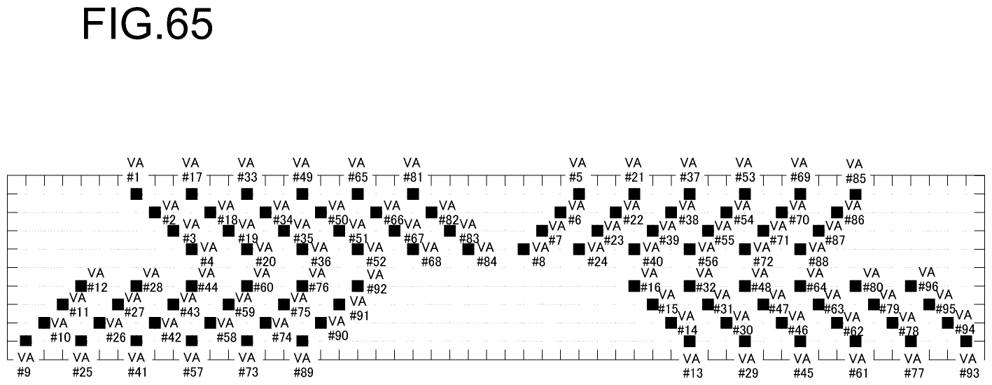

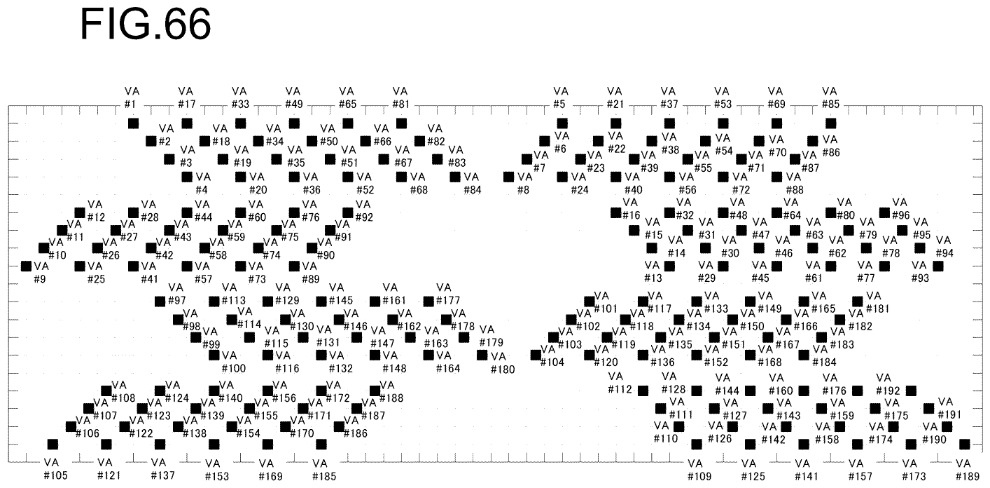

FIGS. 63 to 66 are diagrams illustrating arrangement examples of virtual reception arrays obtained by the antenna arrangements illustrated in FIGS. 59 to 62, respectively.

Next, an example of the direction estimation result (computer simulation result) obtained when the antenna arrangement according to each of above-described Arrangement Example 1-7a to Arrangement Example 1-7d is applied will be described.

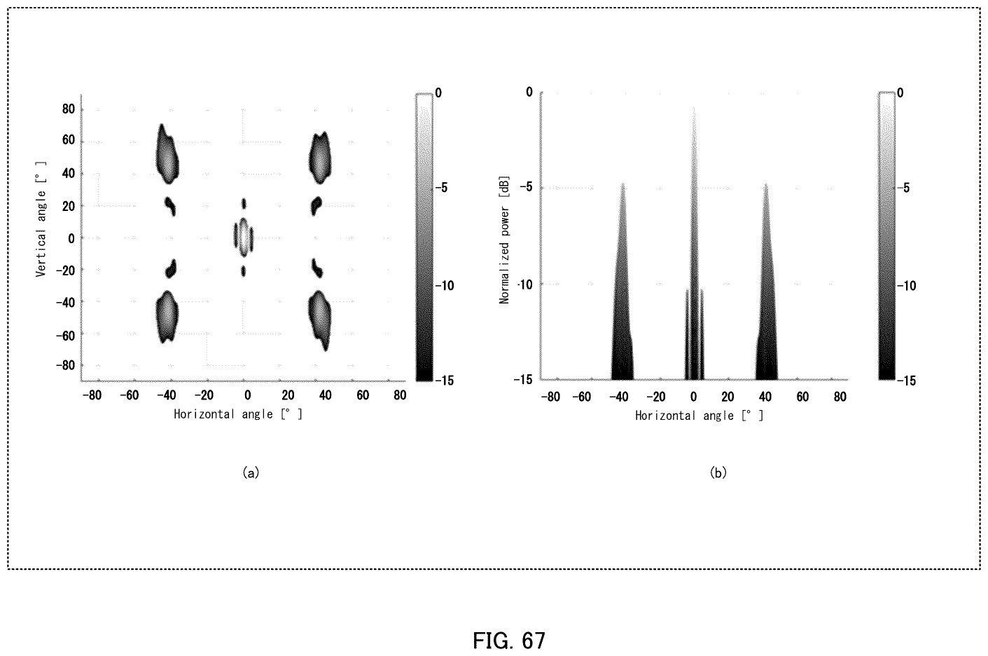

Each of FIGS. 67 to 70 illustrates a direction estimation result obtained when a MIMO array arrangement (D_{H}=0.5λ, D_{V}=0.5λ) of Arrangement Example 1-7 illustrated in each of FIGS. 59 to 62 is used and the beamformer method is used as a direction-of-arrival estimation algorithm of direction estimator 213. By way of example, FIGS. 67 to 70 illustrate plotted outputs of the direction-of-arrival estimation evaluation function values as obtained within the range of ±90 degrees in the horizontal direction and within the range of ±90 degrees in the vertical direction on the assumption that the target true value is at horizontal 0 degrees and vertical 0 degrees.

Note that parts (a) in FIGS. 67 to 70 are a diagram illustrating normalized power values in two-dimensional directions of the horizontal direction as the horizontal axis and the vertical direction as the vertical axis in a grayscale color map. Further, with respect to parts (a) of FIGS. 67 to 70, parts (b) of FIGS. 67 to 70 illustrate grayscale color maps in which the horizontal axis denotes the horizontal direction, and the vertical axis denotes the normalized power values. In FIGS. 67 to 70, the normalized power values may be represented by, for example, a decibel value (dB) normalized by the peak power.

As illustrated in FIGS. 67 to 70, in Arrangement Examples 1-7a to 1-7d, as in Arrangement Example 1 (FIG. 10), the peak levels in the grating-lobe directions are suppressed as compared with the peak in the target-true-value direction.

Further, in Arrangement Example 1-7a (FIG. 59) as compared with Arrangement Example 1 (FIG. 8), the number of transmission antennas Tx are increased, and elements of transmission antennas 106 are vertically shifted for multistage arrangement. Therefore, in Arrangement Example 1-7a, the aperture length of the virtual reception array in the vertical direction is widened. Thus, as illustrated in FIG. 67, the peak in the target-true-value direction becomes sharper in the vertical direction, and the angular measurement accuracy or the estimation accuracy in the vertical direction in radar apparatus 10 can be improved.

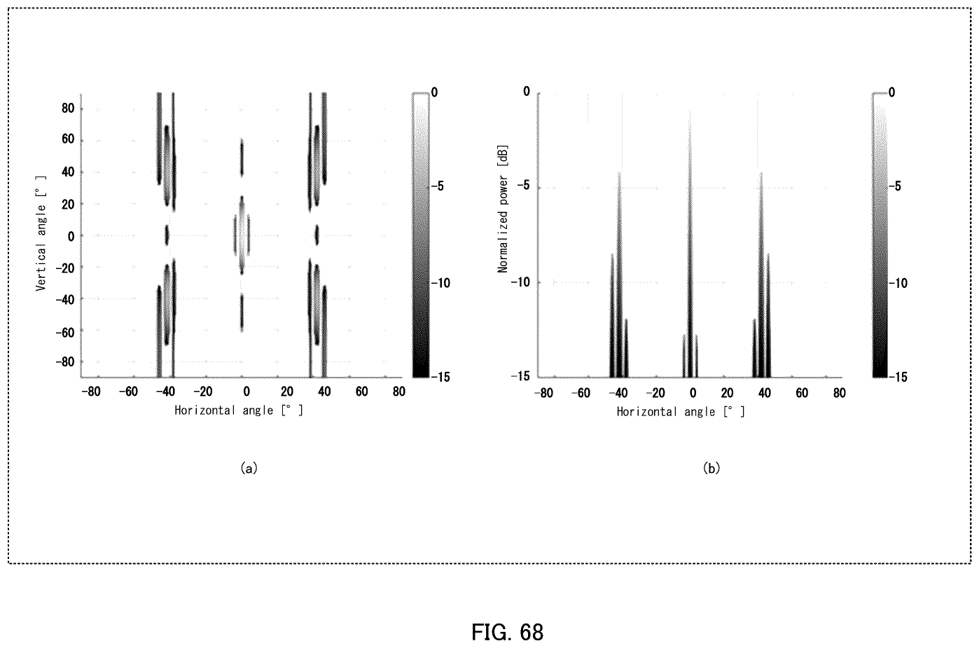

Further, in Arrangement Example 1-7b (FIG. 60), the number of reception antennas Rx are increased as compared with Arrangement Example 1 (FIG. 8), and elements of reception antennas 202 are horizontally shifted for multistage arrangement. Therefore, in Arrangement Example 1-7b, the aperture length of the virtual reception array in the horizontal direction is widened. Thus, as illustrated in FIG. 68, the peak in the target-true-value direction becomes sharper in the horizontal direction, and the horizontal angular measurement accuracy or the horizontal estimation accuracy in radar apparatus 10 can be improved.

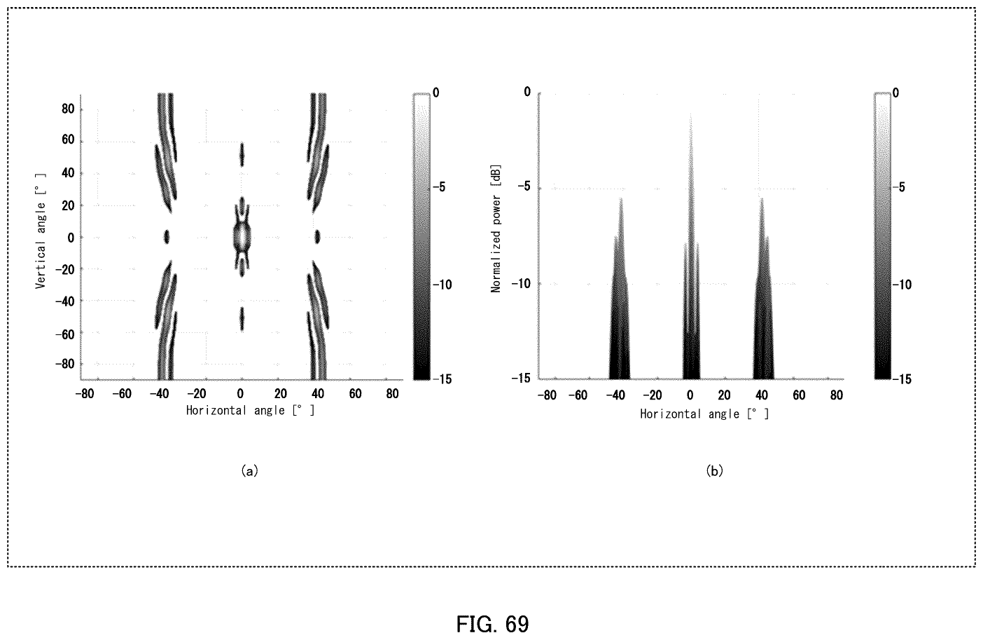

Further, in Arrangement Example 1-7c (FIG. 61), the number of reception antennas Rx is increased as compared with Arrangement Example 1 (FIG. 8), and elements of reception antennas 202 are vertically shifted for multistage arrangement. Therefore, in Arrangement Example 1-7c, the aperture length of the virtual reception array in the vertical direction is widened. Thus, as illustrated in FIG. 69, the peak in the target-true-value direction becomes sharper in the vertical direction, and the angular measurement accuracy or the estimation accuracy in the vertical direction in radar apparatus 10 can be improved.

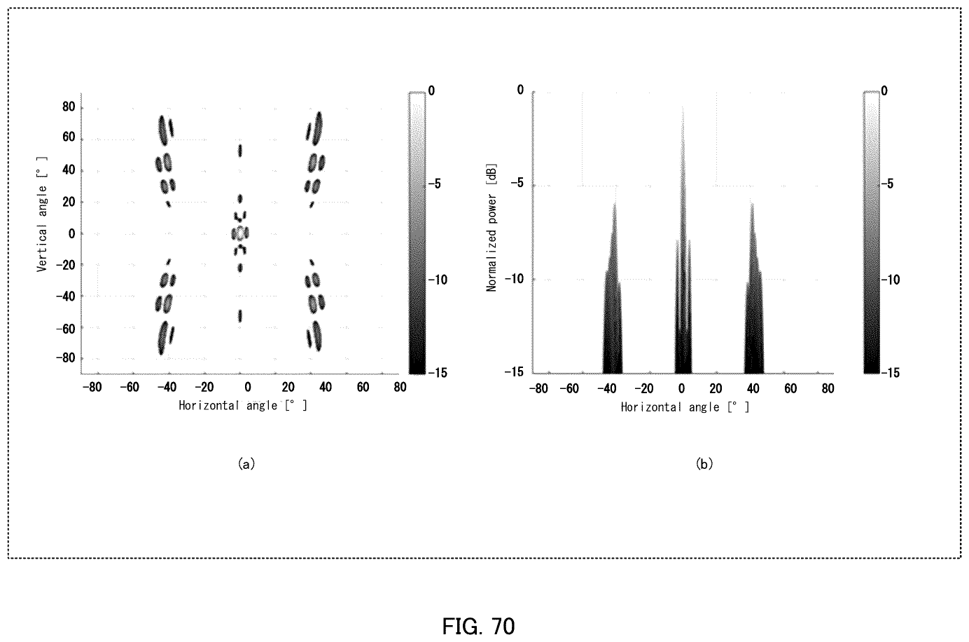

Further, in Arrangement Example 1-7d (FIG. 62), as compared with Arrangement Example 1 (FIG. 8), the number of transmission antennas Tx and the number of reception antennas Rx are increased, and the elements of both transmission antennas 106 and reception antennas 202 are vertically shifted for multistage arrangement. Therefore, in Arrangement Example 1-7d, the aperture length of the virtual reception array in the vertical direction is widened. Thus, as illustrated in FIG. 70, the peak in the target-true-value direction becomes sharper in the vertical direction as compared with Arrangement Example 1-7a (for example, FIG. 59), and the angular measurement accuracy or the estimation accuracy in radar apparatus 10 in the vertical direction can be improved.

Note that different antenna elements (e.g., antenna elements having different sizes) may be used in combination in the multi-stage configuration in Arrangement Example 1-7. For example, the plurality of transmission antennas 106 may include Long Range (LR) antenna elements and Short Range (SR) antenna elements. Here, the LR antenna elements are those in which the directivity gains of the antenna elements are further increased by narrowing down the directivities of in the vertical direction or the horizontal direction or in both the directions as compared with the SR antenna elements. By using the LR antenna elements, radar apparatus 10 can increase the reception signal levels of reflected waves from a target object at a longer distance than when using the SR antenna elements, and can detect the target object at a longer distance. Since the LR antenna elements have higher directivity gains in the vertical direction, the horizontal direction, or both of the directions, the physical size thereof becomes larger in the vertical direction, the horizontal direction, or both of the directions than the size of the SR antenna elements.

For example, in the multi-stage configuration, the long range (LR) antenna elements may be used in the first stage, and the short distance (SR) antenna elements may be used in combination in the second stage. For example, as illustrated in FIG. 59, when transmission antennas 106 are vertically arranged in a multi-stage configuration with two stages, the long range (LR) antenna elements may be applied in the first stage (e.g., Tx #1 to Tx #6), and the short range (SR) antenna elements may be applied in the second stage (e.g., Tx #7 to Tx #12).

When the long range (LR) antenna elements are large in the vertical direction and the horizontal direction, the elements of the first stage may be shifted in the horizontal direction so that transmission antennas 106 of the first stage and transmission antennas 106 of the second stage do not overlap each other.

As described above, when the LR antennas and the SR antennas are used for transmission antennas 106, for example, the SR antennas (for example, those antennas characterized by a wide viewing angle) may be applied to reception antennas 202. Thus, the effects of Arrangement Example 1 are still obtained and simultaneously the detection range of both LR and SR modes can be covered.

### Variation 8 of Arrangement Example 1

Although Arrangement Condition 1 has been described in relation to the case where the arrangement direction of N_{Tx} transmission antennas 106 is the horizontal direction, the arrangement direction of N_{Tx} transmission antennas 106 does not have to strictly coincide with the horizontal direction.

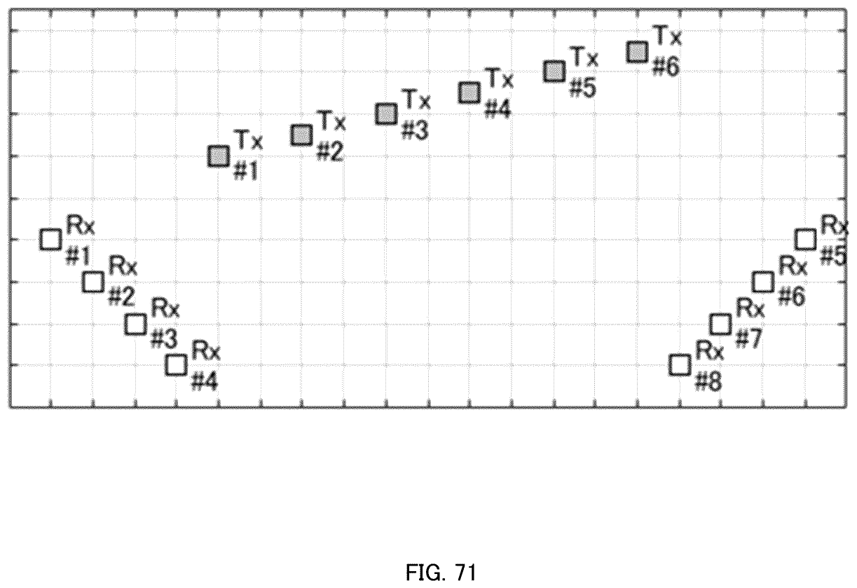

For example, as illustrated in FIG. 71 (hereinafter, referred to as “Arrangement Example 1-8”), transmission antennas Tx #1 to #6 may be horizontally shifted from one another from left to right in the figure by spacings of one wavelength (e.g., 2D_{H}), and may be shifted in the vertical direction by spacings of 0.25 wavelengths (e.g., 0.5D_{V}) at the same time. For example, when the inclination of transmission antennas 106 with respect to the horizontal direction is gentle to the degree illustrated in FIG. 71, the antenna arrangement illustrated in FIG. 71 may be included in the arrangements satisfying Arrangement Condition 1. Note that the arrangement of reception antennas Rx #1 to Rx #8 is not limited to that in FIG. 71, and other arrangements may be used.

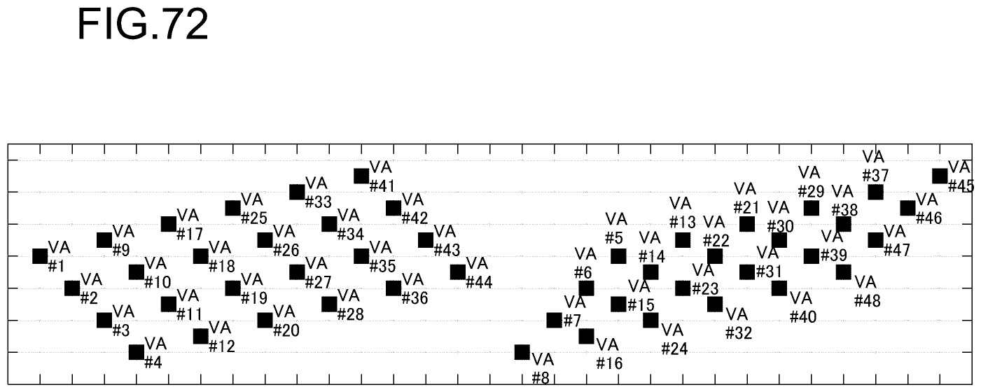

From the arrangement of transmission antennas Tx #1 to Tx #6 and the arrangement of reception antennas Rx #1 to Rx #8 as illustrated in FIG. 71, the position coordinates of virtual antennas VA #1 to #48 constituting the virtual reception array antenna are calculated based on Expression 16. FIG. 72 is a diagram illustrating an arrangement example of a virtual reception array obtained by the antenna arrangement illustrated in FIG. 71.

Next, an example of a direction estimation result (computer simulation result) in the case where the antenna arrangement according to above-described Arrangement Example 1-8 is applied will be described.

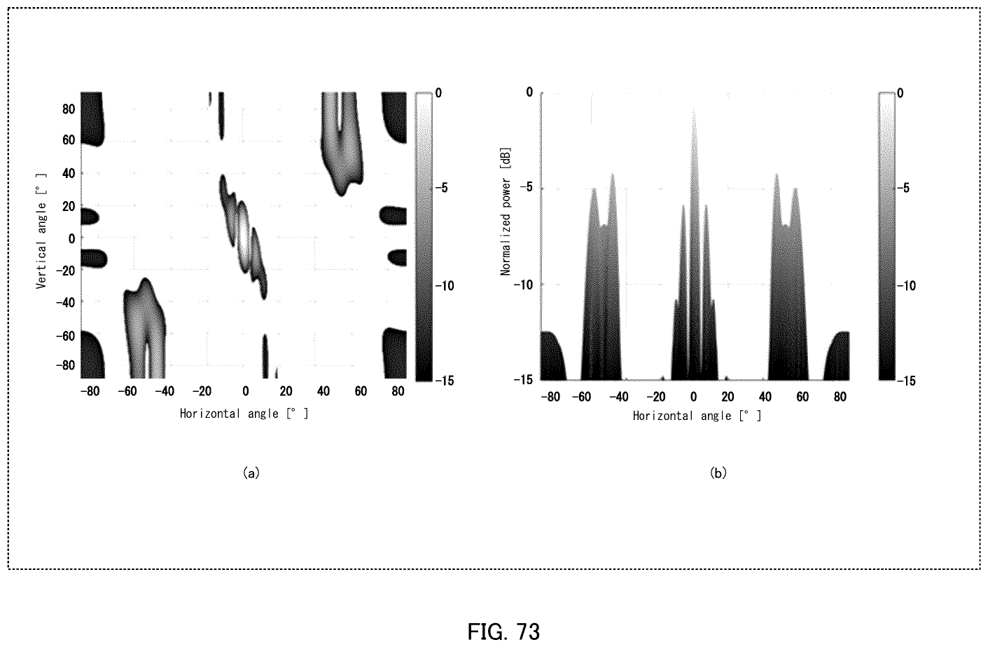

FIG. 73 illustrates a direction estimation result obtained when a MIMO array arrangement (D_{H}=0.5λ, D_{V}=0.5λ) of Arrangement Example 1-8 is used and the beamformer method is used as a direction-of-arrival estimation algorithm of direction estimator 213. By way of example, FIG. 73 illustrates plotted outputs of the direction-of-arrival estimation evaluation function values as obtained within the range of ±90 degrees in the horizontal direction and within the range of ±90 degrees in the vertical direction on the assumption that the target true value is at horizontal 0 degrees and vertical 0 degrees.

Note that (a) in FIG. 73 is a diagram illustrating normalized power values in two-dimensional directions of the horizontal direction as the horizontal axis and the vertical direction as the vertical axis in a grayscale color map. Further, with respect to (a) of FIG. 73, (b) of FIG. 73 illustrates a grayscale color map in which the horizontal axis denotes the horizontal direction, and the vertical axis denotes the normalized power values. In FIG. 73, the normalized power values may be represented by, for example, a decibel value (dB) normalized by the peak power.

As illustrated in FIG. 73, in Arrangement Example 1-8 as in Arrangement Example 1 (for example, FIG. 10), peak levels in the grating-lobe directions are suppressed as compared with the peak in the target-true-value direction.

Further, in Arrangement Example 1-8, transmission antennas 106 are arranged gently obliquely with respect to the horizontal direction as compared with Arrangement Example 1 (for example, FIG. 8). For example, in Arrangement Example 1-8, the arrangement of transmission antennas 106 also has a vertical extension. Therefore, the aperture length in the vertical direction is extended in the virtual reception array arrangement. Thus, as illustrated in FIG. 73, the peak in the target-true-value direction becomes sharper in the vertical direction, and the angular measurement accuracy or the estimation accuracy in radar apparatus 10 in the vertical direction can be improved. In Arrangement Example 1-8, since the transmission beam direction is gently inclined obliquely, it is likely that the generation range of the grating lobes expands in the horizontal direction.

The variations of Arrangement Example 1 have been described above.

### [Minimum Antenna Configuration Under Arrangement Condition 1 and Arrangement Example of Small Number of Antennas]

Hereinafter, a minimum antenna configuration satisfying Arrangement Condition 1 and an arrangement example in a case where the number of antennas satisfying Arrangement Condition 1 is small will be described. It should be noted that the same effect can be obtained even when the antenna arrangement described below is modified in accordance with the variations of Arrangement Example 1 described above.

The minimum number of antennas under Arrangement Condition 1 is, for example, the number in a case where number N_{Tx} of transmission antennas=2 and number Na of reception antennas=3. For example, the number of transmission antennas 106 is 2, and the total number of antennas of the first oblique antenna group and the second oblique antenna group is 3.

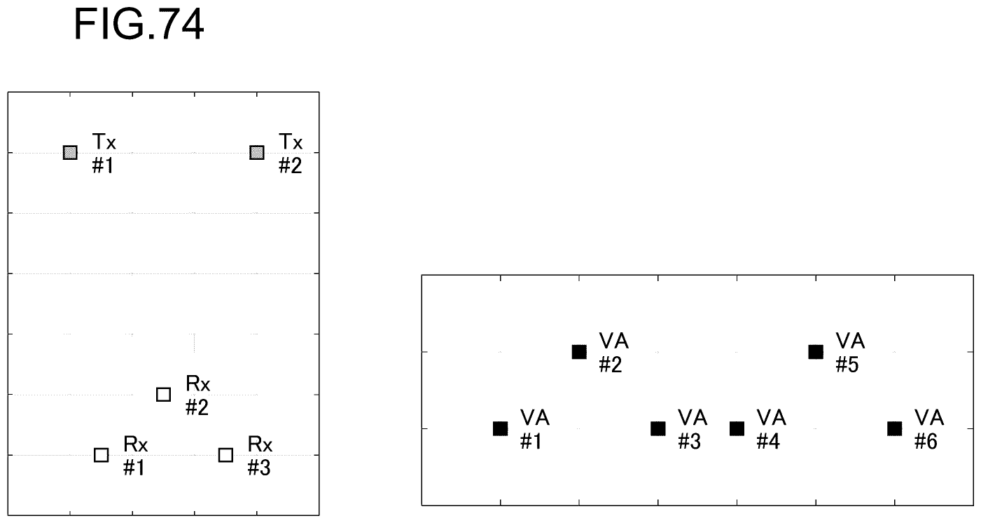

FIG. 74 illustrates an antenna arrangement example of the minimum number of antennas (number N_{Tx} of transmission antennas=2 and number Na of reception antennas=3) under Arrangement Condition 1. Part (a) of FIG. 74 illustrates an example of the MIMO antenna arrangement, and part (b) of FIG. 74 illustrates an example of the virtual reception array arrangement configured by the MIMO antenna arrangement illustrated at part (a) of FIG. 74. In FIG. 74, the scales of the horizontal axis and the vertical axis are, for example, D_{H} and D_{V}, respectively.

In FIG. 74, the first oblique antenna group includes Rx #1 and Rx #2, and the second oblique antenna group includes Rx #2 and Rx #3.

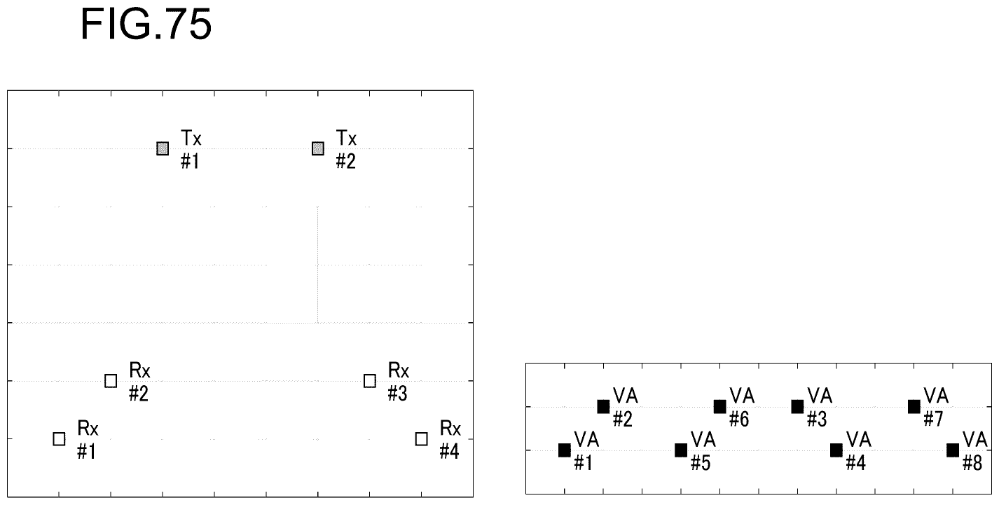

In addition, FIGS. 75 to 79 illustrate antenna arrangement examples for cases where the number of antennas satisfying Arrangement Condition 1 is small. Parts (a) of FIGS. 75 to 79 illustrate examples of the MIMO antenna arrangement, and parts (b) of FIGS. 75 to 79 illustrate examples of the virtual reception array arrangement configured by the MIMO antenna arrangement illustrated at parts (a) of FIGS. 75 to 79. In FIGS. 75 to 79, the scales of the horizontal axis and the vertical axis are, for example, D_{H} and D_{V}, respectively.

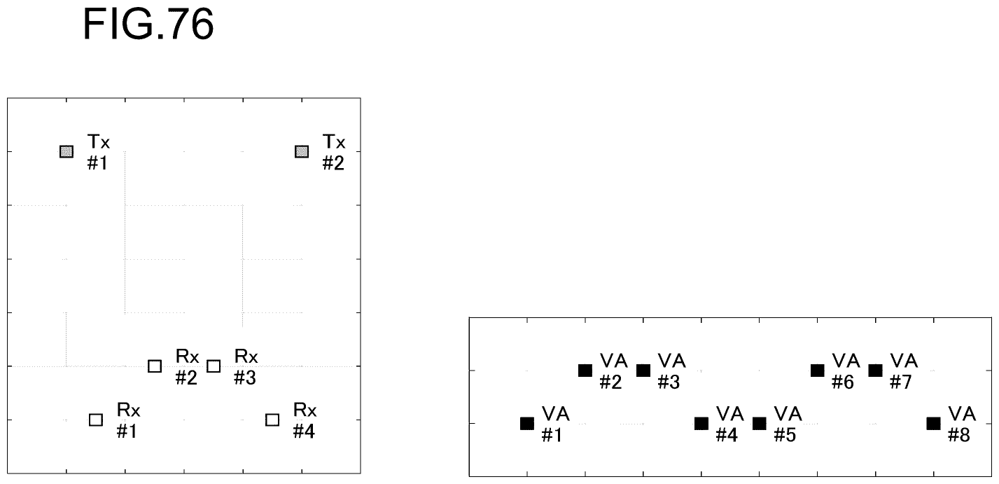

For example, FIGS. 75 and 76 indicate antenna arrangement examples for a case where number N_{Tx} of transmission antennas=2 and number Na of reception antennas=4. In FIG. 75 and FIG. 76, the first oblique antenna group includes Rx #1 and Rx #2, and the second oblique antenna group includes Rx #3 and Rx #4.

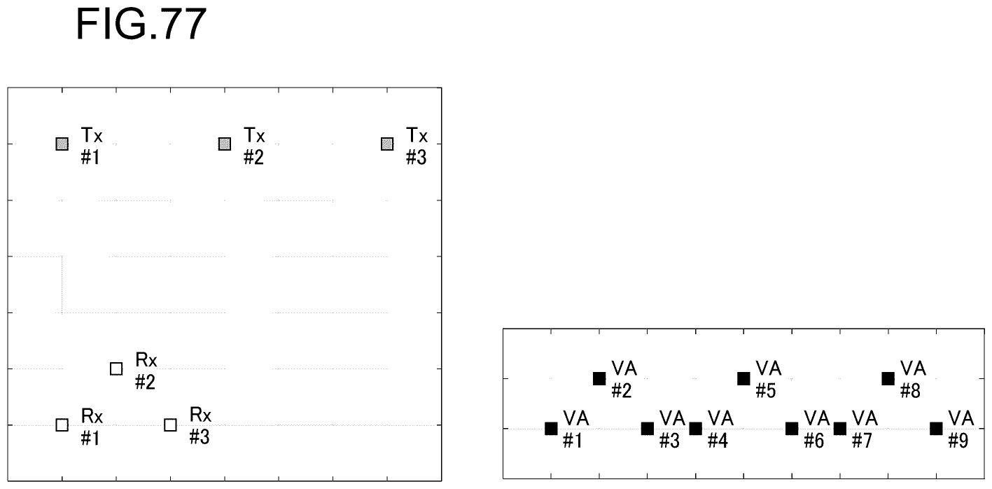

Further, for example, FIG. 77 illustrates an antenna arrangement example when number N_{Tx} of transmission antennas=3 and number Na of reception antennas=3. In FIG. 77, the first oblique antenna group includes Rx #1 and Rx #2, and the second oblique antenna group includes Rx #2 and Rx #3.

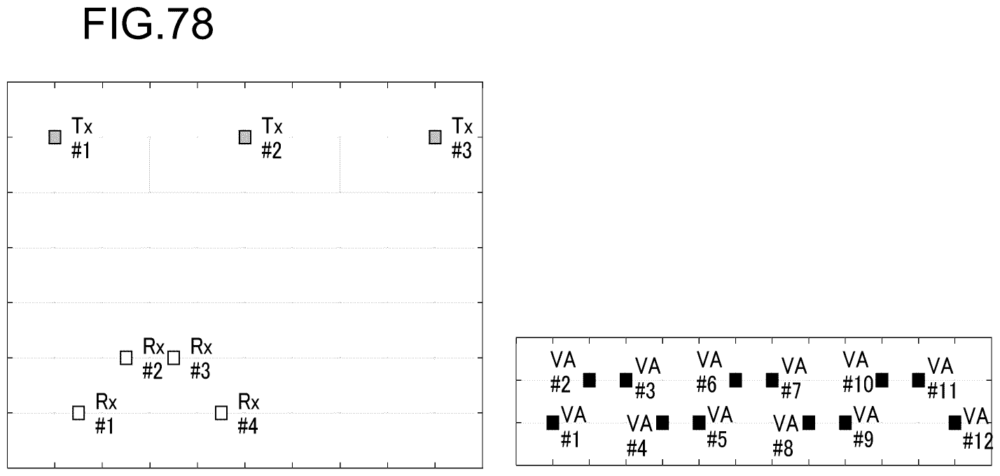

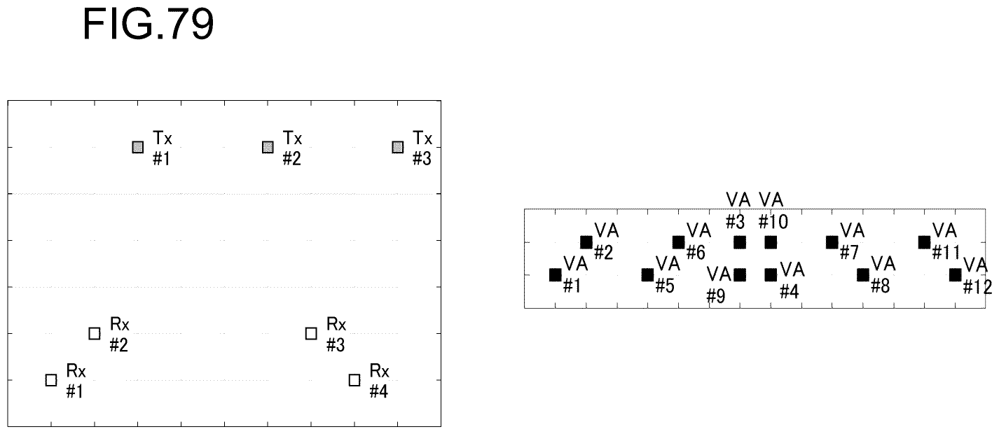

Further, for example, FIGS. 78 and 79 indicate an antenna arrangement example for a case where number N_{Tx} of transmission antennas=3 and number Na of reception antennas=4. In FIGS. 78 and 79, the first oblique antenna group includes Rx #1 and Rx #2, and the second oblique antenna group includes Rx #3 and Rx #4.

The examples under Arrangement Condition 1 have been described above.

### [Arrangement Condition 2]

N_{Tx} transmission antennas 106 include the “first oblique antenna group” disposed in the “first oblique direction” and the “second oblique antenna group” disposed in the “second oblique direction,” and the first oblique direction and the second oblique direction are not parallel to each other. For example, the first oblique direction and the second oblique direction are directions different from each other.

Na reception antennas 202 include a “third oblique antenna group” arranged in the “third oblique direction” and a “fourth oblique antenna group” arranged in the “fourth oblique direction,” and the third oblique direction and the fourth oblique direction are not parallel to each other. For example, the third oblique direction and the fourth oblique direction are directions different from each other.

Note that each of the first oblique antenna group (for example, corresponding to the third antenna group) and the second oblique antenna group (for example, corresponding to the fourth antenna group) may include at least two transmission antennas 106. Further, each of the third oblique antenna group (for example, corresponding to the first antenna group) and the fourth oblique antenna group (for example, corresponding to the second antenna group) may include at least two reception antennas 202.

The grating lobes can be suppressed by arranging, at arbitrary positions, the first oblique antenna group and the second oblique antenna group satisfying Arrangement Condition 2. For example, as illustrated in the following arrangement example or variations, arrangement in which horizontal directions of both the first oblique antenna group and the second oblique antenna group do not overlap each other allows arrangement of transmission antenna elements having a large size in the vertical direction.

Similarly, the grating lobes can be suppressed by arranging the third oblique antenna group and the fourth oblique antenna group satisfying Arrangement Condition 2 at arbitrary positions. For example, as illustrated in the following arrangement example or variations, arrangement in which horizontal directions of both the third oblique antenna group and the fourth oblique antenna group do not overlap each other allows arrangement of reception antenna elements having a large size in the vertical direction.

Under Arrangement Condition 2, for example, transmission antennas 106 include the first oblique antenna group disposed in the first oblique direction and the second oblique antenna group disposed in the second oblique direction. Thus, the aperture length of the virtual reception array in the vertical direction can be further enlarged as compared with Arrangement Condition 1, and thus the angular measurement accuracy or resolution in radar apparatus 10 in the vertical direction can be improved.

In addition, under Arrangement Condition 2, for example, the grating lobes in the vertical direction that occur when the inclinations of the first to fourth oblique directions are made steeper with respect to the horizontal direction can be suppressed. As a result of this suppression effect for suppressing the grating lobes, the vertical aperture length can further increase and the vertical angular measurement accuracy or vertical resolution in radar apparatus 10 can further be improved.

Hereinafter, an example under Arrangement Condition 2 will be described. Hereinafter, an arrangement example satisfying Arrangement Condition 2 and an example of a direction estimation result by computer simulation in the arrangement example will be described.

### Arrangement Example 2

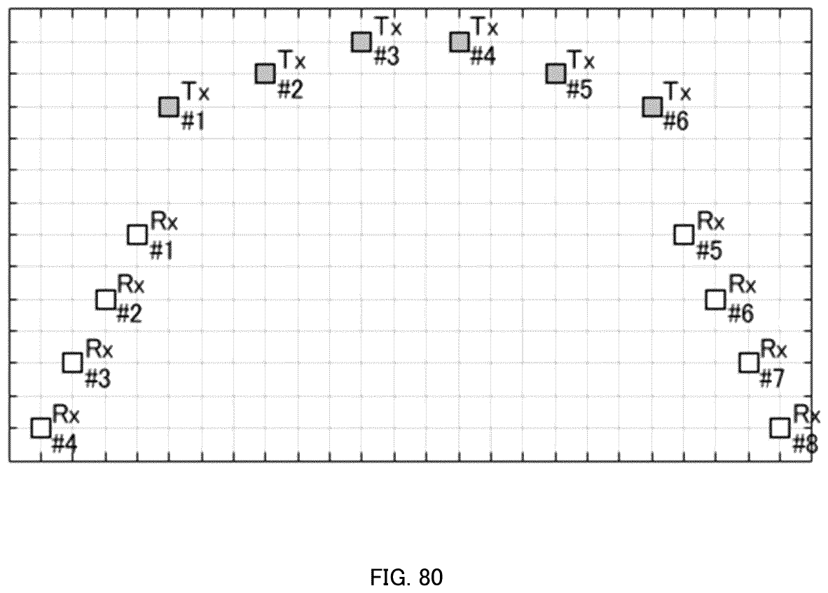

FIG. 80 is a diagram illustrating an arrangement example (for example, a MIMO antenna arrangement example) of transmission antennas 106 (for example, represented by Tx) and reception antennas 202 (for example, represented by Rx) according to Arrangement Example 2. In FIG. 80, the scales of the horizontal axis and the vertical axis are, for example, basic spacing D_{H} in the horizontal direction and basic spacing D_{V} in the vertical direction. Note that the scales of the horizontal axis and the vertical axis are the same for the MIMO antenna arrangement in the following other examples. By way of example, D_{H} and D_{V} may be spacings of 0.5 wavelengths.

In the example of FIG. 80, number N_{Tx} of transmission antennas is six (e.g., Tx #1, Tx #2, Tx #3, Tx #4, Tx #5 and Tx #6), and number Na of reception antennas is eight (e.g., Rx #1, Rx #2, Rx #3, Rx #5, Rx #6, Rx #7, and Rx #8).

In FIG. 80, N_{Tx} (=6) transmission antennas Tx #1 to #6 include first oblique antenna group of antennas Tx #1 to #3 arranged in the first oblique direction and second oblique antenna group of antennas Tx #4 to #6 arranged in the second oblique direction. In FIG. 80, the first oblique direction and the second oblique direction are not parallel to each other, but are directions that differ from each other.

In addition, in FIG. 80, Na (=8) reception antennas Rx #1 to #8 include the third oblique antenna group of antennas Rx #1 to #4 arranged in the third oblique direction and the fourth oblique antenna group of antennas Rx #5 to #8 arranged in the fourth oblique direction. In FIG. 80, the third oblique direction and the fourth oblique direction are not parallel to each other, but are different directions from each other.

Therefore, the antenna arrangement of Arrangement Example 2 illustrated in FIG. 80 satisfies Arrangement Condition 2.

In Arrangement Example 2, as illustrated in FIG. 80, the first to fourth oblique directions are not parallel to one another, but are different directions from one another.

For example, antennas Tx #1 to #3 of the first oblique antenna group illustrated in FIG. 80 are horizontally shifted from one another by spacings of 1.5 wavelengths from left to right in the figure, and are also vertically shifted upward from one another by spacings of 0.5 wavelengths at the same time. In addition, antennas Tx #4 to #6 of the second oblique antenna group illustrated in FIG. 80 are horizontally shifted from one another by spacings of 1.5 wavelengths from left to right in the figure, and also vertically shifted downward from one another by spacings of 0.5 wavelengths at the same time.

As described above, in FIG. 80, the antenna arrangement of the first oblique antenna group disposed in the first oblique direction and the antenna arrangement of the second oblique antenna group disposed in the second oblique direction have line symmetry with respect to a line parallel to the vertical direction (the line vertical to the horizontal direction). For example, the first oblique antenna group of antennas Tx #1 to #3 and the second oblique antenna group of antennas Tx #4 to #6 are arrangement having horizontal inversion symmetry (which is also referred to as left-right inversion symmetry or mirror symmetry).

Here, transmission antennas 106 (e.g., FIG. 8) of Arrangement Example 1 are horizontally arranged. On the other hand, as illustrated in FIG. 80, transmission antennas 106 of Arrangement Example 2 are arranged obliquely. For example, since transmission antennas 106 of Arrangement Example 2 are arranged in the two horizontal and vertical dimensions, the aperture in the vertical direction can be further enlarged in Arrangement Example 2 as compared with Arrangement Example 1.

In addition, for example, antennas Rx #1 to #4 of the third oblique antenna group illustrated in FIG. 80 are horizontally shifted from one another by spacings of 0.5 wavelengths from the right to the left in the figure, and are also vertically shifted downward from one another by spacings of one wavelength at the same time. In addition, antennas Rx #5 to #8 of the fourth oblique antenna group illustrated in FIG. 80 are horizontally shifted from one another by spacings of 0.5 wavelengths from left to right in the figure, and also vertically shifted downward from one another by spacings of one wavelength at the same time.

As described above, the antenna arrangement of the third oblique antenna group disposed in the third oblique direction and the antenna arrangement of the fourth oblique antenna group disposed in the fourth oblique direction have line symmetry with respect to a line parallel to the vertical direction (the line vertical to the horizontal direction). For example, the third oblique antenna group of antennas Rx #1 to #4 and the fourth oblique antenna group of antennas Rx #5 to #8 are arranged to have horizontal inversion symmetry.

For example, the inclinations of the third oblique antenna group of antennas Rx #1 to #4 and the fourth oblique antenna group of antennas Rx #5 to #8 in Arrangement Example 2 illustrated in FIG. 80 are steeper with respect to the horizontal direction as compared with the inclinations of the first oblique antenna group of antennas Rx #1 to #4 and the second oblique antenna group of antennas Rx #5 to #8 in Arrangement Example 1 (for example, FIG. 8). Thus, the aperture in the vertical direction can be further enlarged.

Further, for example, antennas Rx #1 to #4 of the third oblique antenna group and antennas Rx #5 to #8 of the fourth oblique antenna group of Arrangement Example 2 illustrated in FIG. 80 are vertically arranged at spacings of a wavelength equal to or greater than one wavelength. Therefore, the element spacings between the antennas of the third and fourth oblique antenna groups are spacings which may cause grating lobes in the vertical direction. In Arrangement Example 2, for example, the first to fourth oblique directions are not parallel to one another and different directions from one another. Thus, the grating lobes in the vertical direction can be suppressed by using different two-dimensional directions of the vertical direction and the horizontal direction in which the grating lobes are generated.

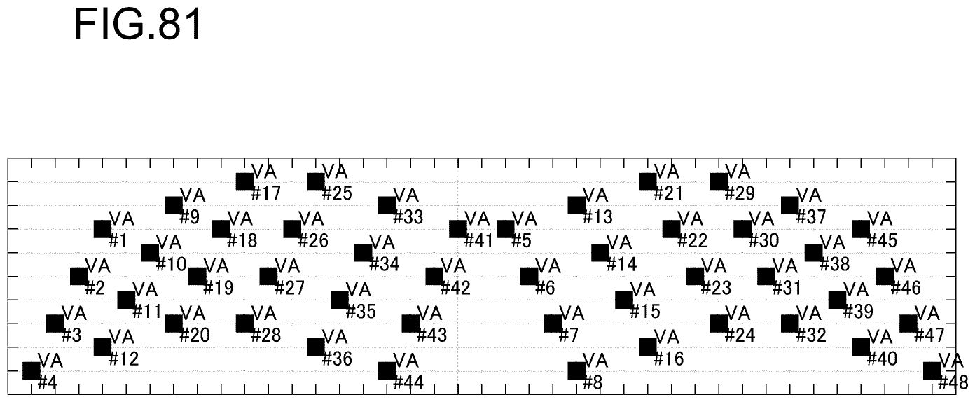

FIG. 81 is a diagram illustrating an arrangement example of a virtual reception array obtained by the antenna arrangement illustrated in FIG. 80.

Here, the arrangement of the virtual reception array may be expressed by following Expression 16, for example, based on the positions of transmission antennas 106 constituting the transmission array antenna (for example, the positions of feed points) and the positions of reception antennas 202 constituting the reception array antenna (for example, the positions of feed points).

The position coordinates of transmission antennas 106 (e.g., Tx #n) constituting the transmission array antenna are represented as (X_{T_#n}, Y_{T_#n}) (e.g., n=1, . . . , N_{Tx}), the position coordinates of reception antennas 202 (e.g., Rx #m) constituting the reception array antenna are represented as (X_{R_#m}, Y_{R_#m}) (e.g., m=1, . . . , Na), and the position coordinates of virtual antennas VA #k constituting a virtual reception array antenna are represented as (X_{V_#k}, Y_{V_#k}) (e.g., k=1, . . . , N_{Tx}×Na). In Expression 16, for example, VA #1 is expressed as the position reference (0, 0) of the virtual reception array.

For example, from the arrangement of transmission antennas Tx #1 to Tx #6 and the arrangement of reception antennas Rx #1 to Rx #8 as illustrated in FIG. 80, the position coordinates of virtual antennas VA #1 to #48 constituting the virtual reception array antenna are calculated from Expression 16. For example, the position coordinates of virtual antennas VA #1 to #16 are (X_{V_#1}, Y_{V_#1})=(0, 0), (X_{V_#2}, Y_{V_#2})=(−D_{H}, −2D_{V}), (X_{V_#3}, Y_{V_#3})=(−2D_{H}, −4D_{V}), (X_{V_#4}, Y_{V_#4})=(−3D_{H}, 6D_{V}), (X_{V_#5}, Y_{V_#5})=(17D_{H}, 0), (X_{V_#6}, Y_{V_#6})=(18D_{H}, −2D_{V}), (X_{V_#7}, Y_{V_#7})=(19D_{H}, −4D_{V}), (X_{V_#8}, Y_{V_#8})=(20D_{H}, −6D_{V}), (X_{V_#9}, Y_{V_#9})=(3D_{H}, D_{V}), (X_{V_#10}, Y_{V_#10})=(2D_{H}, −D_{V}), (X_{V_#11}, Y_{V_#11})=(D_{H}, −3D_{V}), (X_{V_#12}, Y_{V_#12})=(0, −5D_{V}), (X_{V_#13}, Y_{V_#13})=(20D_{H}, D_{V}), (X_{V_#14}, Y_{V_#14})=(21D_{H}, −D_{V}), (X_{V_#15}, Y_{V_#15})=(22D_{H}, −3D_{V}), (X_{V_#16}, Y_{V_#16})=(23D_{H}, −5D_{V}).

Here, the case of FIGS. 80 and 81 is described in which D_{H} and D_{V} are set to 0.52, but D_{H} and D_{V} may also be set, for example, to values of approximately 0.452 to 0.82. Note that λ represents the wavelength of the carrier frequency of the radar transmission signal. For example, when a chirp signal is used as the radar transmission signal, A is the wavelength of the center frequency in the frequency sweep band of the chirp signal.

Next, an example of direction estimation processing performed by direction estimator 213 in the case where the above-described antenna arrangement is applied will be described.

For example, direction estimator 213 performs the direction estimation processing by generating virtual reception array correlation vectors h(f_{b_cfar}, f_{s_cfar}) of transmission antennas 106 given by Expression 17 using reception signals (or code demultiplexing results) DeMul_{z}^{ncm}(f_{b_cfar}, f_{s_cfar}) that are the code multiplexed signals transmitted from transmission antennas 106 on which code demultiplexing processing is performed.

Virtual reception array correlation vectors h(f_{b_cfar}, f_{s_cfar}) includes N_{Tx}×Na elements, the number of which is the product of number N_{Tx} of transmission antennas and number Na of reception antennas. Virtual reception array correlation vectors h(f_{b_cfar}, f_{s_cfar}) is used in processing for performing, on reflected wave signals from a target, direction estimation based on a phase difference between reception antennas 202.

For example, in the example of FIG. 80 for the MIMO antenna arrangement of Arrangement Example 2, N_{Tx}=6 and Na=8. Thus, virtual reception array correlation vector h(f_{b_cfar}, f_{s_cfar}) includes 48 elements, and the elements correspond respectively to reception signals of VA #1 to VA48 in the virtual reception array arrangement illustrated in FIG. 81.

Direction estimator 213 performs the direction estimation processing for the horizontal and vertical directions using, for example, virtual reception array correlation vectors h(f_{b_cfar}, f_{s_cfar}), which are reception signals of the virtual reception array composed of the above-described transmission and reception antenna arrangement. The subsequent operations of direction estimator 213 are the same as those in the case of using Arrangement Example 1, and description thereof will be omitted.

Next, an example of a direction estimation result (computer simulation result) in the case where the antenna arrangement according to above-described Arrangement Example 2 is applied will be described.

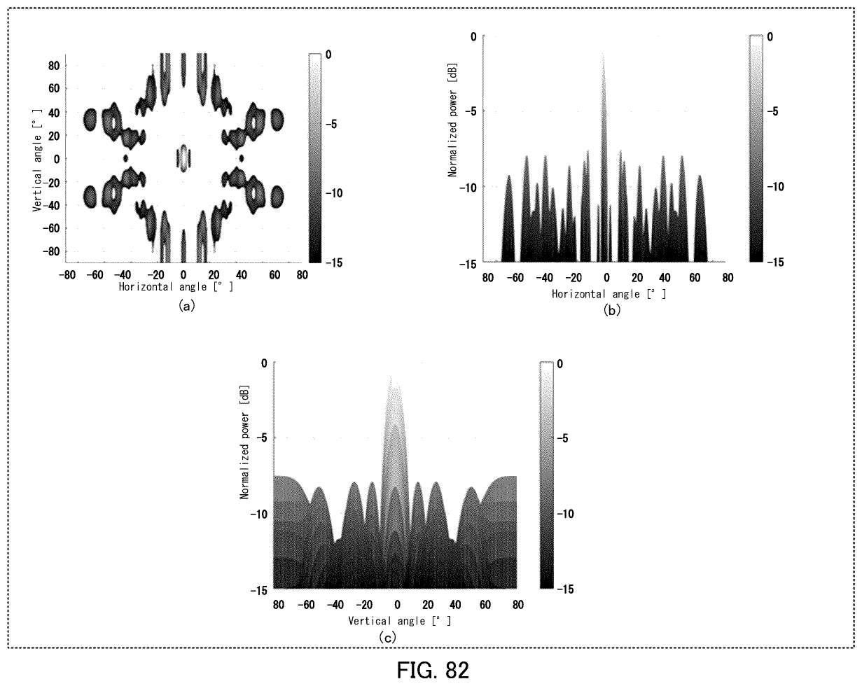

FIG. 82 illustrates a direction estimation result obtained when a MIMO array arrangement (D_{H}=0.5λ, D_{V}=0.5λ) of Arrangement Example 2 is used and the beamformer method is used as a direction-of-arrival estimation algorithm of direction estimator 213. By way of example, FIG. 82 illustrates plotted outputs of the direction-of-arrival estimation evaluation function values as obtained within the range of ±90 degrees in the horizontal direction and within the range of ±90 degrees in the vertical direction on the assumption that the target true value is at horizontal 0 degrees and vertical 0 degrees.

Note that (a) in FIG. 82 is a diagram illustrating normalized power values in two-dimensional directions of the horizontal direction as the horizontal axis and the vertical direction as the vertical axis in a grayscale color map. Further, with respect to (a) of FIG. 82, (b) of FIG. 82 also illustrates a grayscale color map of normalized power values in which the horizontal axis denotes the horizontal direction, and the vertical axis denotes the normalized power values. In addition, with respect to (a) of FIG. 82, (c) of FIG. 82 also illustrates a grayscale color map of normalized power values in which the horizontal axis denotes the vertical direction, and the vertical axis denotes the normalized power values. Note that, in FIG. 82, the normalized power values may be expressed by, for example, a decibel value (dB) normalized by the peak power, and the same applies to plots of direction estimation results in the other examples below.

Here, as illustrated in FIG. 80, the antenna spacings between the first oblique antenna group of antennas Tx #1 to #3 and the second oblique antenna group of antennas Tx #4 to #6 of transmission antennas 106 of Arrangement Example 2 are spacings of a wavelength equal to or greater than one wavelength, and are thus antenna spacings which may cause grating lobes. Further, as illustrated in FIG. 80, the antenna spacings between the third oblique antenna group of antennas Rx #1 to #4 and the fourth oblique antenna group of antennas Rx #5 to #8 of reception antennas 202 of Arrangement Example 2 are spacings of a wavelength equal to or greater than one wavelength, and are thus antenna spacings which may cause grating lobes.

Further, as illustrated in FIG. 81, in the virtual reception array arrangement, the virtual antennas are arranged at spacings of a wavelength equal to or greater than one wavelength in both the horizontal direction and the vertical direction, and thus the spacings may cause grating lobes.

In Arrangement Example 2, such grating lobes are suppressed by devising the arrangement of transmission antennas 106 and reception antennas 202. For example, as illustrated in FIG. 82, it can be seen that the grating lobes are suppressed to about −7.5 dB or less in directions that differ from the peak direction in the target-true-value direction.

In the following, a description will be given of a principle of suppressing the grating lobes by the MIMO antenna arrangement in Arrangement Example 2.

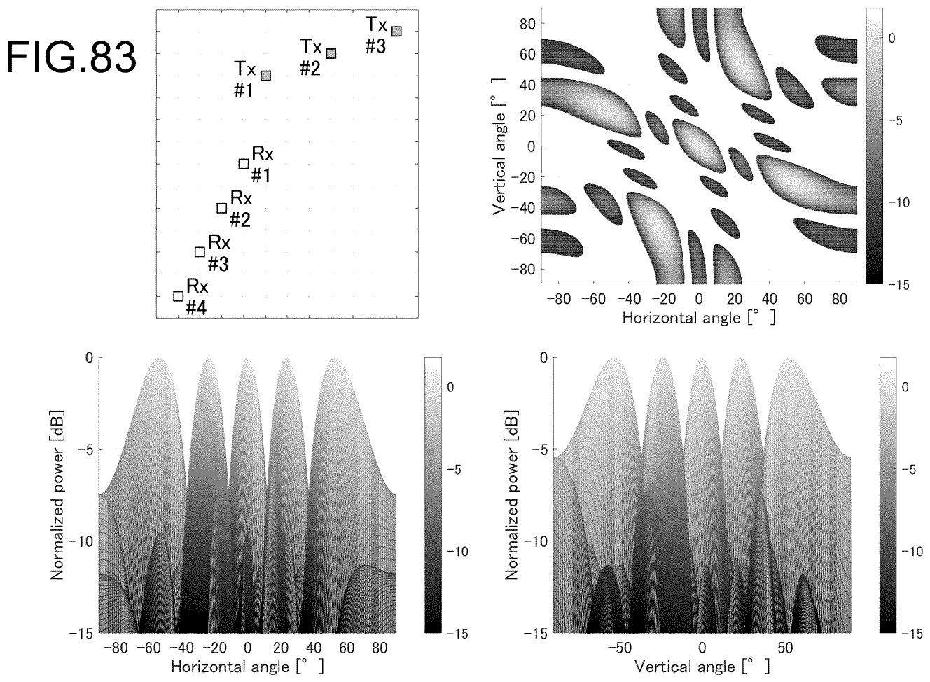

For example, (a) of FIG. 83 illustrates an antenna arrangement (hereinafter referred to as “Comparative Arrangement 2a”) in which the first oblique antenna group of antennas Tx #1 to #3 and the third oblique antenna group of antennas Rx #1 to #4 of Arrangement Example 2 illustrated in FIG. 80 are used for comparison with Arrangement Example 2. In addition, (b), (c), and (d) of FIG. 83 illustrate direction estimation results obtained using the beamformer method in the antenna arrangement illustrated at (a) of FIG. 83. Parts (b), (c), and (d) of FIG. 83 like FIG. 82 illustrate plotted outputs of the direction-of-arrival estimation evaluation function values as obtained within the range of ±90 degrees in the horizontal direction and within the range of ±90 degrees in the vertical direction on the assumption that the target true value is at horizontal 0 degrees and vertical 0 degrees.

The virtual reception array arrangement using Comparative Arrangement 2a corresponds to VA #1 to #4, #9 to #12, and #17 to #20 in FIG. 81.

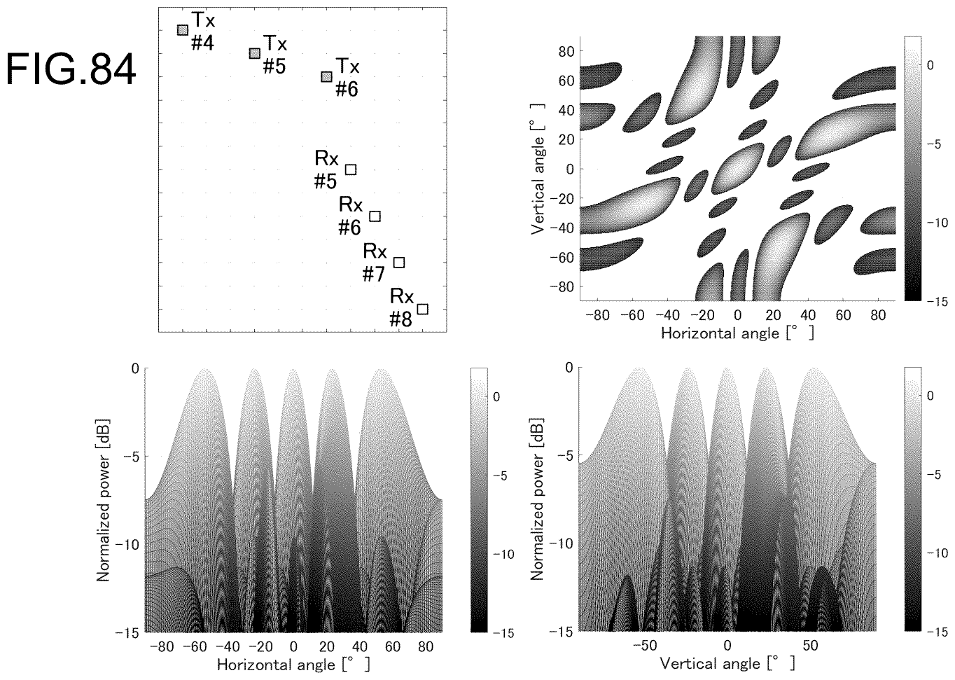

Similarly, (a) of FIG. 84 illustrates an antenna arrangement (hereinafter referred to as “Comparative Arrangement 2b”) in which the second oblique antenna group of antennas Tx #4 to #6 and the fourth oblique antenna group of antennas Rx #5 to #8 of Arrangement Example 2 illustrated in FIG. 80 are used for comparison with Arrangement Example 2. In addition, (b), (c), and (d) of FIG. 84 illustrate direction estimation results obtained using the beamformer method in the antenna arrangement illustrated at (a) of FIG. 84. Parts (b), (c), and (d) of FIG. 84 like FIG. 82 illustrate plotted outputs of the direction-of-arrival estimation evaluation function values as obtained within the range of ±90 degrees in the horizontal direction and within the range of ±90 degrees in the vertical direction on the assumption that the target true value is at horizontal 0 degrees and vertical 0 degrees.

The virtual reception array arrangement using Comparative Arrangement 2b corresponds to #29 to #32, #37 to #40, and #45 to #48 in FIG. 81.

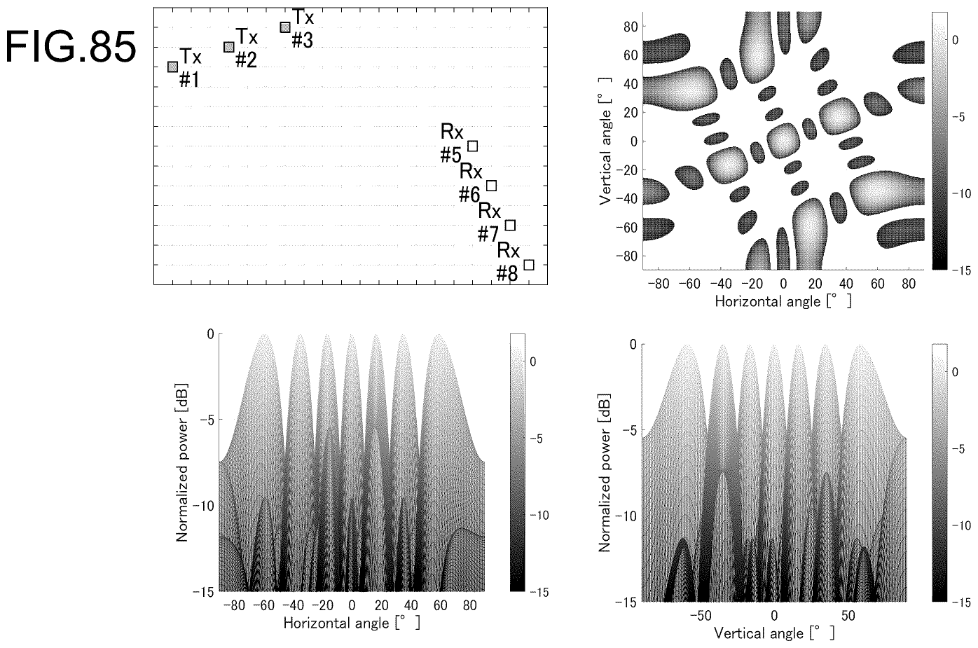

For example, (a) of FIG. 85 illustrates an antenna arrangement (hereinafter referred to as “Comparative Arrangement 2c”) in which the first oblique antenna group of antennas Tx #1 to #3 and the fourth oblique antenna group of antennas Rx #5 to #8 of Arrangement Example 2 illustrated in FIG. 80 are used for comparison with Arrangement Example 2. In addition, (b), (c), and (d) of FIG. 85 illustrate direction estimation results obtained using the beamformer method in the antenna arrangement illustrated at (a) of FIG. 85. Parts (b), (c), and (d) of FIG. 85 like FIG. 82 illustrate plotted outputs of the direction-of-arrival estimation evaluation function values as obtained within the range of ±90 degrees in the horizontal direction and within the range of ±90 degrees in the vertical direction on the assumption that the target true value is at horizontal 0 degrees and vertical 0 degrees.

The virtual reception array arrangement using Comparative Arrangement 2c corresponds to #5 to #8, #13 to #16, and #21 to #24 in FIG. 81.

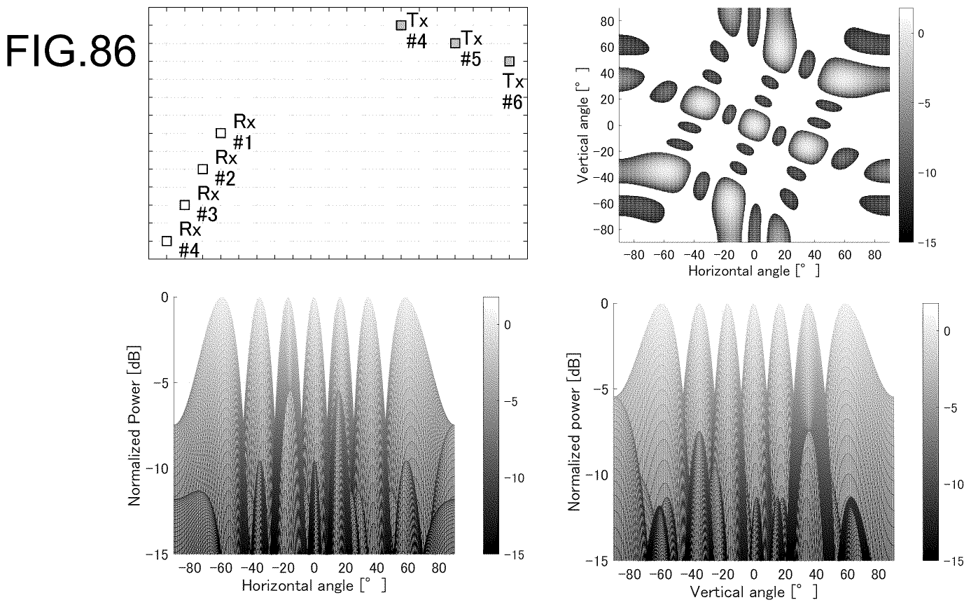

For example, (a) of FIG. 86 illustrates an antenna arrangement (hereinafter referred to as “Comparative Arrangement 2d”) in which the first oblique antenna group of antennas Tx #4 to #6 and the third oblique antenna group of antennas Rx #1 to #4 of Arrangement Example 2 illustrated in FIG. 80 are used for comparison with Arrangement Example 2. In addition, (b), (c), and (d) of FIG. 86 illustrate direction estimation results obtained using the beamformer method in the antenna arrangement illustrated at (a) of FIG. 86. Parts (b), (c), and (d) of FIG. 86 like FIG. 82 illustrate plotted outputs of the direction-of-arrival estimation evaluation function values as obtained within the range of ±90 degrees in the horizontal direction and within the range of ±90 degrees in the vertical direction on the assumption that the target true value is at horizontal 0 degrees and vertical 0 degrees.

The virtual reception array arrangement using Comparative Arrangement 2d corresponds to #25 to #28, #33 to #36, and #41 to #44 in FIG. 81.

For example, a description will be given of the case where the first oblique antenna group of antennas Tx #1 to #3 and the third oblique antenna group of antennas Rx #1 to #4 are used as in Comparative Arrangement 2a illustrated at (a) of FIG. 83, and a case where the second oblique antenna group of antennas Tx #4 to #6 and the fourth oblique antenna group of antennas Rx #5 to #8 are used as in Comparative Arrangement 2b illustrated at (a) of FIG. 84.

The arrangement direction of transmission antennas Tx #1 to #3 (corresponding to, for example, the first oblique antenna group) of Comparative Arrangement 2a illustrated at (a) of FIG. 83 and the arrangement direction of transmission antennas Tx #4 to #6 (corresponding to, for example, the second oblique antenna group) of Comparative Arrangement 2b illustrated at (a) of FIG. 84 are not parallel to each other and differ from each other. Further, the arrangement direction of reception antennas Rx #1 to #4 (corresponding to, for example, the third oblique antenna group) of Comparative Arrangement 2a and the arrangement direction of reception antennas Rx #5 to #8 (corresponding to, for example, the fourth oblique antenna group) of Comparative Arrangement 2b are not parallel to each other and differ from each other. Therefore, as illustrated at (b) of FIG. 83 and (b) of FIG. 84, there are characteristics that the horizontal and vertical two-dimensional angular directions in which the grating lobes are generated are not identical to each other and are deviated from each other between Comparative Arrangement 2a and Comparative Arrangement 2b.

On the other hand, as illustrated at (b) of FIG. 83 and (b) of FIG. 84, the angular directions (e.g., horizontal 0 degrees and vertical 0 degrees) of the main lobes corresponding to the target true values coincide with each other between Comparative Arrangement 2a and Comparative Arrangement 2b.

Therefore, in Arrangement Example 2 including the first to fourth oblique antenna groups as illustrated in FIG. 80, the respective generation directions (two-dimensional angular directions) of the grating lobes generated in Comparative Arrangement 2a including the first oblique antenna group and the third oblique antenna group and the grating lobes generated in Comparative Arrangement 2b including the second oblique antenna group and the fourth oblique antenna group are not identical to each other. It is thus likely that the grating lobes are distributed. Therefore, in Arrangement Example 2 as illustrated at (a) of FIG. 82, the peak levels in the grating-lobe directions are more likely to be suppressed below the peak in the target-true-value direction.

Next, a description will be given, for example, of the case where the first oblique antenna group of antennas Tx #1 to #3 and the fourth oblique antenna group of antennas Rx #5 to #8 are used as in Comparative Arrangement 2c illustrated at (a) of FIG. 85, and the case where the second oblique antenna group of antennas Tx #4 to #6 and the third oblique antenna group of antennas Rx #1 to #4 are used as in Comparative Arrangement 2d illustrated at (a) of FIG. 86.

The arrangement direction of transmission antennas Tx #1 to #3 (corresponding to, for example, the first oblique antenna group) of Comparative Arrangement 2c illustrated at (a) of FIG. 85 and the arrangement direction of transmission antennas Tx #4 to #6 (corresponding to, for example, the second oblique antenna group) of Comparative Arrangement 2d illustrated at FIG. 86 are not parallel to each other and differ from each other. Further, the arrangement direction of reception antennas Rx #5 to #8 (corresponding to, for example, the fourth oblique antenna group) of Comparative Arrangement 2c and the arrangement direction of reception antennas Rx #1 to #4 (corresponding to, for example, the third oblique antenna group) of Comparative Arrangement 2d are not parallel to each other and differ from each other. Therefore, as illustrated at (b) of FIG. 85 and (b) of FIG. 86, there are characteristics that the horizontal and vertical two-dimensional angular directions in which the grating lobes are generated are not identical to each other and are deviated from each other between Comparative Arrangement 2c and Comparative Arrangement 2d.

On the other hand, as illustrated at (b) of FIG. 85 and (b) of FIG. 86, the angular directions (e.g., horizontal 0 degrees and vertical 0 degrees) of the main lobes corresponding to the target true values coincide with each other between Comparative Arrangement 2c and Comparative Arrangement 2d.

Therefore, in Arrangement Example 2 including the first to fourth oblique antenna groups as illustrated in FIG. 80, the respective generation directions (two-dimensional angular directions) of the grating lobes generated in Comparative Arrangement 2c including the first oblique antenna group and the fourth oblique antenna group and the grating lobes generated in Comparative Arrangement 2d including the second oblique antenna group and the third oblique antenna group are not identical to each other. It is thus likely that the grating lobes are distributed. Therefore, in Arrangement Example 2 as illustrated at (a) of FIG. 82, the peak levels in the grating-lobe directions are more likely to be suppressed below the peak in the target-true-value direction.

Here, the virtual reception array arrangement illustrated in FIG. 81 is the same arrangement as the virtual reception array partially formed by each of the virtual reception arrays corresponding to Comparative Arrangements 2a, 2b, 2c and 2d. Therefore, as illustrated at (a) of FIG. 82, the direction estimation result by the virtual reception array arrangement illustrated in FIG. 81 shows suppression of the grating lobes in the directions that differ from the peak direction in the target-true-value direction. For example, in Arrangement Example 2, the angular directions in which the grating lobes are generated by the plurality of oblique antenna groups included in transmission antennas 106 and reception antennas 202 are distributed in different directions. Therefore, for example, as illustrated at (b) of FIG. 82, in Arrangement Example 2, the normalized power values of the grating lobes are likely to be suppressed below the normalized power value of the main lobe for the target true value. For example, in (b) of FIG. 82, it can be seen that the peaks in directions other than the peak direction in the target-true-value direction are suppressed to about −7.5 dB or less.

Note that, for example, in the antenna arrangement of Arrangement Example 2 illustrated in FIG. 80, the arrangement directions of the first oblique antenna group and the second oblique antenna group have horizontal inversion symmetry, and the arrangement directions of the third oblique antenna group and the fourth oblique antenna group have horizontal inversion symmetry. In this case, the virtual reception array arrangements corresponding to Comparative Arrangement 2a and Comparative Arrangement 2b have horizontal inversion symmetry. Thus, for example, as illustrated at (b) of FIG. 83 and (b) of FIG. 84, in Comparative Arrangement 2a and Comparative Arrangement 2b, the horizontal and vertical two-dimensional directions in which the grating lobes are generated have horizontal inversion symmetry, and deviations in the horizontal and vertical two-dimensional angular directions in which the grating lobes are generated become larger.

Similarly, for example, in the antenna arrangement of Arrangement Example 2 illustrated in FIG. 80, the arrangement directions of the first oblique antenna group and the second oblique antenna group have horizontal inversion symmetry, and the arrangement directions of the third oblique antenna group and the fourth oblique antenna group have horizontal inversion symmetry. In this case, the virtual reception array arrangements corresponding to Comparative Arrangement 2c and Comparative Arrangement 2d have horizontal inversion symmetry. Thus, for example, as illustrated at (b) of FIG. 85 and (b) of FIG. 86, in Comparative Arrangement c and Comparative Arrangement d, the horizontal and vertical two-dimensional directions in which the grating lobes are generated have horizontal inversion symmetry, and deviations in the horizontal and vertical two-dimensional angular directions in which the grating lobes are generated become larger.

Therefore, in Arrangement Example 2, when the arrangement directions of the first oblique antenna group and the second oblique antenna group have horizontal inversion symmetry, and the arrangement directions of the third oblique antenna group and the fourth oblique antenna group have horizontal inversion symmetry, spacings (or deviations) between the horizontal and vertical two-dimensional angular directions in which the grating lobes are generated are more likely to increase, for example, as the inclination of each of the first to fourth oblique antenna groups in the oblique direction is closer to 45 degrees with respect to the horizontal direction.

Further, for example, in the case where the arrangement directions of the first oblique antenna group and the second oblique antenna group do not have horizontal inversion symmetry, or in the case where the arrangement directions of the third oblique antenna group and the fourth oblique antenna group do not have horizontal inversion symmetry, the spacings between the horizontal and vertical two-dimensional angular directions in which the grating lobes are generated are more likely to increase, for example, as the inclination of each of the first to fourth oblique antenna groups in the oblique direction is closer to 45 degrees with respect to the horizontal direction.

For example, in such an antenna arrangement in which the spacings between the horizontal and vertical two-dimensional angular directions in which the grating lobes are generated are larger, the smaller the number of antennas of radar apparatus 10, the more preferable it is. For example, the smaller the number of antennas of radar apparatus 10, the wider the beam width of the main beam in the direction estimation is likely to be. Thus, when the directions of the suppressed grating lobes are close to each other, the power of the grating lobes may increase as a result of power overlap between the grating lobes, which is caused by the larger beam width due to the smaller number of antennas of radar apparatus 10. Therefore, as the number of antennas of radar apparatus 10 decreases, the suppression performance for suppressing the grating lobes deteriorates, and the probability of erroneous detection in radar apparatus 10 tends to increase. As a countermeasure, when the number of antennas of radar apparatus 10 is small, Arrangement Example 2 in which, for example, the arrangement directions of the first oblique antenna group and the second oblique antenna group have horizontal inversion symmetry, and the arrangement directions of the third oblique antenna group and the fourth oblique antenna group have horizontal inversion symmetry makes it possible to suppress the power overlap between the grating lobes. Accordingly, the suppression performance for suppressing the grating lobes can be improved.

As described above, in Arrangement Condition 2, transmission antennas 106 include the first oblique antenna group disposed in the first oblique direction and the second oblique antenna group disposed in the second oblique direction. Thus, the aperture length of the virtual reception array in the vertical direction can be further enlarged as compared with Arrangement Condition 1, and the angular measurement accuracy or resolution in radar apparatus 10 in the vertical direction can be improved.

Further, as described above, the directions in which the grating lobes are generated are distributed in the two-dimensional plane formed by the horizontal and vertical directions in Arrangement Condition 2. It is thus possible to suppress the grating lobes in the vertical direction that are generated when the inclinations of the first to fourth oblique directions are set to be steeper with respect to the horizontal direction. As a result, the vertical aperture length of the virtual reception array can be further increased, and the vertical angular measurement accuracy or vertical resolution of radar apparatus 10 can be improved.

For example, even when the second oblique antenna group and the fourth oblique antenna group of Comparative Arrangement 2b are arranged at any positions with respect to the first oblique antenna group and the third oblique antenna group of Comparative Arrangement 2a, the same suppression effect for suppressing the grating lobes can be obtained. Similarly, even when the second oblique antenna group and the third oblique antenna group of Comparative Arrangement 2d are arranged at any positions with respect to the first oblique antenna group and the fourth oblique antenna group of Comparative Arrangement 2c, the same suppression effect for suppressing the grating lobes can be obtained.

Therefore, in Arrangement Example 2, for example, the first oblique antenna group and the second oblique antenna group can be arranged so as not to overlap each other in the horizontal direction. Thus, it is possible to arrange the transmission antenna elements having a larger size in the vertical direction (for example, a size of a wavelength equal to or greater than one wavelength).

Similarly, in Arrangement Example 2, for example, the third oblique antenna group and the fourth oblique antenna group can be arranged so as not to overlap each other in the horizontal direction. Thus, it is possible to arrange the reception antenna elements having a larger size in the vertical direction (for example, a size of a wavelength equal to or greater than one wavelength).

Therefore, in Arrangement Example 2, the antenna elements of transmission antennas 106 and reception antennas 202 can be arranged in lines in the oblique directions, and therefore, antenna elements having a large size in the vertical direction (for example, antenna elements having a size of a wavelength equal to or greater than one wavelength) can be arranged.

Regarding the arrangement of the virtual reception array, the same virtual reception array arrangement can be configured even in a case of a different relative positional relation between transmission antennas 106 and reception antennas 202. Therefore, the positional relation between transmission antennas 106 and reception antennas 202 is not limited to the antenna arrangement illustrated in FIG. 80, and may be arbitrarily set. The same applies to the other example arrangements described below. For example, the spacings between transmission antennas 106 and reception antennas 202 may be sufficiently larger than the antenna element size, or the transmission and reception antennas may be shifted to each other in the horizontal direction so as not to overlap each other in the vertical direction.

As described above, in radar apparatus 10 in Arrangement Example 2, transmission antennas 106 include, for example, the first oblique antenna group disposed in the first oblique direction and the second oblique antenna group disposed in the second oblique direction. Reception antennas 202 include, for example, the third oblique antenna group disposed in the third oblique direction and the fourth oblique antenna group disposed in the fourth oblique direction. In the antenna arrangement of radar apparatus 10, the first oblique direction and the second oblique direction are different from each other, and the third oblique direction and the fourth oblique direction are different from each other.

With the present configuration of the antenna arrangement, antenna elements with any longitudinal (for example, vertical) size can be applied in the MIMO array arrangement of radar apparatus 10, and grating lobes generated in the virtual reception array can be suppressed.

Further, in Arrangement Example 2, as described above, the difference in the arrangement directions of the first to fourth oblique antenna groups of transmission antennas 106 and reception antennas 202 provides the suppression effect for suppressing the grating lobes. Therefore, in Arrangement Example 2, for example, the element spacings between transmission antennas 106 and reception antennas 202 can be arbitrarily set. Thus, for example, the aperture length of the virtual reception array can be increased in accordance with the setting of at least either the element spacings between transmission antennas 106 or the element spacings between reception antennas 202. Accordingly, the angular measurement accuracy and the angular separation performance of radar apparatus 10 in the vertical and horizontal directions can be improved.

Therefore, according to Arrangement Example 2, it is possible to improve the angular measurement accuracy or the resolution in radar apparatus 10 while suppressing the grating lobes.

In Arrangement Example 2, the antenna elements may be further added to at least either transmission antennas 106 or reception antennas 202 in the antenna configuration illustrated in FIG. 80. For example, transmission antennas 106 and reception antennas 202 of radar apparatus 10 may include at least the antenna elements arranged in FIG. 80. In this case of further addition of the antenna element, for example, a virtual antenna is additively added to the virtual reception array arrangement given by Expression 16. For example, the addition of at least one antenna element of transmission antennas 106 or reception antennas 202 results in an arrangement in which a further virtual antenna is added to the virtual reception array arrangement illustrated in FIG. 80. Even in the case of the antenna arrangement including Arrangement Example 2, the effects of above-described Arrangement Example 2 are maintained, and the same effects as those of Arrangement Example 2 can be obtained.

For example, an antenna may be further added to the antenna configuration of Arrangement Example 2. By adding the antenna, the grating lobe level or the sidelobe level suppressed by above-described Arrangement Example 2 is more likely to be further suppressed. Accordingly, erroneous detection at the time of angle measurement in radar apparatus 10 can be reduced, and the angular measurement performance can be improved. Note that the addition of the antenna can be similarly applied to the following arrangement examples or variations, and the same effects can be obtained.

Further, in the MIMO array arrangement of Arrangement Example 2, an arrangement in which the horizontal direction and the vertical direction are interchanged may be applied. In this case, as the virtual reception array arrangement, an arrangement in which the horizontal direction and the vertical direction are interchanged can be obtained, and angle separation performance in which the horizontal direction and the vertical direction are interchanged can be obtained. Interchanging the horizontal direction and the vertical direction of the MIMO array arrangement can be similarly applied to the arrangement examples or variations in the following. In the virtual reception array arrangements in the following arrangement examples, it is possible to obtain an arrangement in which the horizontal direction and the vertical direction are interchanged.

In the MIMO antenna arrangement of Arrangement Example 2, the arrangement of transmission antennas 106 and the arrangement of reception antennas 202 may be interchanged. In this case, for example, the arrangement of reception antennas 202 illustrated in Arrangement Example 2 may be used as the arrangement of transmission antennas 106, and the arrangement of transmission antennas 106 illustrated in Arrangement Example 2 may be used as the arrangement of reception antennas 202. Even when the arrangement of transmission antennas 106 and the arrangement of reception antennas 202 are interchanged, the arrangement of the virtual reception array is the same, and thus the same effect can be obtained. Note that the replacement of the arrangement of transmission antennas 106 and the arrangement of reception antennas 202 can be similarly applied to the below-described arrangement examples or variations.

### Arrangement Example 2a

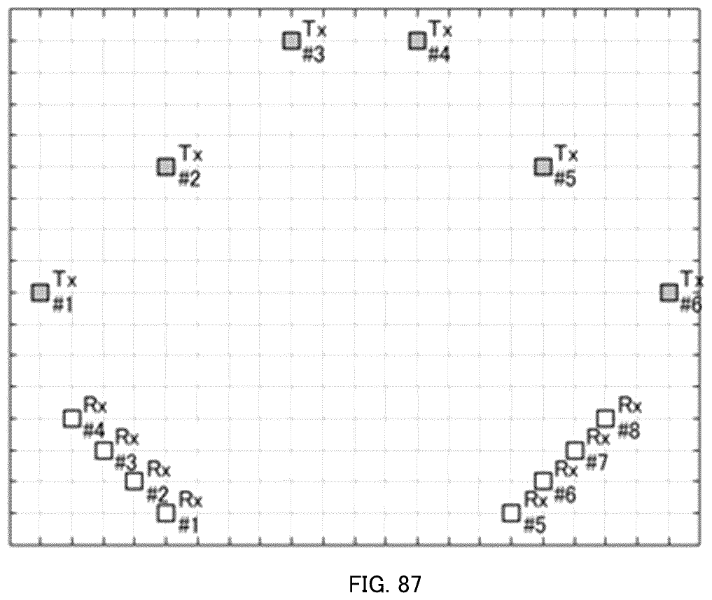

FIG. 87 is a diagram illustrating an arrangement example (for example, a MIMO antenna arrangement example) of transmission antennas 106 (for example, represented by Tx) and reception antennas 202 (for example, represented by Rx) according to Arrangement Example 2a.

In FIG. 87, number N_{Tx} of transmission antennas is six (e.g., Tx #1, Tx #2, Tx #3, Tx #4, Tx #5 and Tx #6), and number Na of reception antennas is eight (e.g., Rx #1, Rx #2, Rx #3, Rx #5, Rx #6, Rx #7, and Rx #8).

In FIG. 87, N_{Tx} (=6) transmission antennas Tx #1 to #6 include first oblique antenna group of antennas Tx #1 to #3 arranged in the first oblique direction and second oblique antenna group of antennas Tx #4 to #6 arranged in the second oblique direction. In FIG. 87, the first oblique direction and the second oblique direction are not parallel to each other, but are directions that differ from each other.

In addition, in FIG. 87, Na (=8) reception antennas Rx #1 to #8 include the third oblique antenna group of antennas Rx #1 to #4 arranged in the third oblique direction and the fourth oblique antenna group of antennas Rx #5 to #8 arranged in the fourth oblique direction. In FIG. 87, the third oblique direction and the fourth oblique direction are not parallel to each other, but are directions that differ from each other.

Therefore, the antenna arrangement of Arrangement Example 2a illustrated in FIG. 87 satisfies Arrangement Condition 2.

Further, in Arrangement Example 2a, as illustrated in FIG. 87, the arrangement direction of the first oblique antenna group and the arrangement direction of the fourth oblique antenna group coincide with each other and are parallel to each other. Further, in Arrangement Example 2a, as illustrated in FIG. 87, the arrangement direction of the second oblique antenna group and the arrangement direction of the third oblique antenna group coincide with each other and are parallel to each other. For example, in FIG. 87, the first oblique direction and the fourth oblique direction are the same direction, and the second oblique direction and the third oblique direction are the same direction.

As described above, in the antenna arrangement satisfying Arrangement Condition 2, the first oblique direction may be set to an inclination coinciding with the inclination of the third oblique direction or the fourth oblique direction, and the second oblique direction may be set to an inclination coinciding with the inclination of the third oblique direction or the fourth oblique direction.

For example, antennas Tx #1 to #3 of the first oblique antenna group illustrated in FIG. 87 are horizontally shifted from one another by spacings of two wavelengths from left to right in the figure, and are also vertically shifted upward from one another by spacings of two wavelengths at the same time. Further, antennas Tx #4 to #6 of the second oblique antenna group illustrated in FIG. 87 are horizontally shifted from one another by spacings of two wavelengths from left to right in the figure, and are also vertically shifted downward from one another by spacings of two wavelengths at the same time. For example, the first oblique antenna group of antennas Tx #1 to #3 and the second oblique antenna group of antennas Tx #4 to #6 have horizontal inversion symmetry.

Here, transmission antennas 106 (e.g., FIG. 8) of Arrangement Example 1 are horizontally arranged. On the other hand, transmission antennas 106 of Arrangement Example 2a are arranged obliquely as illustrated in FIG. 87. For example, since transmission antennas 106 of Arrangement Example 2a are arranged in the two horizontal and vertical dimensions, the aperture in the vertical direction can be further enlarged in Arrangement Example 2a as compared with Arrangement Example 1.

Also, for example, antennas Rx #1 to #4 of the third oblique antenna group illustrated in FIG. 87 are horizontally shifted from one another by spacings of 0.5 wavelengths from the right to the left in the figure, and are also vertically shifted upward from one another by spacings of 0.5 wavelengths at the same time. In addition, antennas Rx #5 to #8 of the fourth oblique antenna group illustrated in FIG. 87 are horizontally shifted from one another by spacings of 0.5 wavelengths from left to right in the figure, and are also vertically shifted upward from one another by spacings of 0.5 wavelengths at the same time. For example, the third oblique antenna group of antennas Rx #1 to #4 and the fourth oblique antenna group of antennas Rx #5 to #8 are arranged to have horizontal inversion symmetry.

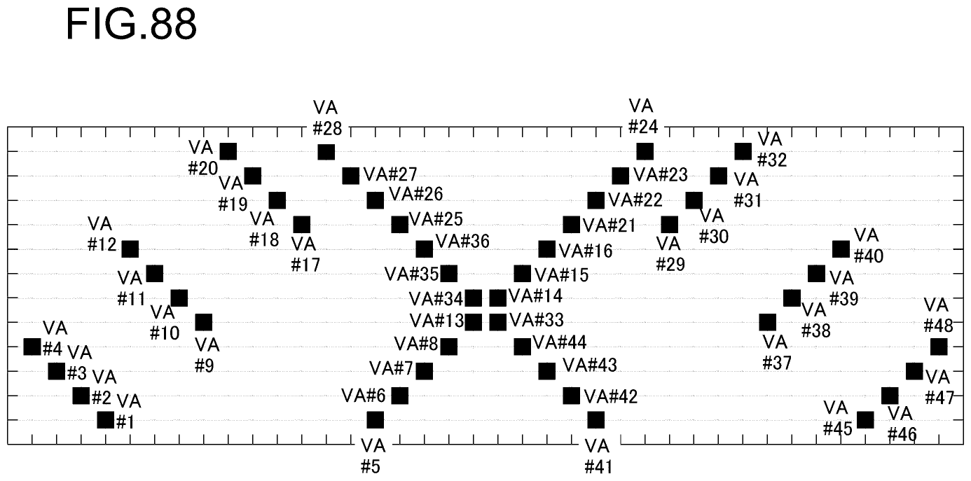

FIG. 88 is a diagram illustrating an arrangement example of a virtual reception array obtained by the antenna arrangement illustrated in FIG. 87. From the arrangement of transmission antennas Tx #1 to Tx #6 and the arrangement of reception antennas Rx #1 to

Rx #8, the position coordinates of virtual antennas VA #1 to #48 constituting the virtual reception array antennas are calculated based on Expression 16.

Next, an example of a direction estimation result (computer simulation result) in the case where the antenna arrangement according to above-described Arrangement Example 2a is applied will be described.

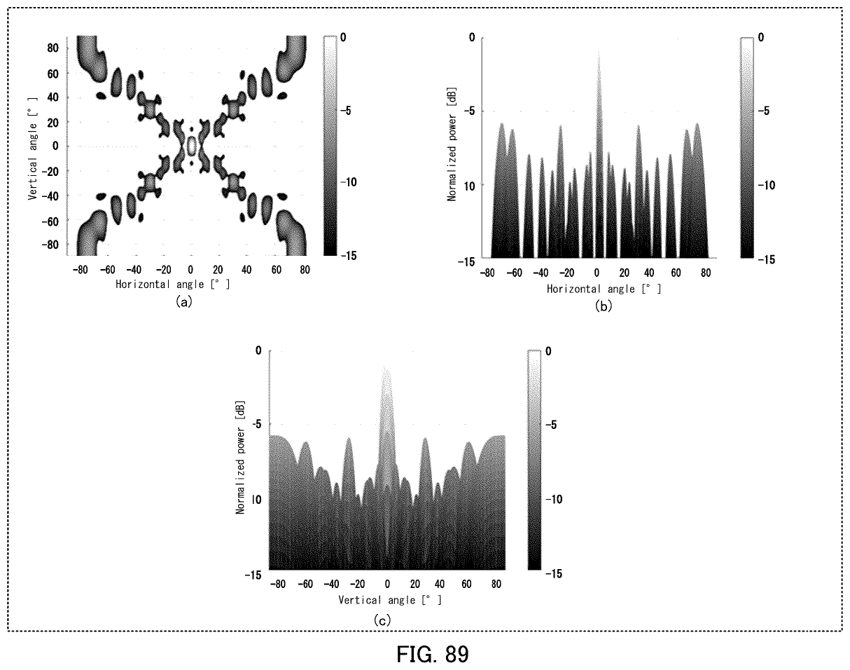

FIG. 89 illustrates a direction estimation result obtained when a MIMO array arrangement (D_{H}=0.5λ, D_{V}=0.5λ) of Arrangement Example 2a is used and the beamformer method is used as a direction-of-arrival estimation algorithm of direction estimator 213. By way of example, FIG. 89 illustrates plotted outputs of the direction-of-arrival estimation evaluation function values as obtained within the range of ±90 degrees in the horizontal direction and within the range of ±90 degrees in the vertical direction on the assumption that the target true value is at horizontal 0 degrees and vertical 0 degrees.

Note that (a) in FIG. 89 is a diagram illustrating normalized power values in two-dimensional directions of the horizontal direction as the horizontal axis and the vertical direction as the vertical axis in a grayscale color map. Further, with respect to (a) of FIG. 89, (b) of FIG. 89 also illustrates a grayscale color map of normalized power values in which the horizontal axis denotes the horizontal direction, and the vertical axis denotes the normalized power values. In addition, with respect to (a) of FIG. 89, (c) of FIG. 89 also illustrates a grayscale color map of normalized power values in which the horizontal axis denotes the vertical direction, and the vertical axis denotes the normalized power values. Note that in FIG. 89, the normalized power values may be represented by a decibel value (dB) normalized by the peak power, and the same applies to plots of direction estimation results in the other examples below.

As illustrated in the virtual reception array arrangement illustrated in FIG. 88, the virtual antennas are arranged at spacings including a large number of spacings equal to or greater than one wavelength in both the horizontal direction and the vertical direction, and thus the spacings between the virtual antennas are spacings which cause grating lobes. On the other hand, as illustrated in FIG. 89, it can be seen that the grating lobes are suppressed to about −6 dB or less in directions that differ from the peak direction in the target-true-value direction.

Note that, for example, in the antenna arrangement of Arrangement Example 2a illustrated in FIG. 87, the arrangement directions of the first oblique antenna group and the second oblique antenna group have horizontal inversion symmetry, and the arrangement directions of the third oblique antenna group and the fourth oblique antenna group have horizontal inversion symmetry. For example, the inclinations of the first to fourth oblique directions are 45 degrees with respect to the horizontal direction. In this case, as illustrated at (a) of FIG. 89, the arrangement with the widest spacings in the horizontal and vertical two-dimensional angular directions in which the grating lobes are generated is achieved.

For example, in such an antenna arrangement in which the spacings between the horizontal and vertical two-dimensional angular directions in which the grating lobes are generated are larger, the smaller the number of antennas of radar apparatus 10, the more preferable it is. For example, the smaller the number of antennas of radar apparatus 10, the wider the beam width of the main beam in the direction estimation is likely to be. Thus, when the directions of the suppressed grating lobes are close to each other, the power of the grating lobes may increase as a result of power overlap between the grating lobes, which is caused by the larger beam width due to the smaller number of antennas of radar apparatus 10. Therefore, as the number of antennas of radar apparatus 10 decreases, the suppression performance for suppressing the grating lobes deteriorates, and the probability of erroneous detection in radar apparatus 10 tends to increase. As a countermeasure, when the number of antennas of radar apparatus 10 is small, Arrangement Example 2 in which, for example, the arrangement directions of the first oblique antenna group and the second oblique antenna group have horizontal inversion symmetry, and the arrangement directions of the third oblique antenna group and the fourth oblique antenna group have horizontal inversion symmetry makes it possible to suppress the power overlap between the grating lobes. Accordingly, the suppression performance for suppressing the grating lobes can be improved.

In addition, in Arrangement Example 2a, the arrangement direction of the first oblique antenna group and the arrangement direction of the fourth oblique antenna group coincide with each other and are parallel to each other. In addition, in Arrangement Example 2a, the arrangement direction of the second oblique antenna group and the arrangement direction of the third oblique antenna group coincide with each other and are parallel to each other. As described above, in Arrangement Example 2a, the first oblique direction may be set to an inclination coinciding with the inclination of the third oblique direction or the fourth oblique direction, and the second oblique direction may be set to an inclination coinciding with the inclination of the third oblique direction or the fourth oblique direction. Accordingly, the grating-lobe suppression effect the same as in Arrangement Example 2 can be obtained.

Further, in Arrangement Example 2a, as illustrated in FIG. 87, the respective antenna elements of transmission antennas 106 and reception antennas 202 can be arranged in lines in the oblique directions, and therefore, antenna elements having a large size in the vertical direction (for example, antenna elements having a size of a wavelength equal to or greater than one wavelength) can be arranged.

As described above, in Arrangement Example 2a as in Arrangement Example 2, antenna elements with any longitudinal (for example, vertical) size can be applied in the MIMO array arrangement of radar apparatus 10, and grating lobes generated in the virtual reception array can be suppressed.

### Arrangement Example 2b

In Arrangement Example 2b, for example, one of the first oblique direction and the second oblique direction satisfying Arrangement Condition 2 may coincide with and may be parallel to the third oblique direction or the fourth oblique direction, and the other of the first oblique direction and the second oblique direction does not coincide with and may differ from the third oblique direction and the fourth oblique direction.

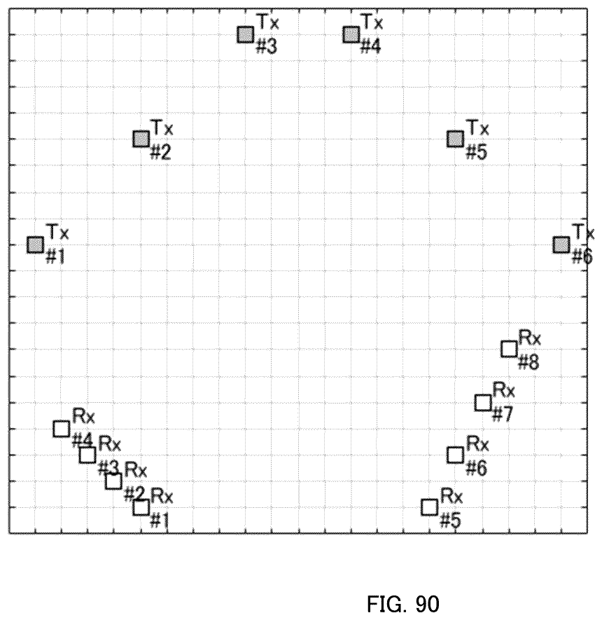

FIG. 90 is a diagram illustrating an arrangement example (for example, a MIMO antenna arrangement example) of transmission antennas 106 (for example, represented by Tx) and reception antennas 202 (for example, represented by Rx) according to Arrangement Example 2b.

In FIG. 90, number N_{Tx} of transmission antennas is six (e.g., Tx #1, Tx #2, Tx #3, Tx #4, Tx #5 and Tx #6), and number Na of reception antennas is eight (e.g., Rx #1, Rx #2, Rx #3, Rx #5, Rx #6, Rx #7, and Rx #8).

In FIG. 90, N_{Tx} (=6) transmission antennas Tx #1 to #6 include first oblique antenna group of antennas Tx #1 to #3 arranged in the first oblique direction and second oblique antenna group of antennas Tx #4 to #6 arranged in the second oblique direction. In FIG. 90, the first oblique direction and the second oblique direction are not parallel to each other, but are oblique directions that differ from each other.

In addition, in FIG. 90, Na (=8) reception antennas Rx #1 to #8 include the third oblique antenna group of antennas Rx #1 to #4 arranged in the third oblique direction and the fourth oblique antenna group of antennas Rx #5 to #8 arranged in the fourth oblique direction. In FIG. 90, the third oblique direction and the fourth oblique direction are not parallel to each other, but are directions that differ from each other.

Therefore, the antenna arrangement of Arrangement Example 2b illustrated in FIG. 90 satisfies Arrangement Condition 2.

Further, in Arrangement Example 2b, as illustrated in FIG. 90, the arrangement direction of the first oblique antenna group and the arrangement direction of the fourth oblique antenna group do not coincide with each other, and are different directions. On the other hand, as illustrated in FIG. 90, the arrangement direction of the second oblique antenna group and the arrangement direction of the third oblique antenna group coincide with each other and are parallel to each other. For example, in FIG. 90, the first oblique direction and the fourth oblique direction are the same direction, and the second oblique direction and the third oblique direction are different directions.

As described above, also when any one of the first oblique direction and the second oblique direction is set to an inclination coinciding with the third oblique direction or the fourth oblique direction, Arrangement Condition 2 is satisfied.

For example, antennas Tx #1 to #3 of the first oblique antenna group illustrated in FIG. 90 are horizontally shifted from one another by spacings of two wavelengths from left to right in the figure, and are also vertically shifted upward from one another by spacings of two wavelengths at the same time. Further, antennas Tx #4 to #6 of the second oblique antenna group illustrated in FIG. 90 are horizontally shifted from one another by spacings of two wavelengths from left to right in the figure, and are also vertically shifted downward from one another by spacings of two wavelengths at the same time. For example, the first oblique antenna group of antennas Tx #1 to #3 and the second oblique antenna group of antennas Tx #4 to #6 have horizontal inversion symmetry.

Here, transmission antennas 106 (e.g., FIG. 8) of Arrangement Example 1 are horizontally arranged. On the other hand, transmission antennas 106 of Arrangement Example 2b are arranged obliquely as illustrated in FIG. 90. For example, since transmission antennas 106 of Arrangement Example 2b are arranged in the two horizontal and vertical dimensions, the aperture in the vertical direction can be further enlarged in Arrangement Example 2b as compared with Arrangement Example 1.

Also, for example, antennas Rx #1 to #4 of the third oblique antenna group illustrated in FIG. 90 are horizontally shifted from one another by spacings of 0.5 wavelengths from the right to the left in the figure, and are also vertically shifted upward from one another by spacings of 0.5 wavelengths at the same time. In addition, antennas Rx #5 to #8 of the fourth oblique antenna group illustrated in FIG. 90 are horizontally shifted from one another by spacings of 0.5 wavelengths from left to right in the figure, and are also vertically shifted upward from one another by spacings of one wavelength at the same time. For example, the third oblique antenna group of antennas Rx #1 to #4 and the fourth oblique antenna group of antennas Rx #5 to #8 are arranged not to have horizontal inversion symmetry.

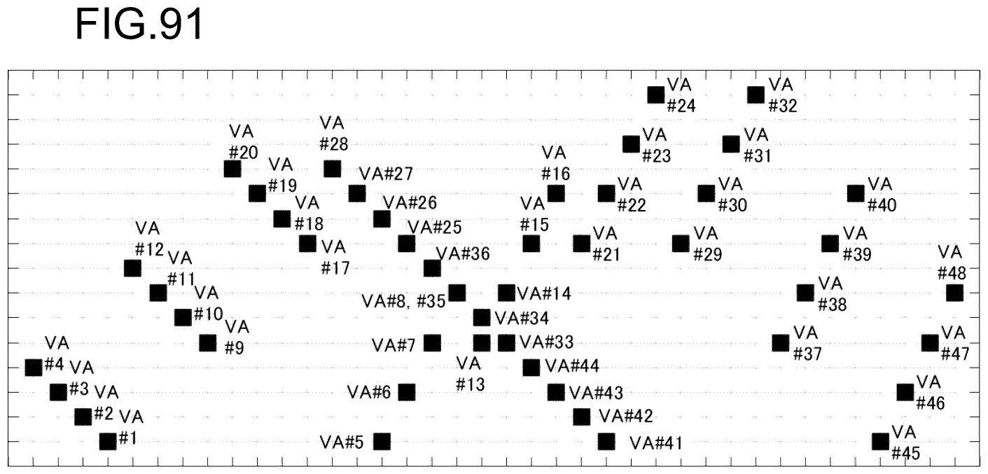

FIG. 91 is a diagram illustrating an arrangement example of a virtual reception array obtained by the antenna arrangement illustrated in FIG. 90. From the arrangement of transmission antennas Tx #1 to Tx #6 and the arrangement of reception antennas Rx #1 to Rx #8, the position coordinates of virtual antennas VA #1 to #48 constituting the virtual reception array antennas are calculated based on Expression 16.

Next, an example of a direction estimation result (computer simulation result) in the case where the antenna arrangement according to above-described Arrangement Example 2b is applied will be described.

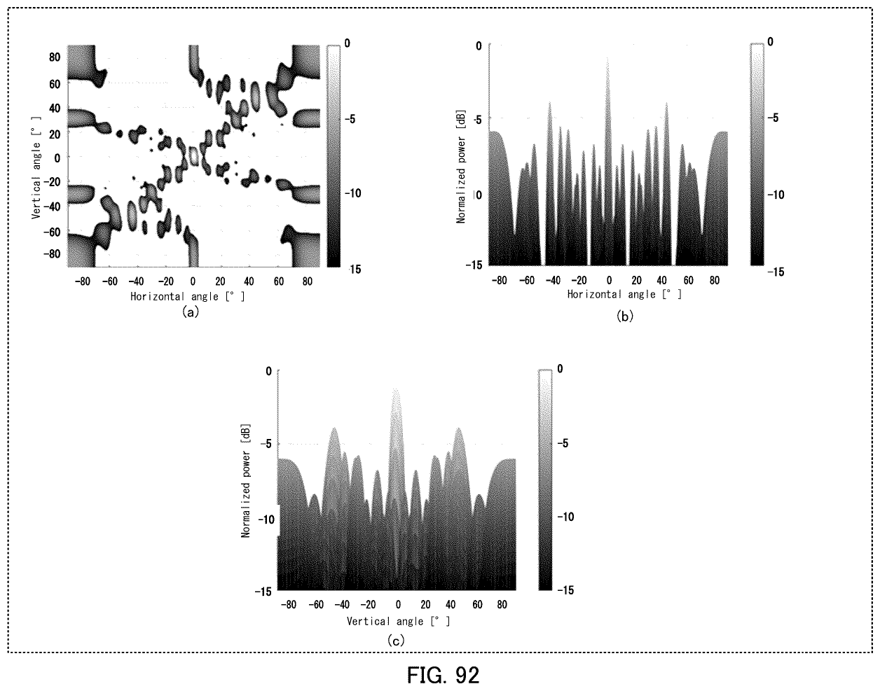

FIG. 92 illustrates a direction estimation result obtained when a MIMO array arrangement (D_{H}=0.5λ, D_{V}=0.5λ) of Arrangement Example 2b is used and the beamformer method is used as a direction-of-arrival estimation algorithm of direction estimator 213. By way of example, FIG. 92 illustrates plotted outputs of the direction-of-arrival estimation evaluation function values as obtained within the range of ±90 degrees in the horizontal direction and within the range of ±90 degrees in the vertical direction on the assumption that the target true value is at horizontal 0 degrees and vertical 0 degrees.

Note that (a) in FIG. 92 is a diagram illustrating normalized power values in two-dimensional directions of the horizontal direction as the horizontal axis and the vertical direction as the vertical axis in a grayscale color map. Further, with respect to (a) of FIG. 92, (b) of FIG. 92 also illustrates a grayscale color map of normalized power values in which the horizontal axis denotes the horizontal direction, and the vertical axis denotes the normalized power values. In addition, with respect to (a) of FIG. 92, (c) of FIG. 92 also illustrates a grayscale color map of normalized power values in which the horizontal axis denotes the vertical direction, and the vertical axis denotes the normalized power values. Note that in FIG. 92, the normalized power values may be represented by a decibel value (dB) normalized by the peak power, and the same applies to plots of direction estimation results in the other examples below.

In the virtual reception array arrangement as illustrated in FIG. 91, the virtual antennas are arranged at spacings of a wavelength equal to or greater than one wavelength in both the horizontal direction and the vertical direction. Thus, the spacings between the virtual antennas may cause grating lobes. On the other hand, as illustrated in FIG. 92, it can be seen that the grating lobes are suppressed to about −4 dB or less in directions that differ from the peak direction in the target-true-value direction.

In Arrangement Example 2b, for example, the arrangement direction of the first oblique antenna group and the arrangement direction of the fourth oblique antenna group do not coincide with each other, but the arrangement direction of the second oblique antenna group and the arrangement direction of the third oblique antenna group coincide with each other and are parallel to each other. As described above, also when any one of the first oblique direction and the second oblique direction has an inclination coinciding with the inclination of the third oblique direction or the fourth oblique direction, Arrangement Condition 2 is satisfied, and the same grating-lobe suppression effect as in Arrangement Example 2 can be obtained.

Further, in Arrangement Example 2b, as illustrated in FIG. 90, the antenna elements of transmission antennas 106 and reception antennas 202 can be arranged in lines in the oblique directions, and therefore, antenna elements having a large size in the vertical direction (for example, antenna elements having a size of a wavelength equal to or greater than one wavelength) can be arranged.

As described above, in Arrangement Example 2b as in Arrangement Example 2, antenna elements with any longitudinal (for example, vertical) size can be applied in the MIMO array arrangement of radar apparatus 10, and grating lobes generated in the virtual reception array can be suppressed.

In the following, variations of Arrangement Example 2 will be described.

For example, Variations 1 to 4, 6, and 7 of Arrangement Example 1 may be similarly applied to the reception antennas of Arrangement Example 2 (or Arrangement Example 2a, 2b). Even when Variations 1 to 4, 6, and 7 of Arrangement Example 1 are applied to Arrangement Example 2, the same effects as in Arrangement Example 2 can be obtained. For example, Variations 1 to 4, 6, and 7 of Arrangement Example 1 may be applied (mutatis mutandis) by replacing “Arrangement Example 1” in the description of each of Variations 1 to 4, 6, and 7 of Arrangement Example 1 with “Arrangement Example 2,” and further, the “first oblique antenna group” and the “second oblique antenna group” of Arrangement Example 1 respectively with the “third oblique antenna group” and the “fourth oblique antenna group” of Arrangement Example 2. Accordingly, the same effects as those of Variations 1 to 4, 6, and 7 of Arrangement Example 1 can be obtained also in Arrangement Example 2. Note that a description of the same application as that of Variations 1 to 4, 6, and 7 of Arrangement Example 1 to Arrangement Example 2 is omitted.

Hereinafter, additional description will be given of a case where the same contents as those of Variations 1 to 4, 6, and 7 of Arrangement Example 1 are applied to the “first oblique antenna group” and the “second oblique antenna group” included in transmission antennas 106 of Arrangement Example 2.

Hereinafter, additions of Variations 1 to 4, 6, and 7 of Arrangement Example 2 corresponding to Variations 1 to 4, 6, and 7 of Arrangement Example 1 will be described. [Variation 1 of Arrangement Example 2]

In Variation 1 of Arrangement Example 2, the spacing between the first oblique antenna group and the second oblique antenna group (for example, the minimum spacing) may be wider than that in Arrangement Example 2 (or Arrangement Example 2a or 2b), for example.

For example, in Arrangement Example 2, as illustrated in FIG. 80, the minimum spacing between the first oblique antenna group and the second oblique antenna group (e.g., the spacing between Tx #3 and Tx #4) is set to a spacing narrower than the horizontal aperture length of Na reception antennas 202 (e.g., the spacing between Rx #4 and Rx #8). In Variation 1 of Arrangement Example 2, for example, the minimum spacing between the first oblique antenna group and the second oblique antenna group (for example, the spacing between Tx #3 and Tx #4) may be set to be larger than the horizontal direction aperture length of Na reception antennas 202. Also in this case, the same effect as in Arrangement Example 2 can be obtained.

Further, by increasing the minimum spacing between the first oblique antenna group and the second oblique antenna group, the peak in the target-true-value direction in the horizontal direction becomes sharper. It is thus possible to improve the horizontal angular measurement accuracy or horizontal estimation accuracy in radar apparatus 10. Note that, in Variation 1 of Arrangement Example 2, as in Variation 1 of Arrangement Example 1, the lateral (horizontal) sidelobe level along the peak in the target-true-value direction may increase. Accordingly, the spacing between the first oblique antenna group and the second oblique antenna group (for example, the minimum spacing) may be set within a suitable range depending on requirements such as a detection target assumed by radar apparatus 10.

### Variation 2 of Arrangement Example 2

In Variation 2 of Arrangement Example 2, for example, the spacing between the first oblique antenna group and the second oblique antenna group (for example, the minimum spacing) may be such that the groups are closer to each other as compared with Arrangement Example 2 (or Arrangement Example 2a, 2b). Further, in Variation 2 of Arrangement Example 2, for example, some antennas included in the first oblique antenna group and the second oblique antenna group may overlap.

For example, in Arrangement Example 2, as illustrated in FIG. 80, the minimum spacing between the first oblique antenna group of antennas Tx #1 to #3 and the second oblique antenna group of antennas Tx #4 to #6 (the spacing between Tx #3 and Tx #4) is narrower than the horizontal aperture length (for example, the spacing between Rx #4 and Rx #8) of Nₐ reception antennas 202.

In Variation 2 of Arrangement Example 2, for example, the minimum spacing between the first oblique antenna group of antennas Tx #1 to #3 and the second oblique antenna group of antennas Tx #4 to #6 (the spacing between Tx #3 and Tx #4) may be such that the groups are arranged closer to each other.

Alternatively, in Variation 2 of Arrangement Example 2, for example, some antennas of the first oblique antenna group and the second oblique antenna group may be arranged so as to overlap each other.

Also in these cases, the same effects as those of Arrangement Example 2 and the same effects as those of Variation 2 of Arrangement Example 1 can be obtained. [Variation 3 of Arrangement Example 2]

In Variation 3 of Arrangement Example 2, for example, the inclinations (for example, the position changes in the vertical direction with respect to the horizontal direction) of the first oblique antenna group and the second oblique antenna group may be set to be gentler than in Arrangement Example 2. Also in this case, the same effects as those of Arrangement Example 2 and the same effects as those of Variation 3 of Arrangement Example 1 can be obtained.

### Variation 4 of Arrangement Example 2

For example, in Arrangement Example 2 illustrated in FIG. 80, the first oblique antenna group of antennas Tx #1 to #3 and the second oblique antenna group of antennas Tx #4 to #6 are arranged to have horizontal inversion symmetry has been described, but the present disclosure is not limited thereto. The first oblique antenna group and the second oblique antenna group do not have to be arranged to have inversion symmetry. For example, the first oblique direction and the second oblique direction do not have to be parallel to each other and may be different directions. In the present variation, the same effects as those in Arrangement Example 2 can be obtained.

For example, a) the first oblique antenna group and the second oblique antenna group may be inclined asymmetrically, or different antenna spacings may be set for each of the horizontal direction and the vertical direction.

In addition, for example, b) the positions of the first oblique antenna group and the second oblique antenna group may be shifted in the vertical direction.

Further, for example, c) the numbers of antennas included respectively in the first oblique antenna group and the second oblique antenna group may be different from each other.

Further, for example, for the arrangement of the first oblique antenna group and the second oblique antenna group, any two or three of a) the arrangement of the first oblique antenna group and the second oblique antenna group having asymmetric inclinations, b) the arrangement in which the numbers of antennas included respectively in the first oblique antenna group and the second oblique antenna group are different from each other, and c) the arrangement in which the positions of the first oblique antenna group and the second oblique antenna group are shifted from each other in the vertical direction as described above may be combined.

In the present variation, the same effects as those in Arrangement Example 2 and the same effects as those in Variation 4 of Arrangement Example 1 can be obtained.

Further, the variations of the arrangement for the first oblique antenna group and the second oblique antenna group included in transmission antennas 106 as described above, and variations of the arrangement for the third oblique antenna group and the fourth oblique antenna group included in reception antennas 202 may be combined.

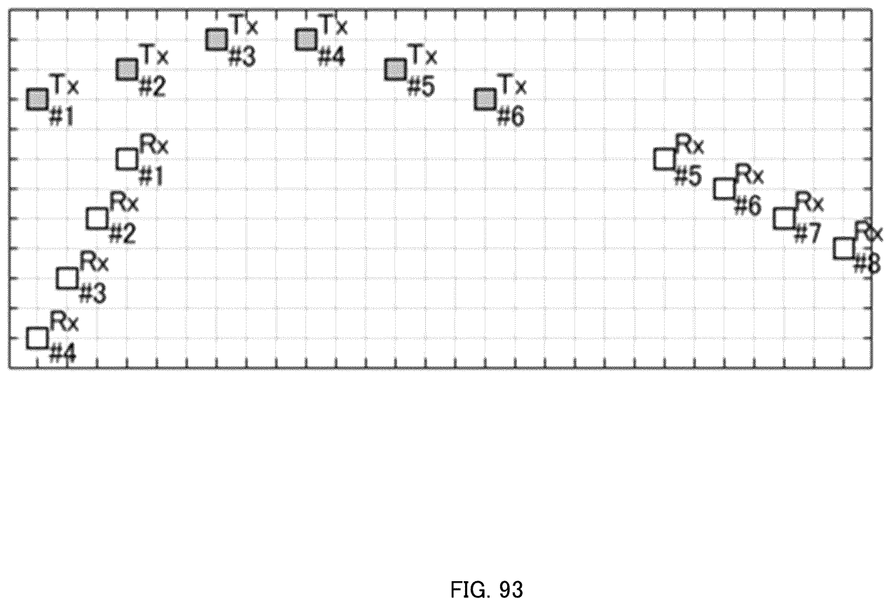

FIG. 93 illustrates an example of an arrangement in which the first oblique antenna group of antennas Tx #1 to #3 and the second oblique antenna group of antennas Tx #4 to #6 have horizontally symmetric inclinations, and the third oblique antenna group of antennas Rx #1 to #4 and the fourth oblique antenna group of antennas Rx #5 to #8 are arranged asymmetrically in the horizontal direction (for example, referred to as “Arrangement Example 2-4a”). Also with Arrangement Example 2-4a, the same advantages as in Arrangement Example 2 can be obtained.

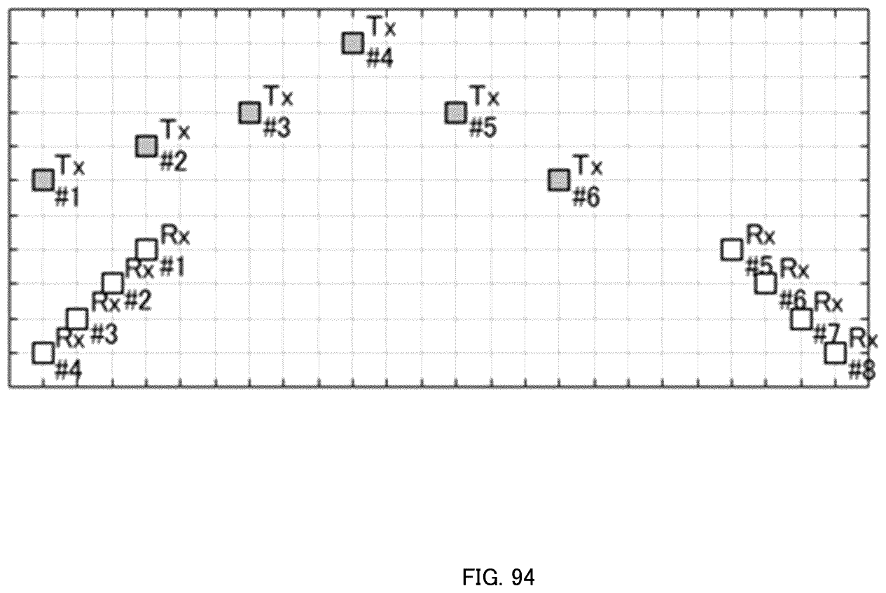

FIG. 94 illustrates an example of an arrangement in which the first oblique antenna group of antennas Tx #1 to #3 and the second oblique antenna group of antennas Tx #4 to #6 have horizontally asymmetric inclinations, and the third oblique antenna group of antennas Rx #1 to #4 and the fourth oblique antenna group of antennas Rx #5 to #8 are arranged symmetrically in the horizontal direction (for example, referred to as “Arrangement Example 2-4b”). Also in Arrangement Example 2-4b, the same advantages as in Arrangement Example 2 can be obtained.

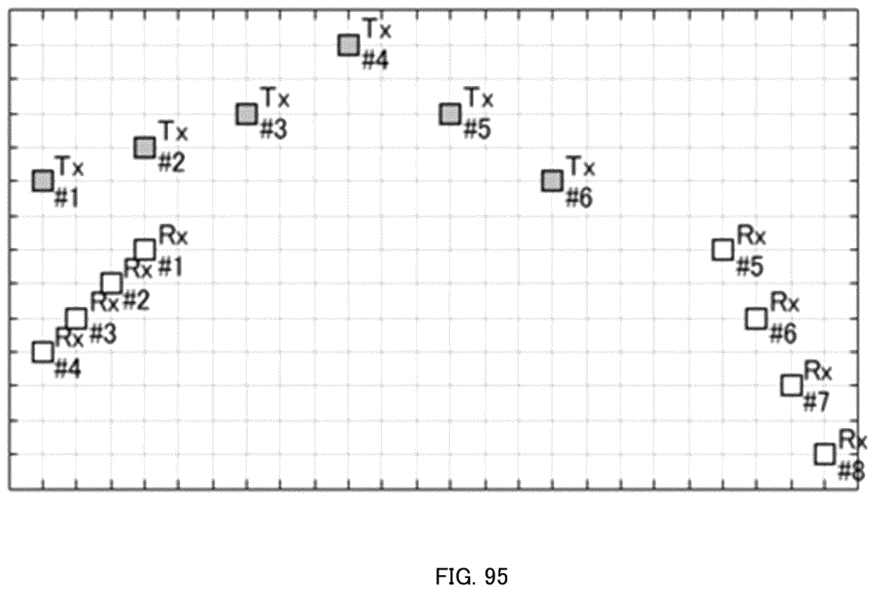

FIG. 95 illustrates an example of an arrangement in which the first oblique antenna group of antennas Tx #1 to #3 and the second oblique antenna group of antennas Tx #4 to #6 have horizontally asymmetric inclinations, and the third oblique antenna group of antennas Rx #1 to #4 and the fourth oblique antenna group of antennas Rx #5 to #8 are arranged asymmetrically in the horizontal direction (for example, referred to as “Arrangement Example 2-4c”). Also in Arrangement Example 2-4c, the same advantages as in Arrangement Example 2 can be obtained.

Under Arrangement Condition 2, one of the first oblique direction and the second oblique direction may be arranged in the horizontal direction. In addition, under Arrangement Condition 2, one of the third oblique direction and the fourth oblique direction may be arranged in the horizontal direction.

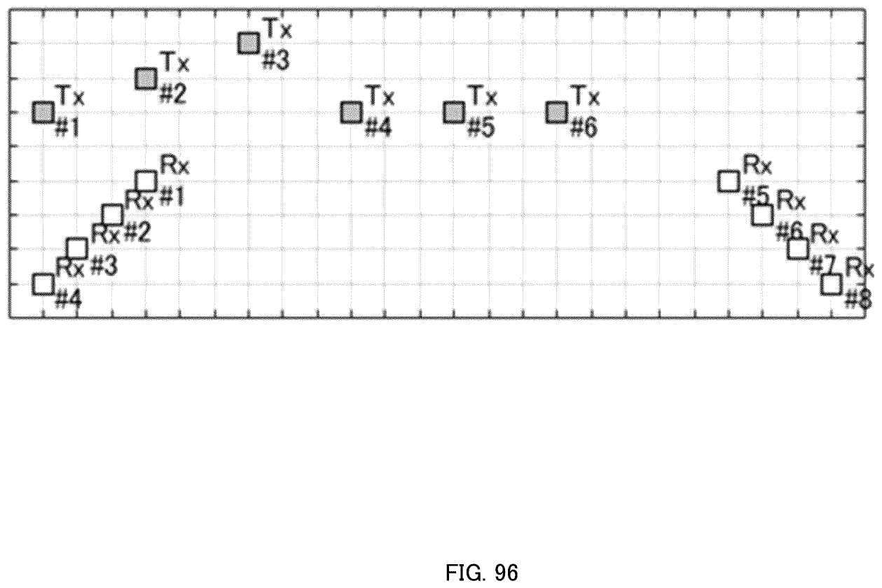

For example, FIG. 96 illustrates an example of the first oblique antenna group of antennas Tx #1 to #3 arranged in the oblique direction and the second oblique antenna group of antennas Tx #4 to #6 arranged in the horizontal direction (for example, referred to as “Arrangement Example 2-4d”). In FIG. 96, for example, the arrangements of the third oblique antenna group of antennas Rx #1 to #4 and the fourth oblique antenna group of antennas Rx #5 to #8 have horizontal inversion symmetry. As described above, also when either one of the first oblique direction and the second oblique direction is arranged in the horizontal direction, the same effects as in Arrangement Example 2 can be obtained.

### Variation 6 of Arrangement Example 2

In at least either one of transmission antennas 106 (for example, the first oblique antenna group and the second oblique antenna group) and reception antennas 202 (for example, the third oblique antenna group and the fourth oblique antenna group), the spacings between adjacent antennas are not limited to the case of equal spacings, and may be unequal spacings.

For example, the arrangement of at least one of the first oblique antenna group, the second oblique antenna group, the third oblique antenna group, and the fourth oblique antenna group may be set as an antenna arrangement having unequal spacings. Also in the present variation, the same effects as in Arrangement Example 2 can be obtained.

### Variation 7 of Arrangement Example 2

In Variation 7 of Arrangement Example 2, for example, a multi-stage configuration may be applied to the antenna arrangements described in Arrangement Example 2 and Variations 1 to 4 and 6 of Arrangement Example 2.

The multi-stage configuration includes, for example, a configuration in which the first oblique antenna group and the second oblique antenna group included in transmission antennas 106 are arranged in two stages in the vertical direction or are arranged in two stages in the horizontal direction, and a configuration in which the third oblique antenna group and the fourth oblique antenna group included in reception antennas 202 are arranged in two stages in the vertical direction or are arranged in two stages in the horizontal direction. Alternatively, the multi-stage configuration may be a configuration in which these configurations are combined with one another.

Also in the case of the multi-stage configuration, the effects according to above-described Arrangement Example 2 can be maintained. Further, for example, the horizontal multi-stage configuration increases the aperture length of the virtual reception array in the horizontal direction, and improves the horizontal angular measurement accuracy or horizontal resolution in radar apparatus 10. Further, for example, the aperture length of the virtual reception array in the vertical direction is widened by the vertical multi-stage configuration, and the angular measurement accuracy or the resolution in the vertical direction in radar apparatus 10 can be improved. In addition, for example, the aperture lengths of the virtual reception array in the vertical direction and the horizontal direction are widened by the horizontal and vertical multi-stage configurations, and the angular measurement accuracy or the resolution in the vertical direction and the horizontal direction in radar apparatus 10 can be improved.

Note that, in the case of the multi-stage configurations, a common arrangement for transmission antennas Tx or reception antennas Rx may be configured in multiple stages in at least one of the vertical direction and the horizontal direction, or different arrangements for transmission antennas Tx or reception antennas Rx may be configured in multiple stages in at least one of the vertical direction and the horizontal direction.

Further, different antenna elements may be used in combination in the above-described multi-stage configuration. For example, the plurality of transmission antennas 106 may include Long Range (LR) antenna elements and Short Range (SR) antenna elements.

For example, in the multi-stage configuration, the long range (LR) antenna elements may be used in the first stage, and the short distance (SR) antenna elements may be used in combination in the second stage. For example, when transmission antennas 106 are vertically arranged in a multi-stage configuration with two stages, the long range (LR) antenna elements may be applied in the first stage, and the short range (SR) antenna elements may be applied in the second stage.

When the long range (LR) antenna elements are large in the vertical direction and the horizontal direction, the elements of the first stage may be shifted in the horizontal direction so that transmission antennas 106 of the first stage and transmission antennas 106 of the second stage do not overlap each other.

As described above, when the LR antennas and the SR antennas are used for transmission antennas 106, for example, the SR antennas (for example, those antennas characterized by a wide viewing angle) may be applied to reception antennas 202. Thus, the effects of Arrangement Example 2 are still obtained and simultaneously the detection range of both LR and SR modes can be covered.

The variations of Arrangement Example 2 have been described above.

Next, variations specific to Arrangement Condition 2 will be described.

### [Variation of Arrangement Condition 2]

Arrangement Example 2 and the variations of Arrangement Example 2 have been described in relation to the case where, for example, the inclinations of transmission antennas 106 and reception antennas 202 in the oblique direction are set by an integer multiple of basic spacing D_{H} in the horizontal direction and by an integer multiple of basic spacing D_{V} in the vertical direction.

For example, with regard to N_{Tx} transmission antennas 106, the first oblique antenna group and the second oblique antenna group are arranged in respective different oblique directions. In addition, the first oblique antenna group is arranged in an oblique direction such that the antennas are horizontally shifted from one another by spacings of dTH₁×D_{H} and are also vertically shifted from one another by spacings of dTV₁×D_{V}. In addition, the second oblique antenna group is arranged in an oblique direction such that the antennas are horizontally shifted from one another by spacings of dTH₂×D_{H} and are also vertically shifted from one another by spacings of dTV₂×D_{V}.

In addition, with regard to Na reception antennas 202, the third oblique antenna group and the fourth oblique antenna group are arranged in respective different oblique directions. In addition, the third oblique antenna group is arranged in an oblique direction such that the antennas are horizontally shifted from one another by spacings of dRH₁×D_{H} and are also vertically shifted from one another by spacings of dRV₁×D_{V}. In addition, the fourth oblique antenna group is arranged in an oblique direction such that the antennas are horizontally shifted from one another by spacings of dRH₂×D_{H} and are also vertically shifted from one another by spacings of dRV₂×D_{V}.

Here, dTH₁ and dTV₁ are an integer equal to or greater than 1, and dTH₂ and dTV₂ are an integer equal to or greater than 1. Further, dRH₁ and dRV₁ are an integer equal to or greater than 1, and dRH₂ and dRV₂ are an integer equal to or greater than 1.

For example, in a case where dTH₁=dTH₂ and dTV₁=dTV₂, the first oblique antenna group and the second oblique antenna group are arranged to have horizontal symmetry. Further, for example, in a case where dTH₁+dTH₂ or dTV₁+dTV₂, the first oblique antenna group and the second oblique antenna group are arranged to have horizontal asymmetry.

Similarly, for example, in a case where dRH₁=dRH₂ and dRV₁=dRV₂, the third oblique antenna group and the fourth oblique antenna group are arranged to have horizontal symmetry. Further, for example, in a case where dRH₁ #dRH₂ or dRV₁+dRV₂, the third oblique antenna group and the fourth oblique antenna group are arranged to have horizontal asymmetry.

Note that, in Arrangement Example 2 and the variations of Arrangement Example 2, the inclinations of transmission antennas 106 and reception antennas 202 in the oblique direction are not limited to the case where the inclinations are set by an integer multiple of basic spacing D_{H} in the horizontal direction and by an integer multiple of basic spacing D_{V} in the vertical direction. The inclinations may be set by spacings that are not integer multiples of D_{V} and D_{H}. Also in such an arrangement, Arrangement Condition 2 is satisfied, and the same effects as in Arrangement Example 2 can be obtained.

### [Minimum Antenna Configuration Under Arrangement Condition 2 and Arrangement Example in Case of Small Number of Antennas]

Hereinafter, a minimum antenna configuration satisfying Arrangement Condition Example 2 and an arrangement example in a case where the number of antennas satisfying Arrangement Condition 2 is small will be described. It should be noted that the same effect can be obtained even when the antenna arrangement described below is modified in accordance with the variations of Arrangement Example 2 described above.

The minimum number of antennas under Arrangement Condition 2 is, for example, the number in a case where number N_{Tx} of transmission antennas=3 and number Na of reception antennas=3. For example, the total number of antennas of the first oblique antenna group and the second oblique antenna group is three, and the total number of antennas of the third oblique antenna group and the fourth oblique antenna group is three.

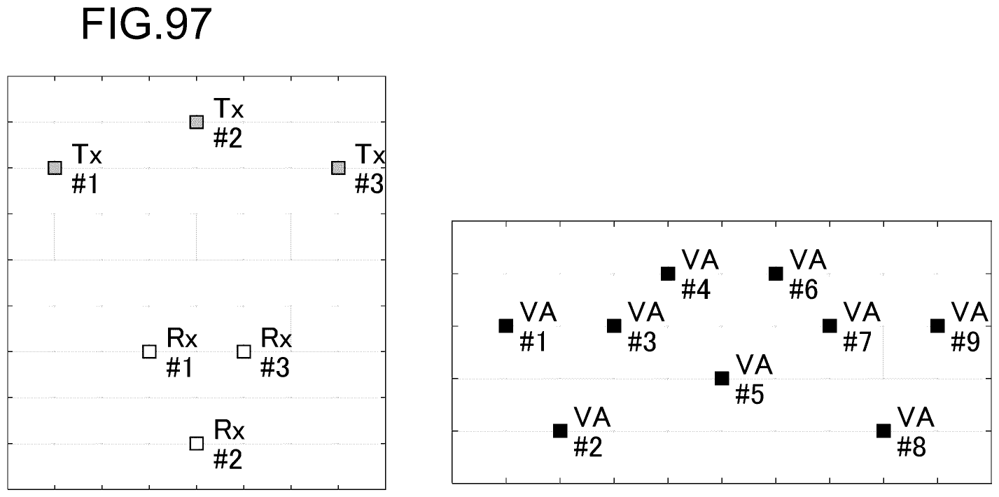

FIG. 97 illustrates an antenna arrangement example of the minimum number of antennas (number N_{Tx} of transmission antennas=3 and number Na of reception antennas=3) under Arrangement Condition 2. Part (a) of FIG. 97 illustrates an example of the MIMO antenna arrangement, and part (b) of FIG. 97 illustrates an example of the virtual reception array arrangement configured by the MIMO antenna arrangement illustrated at part (a) of FIG. 97. In FIG. 97, the scales of the horizontal axis and the vertical axis are, for example, D_{H} and D_{V}, respectively.

In FIG. 97, the first oblique antenna group includes Tx #1 and Tx #2, and the second oblique antenna group includes Tx #2 and Tx #3. In addition, in FIG. 97, the third oblique antenna group includes Rx #1 and Rx #2, and the fourth oblique antenna group includes Rx #2 and Rx #3.

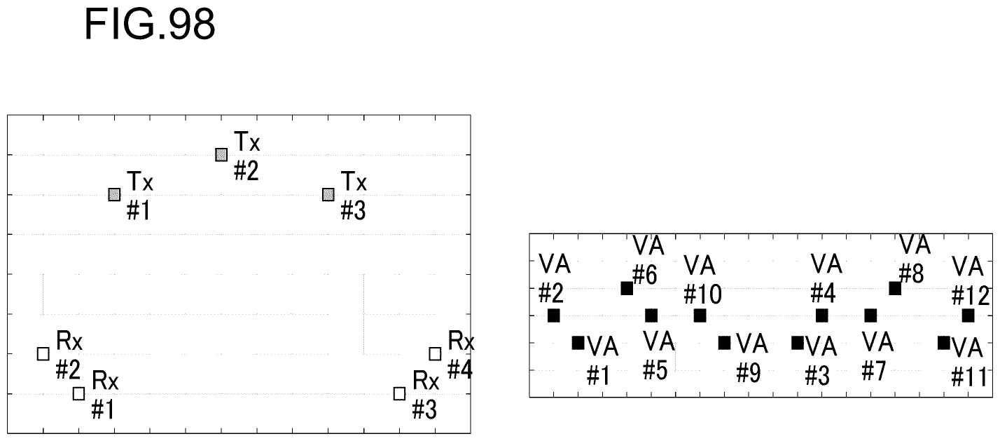

In addition, FIGS. 98 to 101 illustrate antenna arrangement examples for cases where the number of antennas satisfying Arrangement Condition 2 is small. Parts (a) of FIGS. 98 to 101 illustrate examples of the MIMO antenna arrangements, and parts (b) of FIGS. 98 to 101 illustrate examples of the virtual reception array arrangements configured by the MIMO antenna arrangements illustrated at parts (a) of FIGS. 98 to 101. In FIGS. 98 to 101, the scales of the horizontal axis and the vertical axis are, for example, D_{H} and D_{V}, respectively.

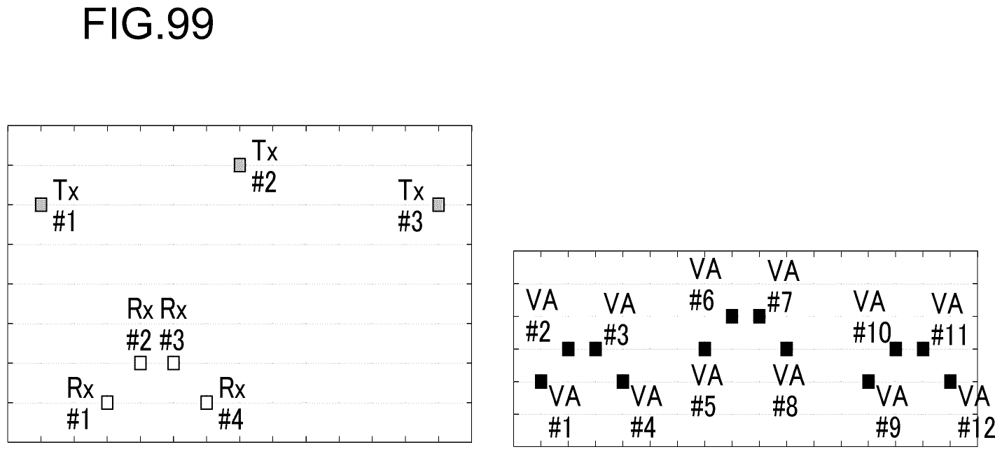

For example, FIGS. 98 and 99 indicate antenna arrangement examples for a case where number N_{Tx} of transmission antennas=3 and number Na of reception antennas=4. In FIGS. 98 and 99, the first oblique antenna group includes Tx #1 and Tx #2, the second oblique antenna group includes Tx #2 and Tx #3, the third oblique antenna group includes Rx #1 and Rx #2, and the fourth oblique antenna group includes Rx #3 and Rx #4.

For example, in the antenna arrangement example illustrated in FIG. 98, even when the size of transmission antennas 106 in the vertical direction is large, reception antennas 202 are arranged on opposite sides of transmission antennas 106 (the left side of transmission antenna Tx #1 and the right side of transmission antenna Tx #3). Thus, the mounting area of the antennas can be reduced.

Further, for example, in the antenna arrangement example illustrated in FIG. 99, even when the size of transmission antennas 106 in the vertical direction is large, transmission antennas 106 are arranged on opposite sides of reception antenna 202 (the left side of reception antenna Rx #1 and the right side of reception antenna Rx #4). Thus, the mounting area of the antennas can be reduced.

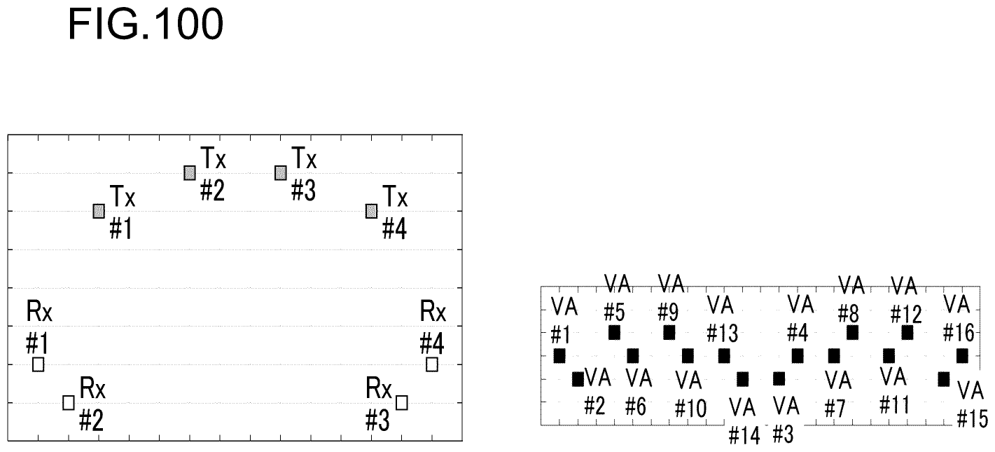

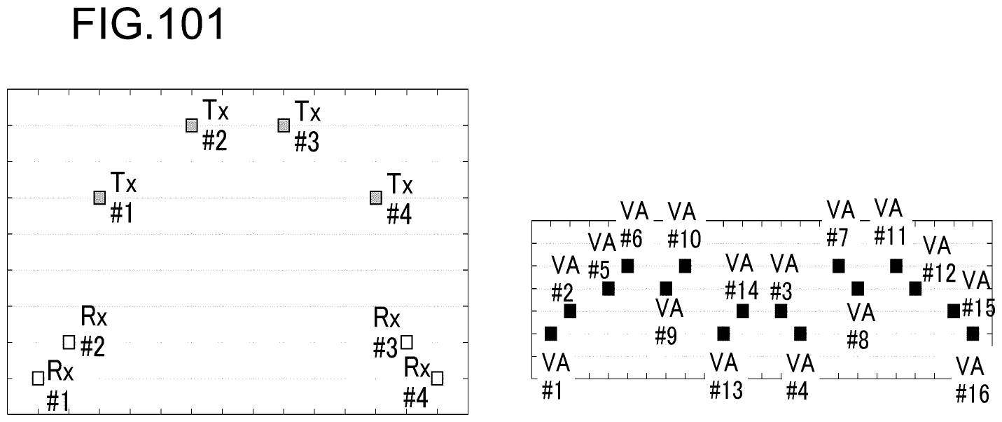

Further, for example, FIGS. 100 and 101 indicate antenna arrangement examples for a case where number N_{Tx} of transmission antennas=4 and number Na of reception antennas=4. In FIGS. 100 and 101, the first oblique antenna group includes Tx #1 and Tx #2, the second oblique antenna group includes Tx #3 and Tx #4, the third oblique antenna group includes Rx #1 and Rx #2, and the fourth oblique antenna group includes Rx #3 and Rx #4.

For example, in the antenna arrangements illustrated in FIGS. 100 and 101, even when the size of transmission antennas 106 in the vertical direction is large, reception antennas 202 are arranged on opposite sides of transmission antennas 106 (the left side of transmission antenna Tx #1 and the right side of transmission antenna Tx #4). Thus, the mounting area of the antennas can be reduced.

The embodiments of the present disclosure have been described above.

Note that, one exemplary embodiment of the present disclosure has been described in relation to the case where the arrangement directions (e.g., the oblique directions) of reception antennas 202 are two different directions under Arrangement Condition 1 (e.g., FIG. 8), but the arrangement directions of reception antennas 202 may be three or more different directions. Similarly, the case has been described in which the arrangement directions (e.g., oblique directions) of transmission antennas 106 and reception antennas 202 are two different directions each under Arrangement Condition 2 (e.g., FIG. 80), but the arrangement directions of transmission antennas 106 and reception antennas 202 may be three or more different directions each. Even in these cases of three or more different arrangement directions, the generation directions of the grating lobes corresponding to the respective arrangement directions are likely to be dispersed as described above. Thus, the grating lobes can be suppressed as described above.

Further, the configuration of the radar apparatus according to one exemplary embodiment is not limited to the configuration illustrated in FIG. 6. For example, the radar apparatus does not have to include CFAR section 211.

Further, the parameters such as number N_{Tx} of transmission antennas, number Na of reception antennas, and the antenna spacings in the antenna arrangements described in one exemplary embodiment of the present disclosure are examples, and may be other different values.

Further, at least two of the variations of Arrangement Example 1 described in the exemplary embodiment of the present disclosure may be implemented in combination. Similarly, at least two of the variations of Arrangement Example 2 may be implemented in combination. For example, configurations such as the number of antennas, the inclinations, the element spacings, or the spacing between the oblique antenna groups of the first and second oblique antenna groups in Arrangement Example 1 and the first to fourth oblique antenna groups in Arrangement Example 2 may be determined by a combination of at least two variations of Arrangement Example 1 or Arrangement Example 2.

In the radar apparatus according to the exemplary embodiment of the present disclosure, the radar transmitter and the radar receiver may be separately disposed at physically separate locations. In addition, in the radar receiver according to the exemplary embodiment of the present disclosure, the direction estimator and the other components may be separately arranged at physically separate locations.

A radar apparatus according to an exemplary embodiment of the present disclosure includes, for example, a central processing unit (CPU), a storage medium such as a read only memory (ROM) that stores a control program, and a work memory such as a random access memory (RAM), which are not illustrated. In this case, the functions of the sections described above are implemented by the CPU executing the control program. However, the hardware configuration of the radar apparatus is not limited to that in this example. For example, the functional sections of the radar apparatus may be implemented as an integrated circuit (IC). Each functional section may be formed as an individual chip, or some or all of them may be formed into a single chip.

Although various embodiments have been described above with reference to the drawings, it goes without saying that the present disclosure is not limited to foregoing embodiments. Obviously, a person skilled in the art would arrive variations and modification examples within a scope described in claims, and it is understood that these variations and modifications are within the technical scope of the present disclosure. Moreover, any combination of features of the above-mentioned embodiments may be made without departing from the spirit of the present disclosure.

The expression “section” used in the above-described embodiments may be replaced with another expression such as “circuit (circuitry),” “device,” “unit,” or “module.”

The above embodiments have been described with an example of a configuration using hardware, but the present disclosure can be realized by software in cooperation with hardware.

Each functional block used for explaining the above-mentioned embodiments is realized as an LSI which is typically an integrated circuit. The integrated circuit controls each functional block used in the description of the above embodiments and may include an input terminal and an output terminal. The LSI may be individually formed as chips, or one chip may be formed so as to include a part or all of the functional blocks. The LSI herein may be referred to as an IC, a system LSI, a super LSI, or an ultra LSI depending on a difference in the degree of integration.

However, the technique of implementing an integrated circuit is not limited to the LSI and may be realized by using a dedicated circuit, a general-purpose processor, or a special-purpose processor. In addition, a Field Programmable Gate Array (FPGA) that can be programmed after the manufacture of the LSI or a reconfigurable processor in which the connections and the settings of circuit cells disposed inside the LSI can be reconfigured may be used.

In case that future integrated circuit technology replaces LSIs as a result of the advancement of semiconductor technology or other derivative technology, the functional blocks could be integrated using the future integrated circuit technology. Biotechnology can also be applied.

### Summary of Disclosure

A radar apparatus according to an exemplary embodiment of the present disclosure includes: transmission circuitry, which, in operation, transmits a transmission signal using a plurality of transmission antennas; and reception circuitry, which, in operation, receives a reflected wave signal using a plurality of reception antennas, the reflected wave signal being the transmission signal reflected by an object, in which either the plurality of transmission antennas or the plurality of reception antennas include a first antenna group disposed in a first direction and a second antenna group disposed in a second direction different from the first direction, and an other of the plurality of transmission antennas and the plurality of reception antennas include a third antenna group in which a spacing between adjacent antennas is equal to or greater than one wavelength of the transmission signal and which is disposed in a third direction different from each of the first direction and the second direction.

In one exemplary embodiment of the present disclosure, the radar apparatus is installed in a vehicle, and the first direction and the second direction are different directions with respect to a vertical direction and a horizontal direction, the vertical direction being a height direction of the vehicle, the horizontal direction being a forward traveling direction of the vehicle and a direction orthogonal to the forward traveling direction of the vehicle.

In one exemplary embodiment of the present disclosure, the first direction and the second direction are different directions with respect to a vertical direction and a horizontal direction, the vertical direction being a gravity direction, the horizontal direction being a direction orthogonal to the gravity direction.

In one exemplary embodiment of the present disclosure, the third direction is a direction coinciding with the horizontal direction.

In one exemplary embodiment of the present disclosure, a minimum spacing between the first antenna group and the second antenna group is greater than an aperture length of the third antenna group.

In one exemplary embodiment of the present disclosure, the first antenna group and the second antenna group include one or more shared antennas.

In one exemplary embodiment of the present disclosure, an antenna arrangement included in the first antenna group and an antenna arrangement included in the second antenna group have line symmetry with respect to a line orthogonal to the third direction.

In one exemplary embodiment of the present disclosure, a spacing between adjacent antennas of the third antenna group in the horizontal direction is dT×D_{H}, a spacing between adjacent antennas included in the first antenna group in the horizontal direction is dRH₁×D_{H}, a spacing between adjacent antennas included in the first antenna group in the vertical direction is dRV×D_{V}, a spacing between adjacent antennas included in the second antenna group in the horizontal direction is dRH₂×D_{H}, and a spacing between adjacent antennas included in the second antenna group in the vertical direction is dRV×D_{V}, the D_{H} and the D_{V} are values in a range of 0.45 to 0.8 times the wavelength of the transmission signal, the dT is a value equal to or greater than 2, and each of the dRH₁ and the dRH₂ is a value equal to or greater than 1.

In one exemplary embodiment of the present disclosure, a spacing between adjacent antennas is an equal spacing in each of the third antenna group, the first antenna group, and the second antenna group.

In one exemplary embodiment of the present disclosure, a spacing between adjacent antennas includes one or more unequal spacings in at least one of the third antenna group, the first antenna group, and the second antenna group.

In one exemplary embodiment of the present disclosure, the third antenna group includes a plurality of sets of at least some antennas arranged in the third direction.

In one exemplary embodiment of the present disclosure, the either the plurality of transmission antennas or the plurality of reception antennas include a plurality of the first antenna groups and a plurality of the second antenna groups.

In one exemplary embodiment of the present disclosure, the plurality of transmission antennas include two types of antenna elements differing at least in size.

In one exemplary embodiment of the present disclosure, the other of the plurality of transmission antennas and the plurality of reception antennas include a fourth antenna group disposed in a fourth direction different from the third direction.

In one exemplary embodiment of the present disclosure, the other of the plurality of transmission antennas and the plurality of reception antennas include a fourth antenna group disposed in a fourth direction different from the third direction, and
the third direction and the fourth direction are different directions with respect to the horizontal direction and the vertical direction.

In one exemplary embodiment of the present disclosure, the first direction, the second direction, the third direction, and the fourth direction are different from one another.

In one exemplary embodiment of the present disclosure, the third antenna group and the fourth antenna group include one or more shared antennas.

In one exemplary embodiment of the present disclosure, a spacing between adjacent antennas of the third antenna group in the horizontal direction is dTH₁×D_{H}, a spacing between adjacent antennas included in the third antenna group in the vertical direction is dTV₁×D_{V}, a spacing between adjacent antennas of the fourth antenna group in the horizontal direction is dTH₂×D_{H}, a spacing between adjacent antennas included in the fourth antenna group in the vertical direction is dTV₂×D_{V}, a spacing between adjacent antennas included in the first antenna group in the horizontal direction is dRH₁×D_{H}, a spacing between adjacent antennas included in the first antenna group in the vertical direction is dRV₁×D_{V}, a spacing between adjacent antennas included in the second antenna group in the horizontal direction is dRH₂×D_{H}, a spacing between adjacent antennas included in the second antenna group in the vertical direction is dRV₂×D_{V}, the D_{H} and the D_{V} are values in a range of 0.45 to 0.8 times the wavelength of the transmission signal, and each of dTH₁, dTV₁, dTH₂, dTV₂, dRH₁, dRV₁, dRH₂, dRV₂ is a value equal to or greater than 1.

A radar apparatus according to an exemplary embodiment of the present disclosure includes: transmission circuitry, which, in operation, transmits a transmission signal using a plurality of transmission antennas; and reception circuitry, which, in operation, receives a reflected wave signal using a plurality of reception antennas, the reflected wave signal being the transmission signal reflected by an object, in which either the plurality of transmission antennas or the plurality of reception antennas include a first antenna group disposed in a first direction and a second antenna group disposed in a second direction different from the first direction, and an other of the plurality of transmission antennas and the plurality of reception antennas include a third antenna group in which a spacing between adjacent antennas is equal to or greater than one wavelength of the transmission signal and which is disposed in a third direction, and a fourth antenna group in which a spacing between adjacent antennas is equal to or greater than one wavelength of the transmission signal and which is disposed in a fourth direction different from the third direction, in which the third direction is the same direction as the first direction and the fourth direction is a same direction as the second direction.

While various embodiments have been described herein above, it is to be appreciated that various changes in form and detail may be made without departing from the sprit and scope of the invention (s) presently or hereafter claimed.

This application is entitled and claims the benefit of Japanese Patent Application No. 2021-114909, filed on Jul. 12, 2021, the disclosure of which including the specification, drawings and abstract is incorporated herein by reference in its entirety.

### INDUSTRIAL APPLICABILITY

The present disclosure is suitable as a radar apparatus for detection in a wide-angle range.

### REFERENCE SIGNS LIST

10 Radar apparatus
100 Radar transmitter
101 Radar transmission signal generator
102 Modulation signal generator
103 VCO
104 Code generator
105 Phase rotator
106 Transmission antenna
200 Radar receiver
201 Antenna system processor
202 Reception antenna
203 Reception radio
204 Mixer
205 LPF
206 Signal processor
207 AD converter
208 Beat frequency analyzer
209 Output switch
210 Doppler analyzer
211 CFAR section
212 Code demultiplexer
213 Direction estimator

1. A radar apparatus, comprising:
transmission circuitry, which, in operation, transmits a transmission signal using a plurality of transmission antennas; and
reception circuitry, which, in operation, receives a reflected wave signal using a plurality of reception antennas, the reflected wave signal being the transmission signal reflected by an object, wherein
either the plurality of transmission antennas or the plurality of reception antennas include a first antenna group disposed in a first direction and a second antenna group disposed in a second direction different from the first direction, and
an other of the plurality of transmission antennas and the plurality of reception antennas include a third antenna group disposed in a third direction different from each of the first direction and the second direction.

2. The radar apparatus according to claim 1, wherein:
the radar apparatus is installed in a vehicle, and
the first direction and the second direction are different directions with respect to a vertical direction and a horizontal direction, the vertical direction being a height direction of the vehicle, the horizontal direction being a forward traveling direction of the vehicle and a direction orthogonal to the forward traveling direction of the vehicle.

3. The radar apparatus according to claim 1, wherein
the first direction and the second direction are different directions with respect to a vertical direction and a horizontal direction, the vertical direction being a gravity direction, the horizontal direction being a direction orthogonal to the gravity direction.

4. The radar apparatus according to claim 2, wherein
the third direction is a direction coinciding with the horizontal direction.

5. The radar apparatus according to claim 1, wherein
a minimum spacing between the first antenna group and the second antenna group is greater than an aperture length of the third antenna group.

6. The radar apparatus according to claim 1, wherein
the first antenna group and the second antenna group include one or more shared antennas.

7. The radar apparatus according to claim 1, wherein
an antenna arrangement included in the first antenna group and an antenna arrangement included in the second antenna group have line symmetry with respect to a line orthogonal to the third direction.

8. The radar apparatus according to claim 2, wherein:
a spacing between adjacent antennas of the third antenna group in the horizontal direction is dT×D_{H},
a spacing between adjacent antennas included in the first antenna group in the horizontal direction is dRH₁×D_{H},
a spacing between adjacent antennas included in the first antenna group in the vertical direction is dRV×D_{V},
a spacing between adjacent antennas included in the second antenna group in the horizontal direction is dRH₂×D_{H},
a spacing between adjacent antennas included in the second antenna group in the vertical direction is dRV×D_{V},
the D_{H} and the D_{V} are values in a range of 0.45 to 0.8 times the wavelength of the transmission signal, and
the dT is a value equal to or greater than 2, each of the dRH₁ and the dRH₂ is a value equal to or greater than 1.

9. The radar apparatus according to claim 1, wherein
a spacing between adjacent antennas is an equal spacing in each of the third antenna group, the first antenna group, and the second antenna group.

10. The radar apparatus according to claim 1, wherein
a spacing between adjacent antennas includes one or more unequal spacings in at least one of the third antenna group, the first antenna group, and the second antenna group.

11. The radar apparatus according to claim 1, wherein
the third antenna group includes a plurality of sets of at least some antennas arranged in the third direction.

12. The radar apparatus according to claim 1, wherein
the either the plurality of transmission antennas or the plurality of reception antennas include a plurality of the first antenna groups and a plurality of the second antenna groups.

13. The radar apparatus according to claim 1, wherein
the plurality of transmission antennas include two types of antenna elements differing at least in size.

14. The radar apparatus according to claim 1, wherein
the other of the plurality of transmission antennas and the plurality of reception antennas include a fourth antenna group disposed in a fourth direction different from the third direction.

15. The radar apparatus according to claim 2, wherein:
the other of the plurality of transmission antennas and the plurality of reception antennas include a fourth antenna group disposed in a fourth direction different from the third direction, and
the third direction and the fourth direction are different directions with respect to the horizontal direction and the vertical direction.

16. The radar apparatus according to claim 14, wherein
the first direction, the second direction, the third direction, and the fourth direction are different from one another.

17. The radar apparatus according to claim 14, wherein
the third antenna group and the fourth antenna group include one or more shared antennas.

18. The radar apparatus according to claim 15, wherein:
a spacing between adjacent antennas of the third antenna group in the horizontal direction is dTH₁×D_{H},
a spacing between adjacent antennas included in the third antenna group in the vertical direction is dTV₁×D_{V},
a spacing between adjacent antennas of the fourth antenna group in the horizontal direction is dTH₂×D_{H},
a spacing between adjacent antennas included in the fourth antenna group in the vertical direction is dTV₂×D_{V},
a spacing between adjacent antennas included in the first antenna group in the horizontal direction is dRH₁×D_{H},
a spacing between adjacent antennas included in the first antenna group in the vertical direction is dRV₁×D_{V},
a spacing between adjacent antennas included in the second antenna group in the horizontal direction is dRH₂×D_{H},
a spacing between adjacent antennas included in the second antenna group in the vertical direction is dRV₂×D_{V},
the D_{H} and the D_{V} are values in a range of 0.45 to 0.8 times the wavelength of the transmission signal, and
each of the dTH₁, the dTV₁, the dTH₂, the dTV₂, the dRH₁, the dRV₁, the dRH₂, and the dRV₂ is a value equal to or greater than 1.

19. The radar apparatus according to claim 1, wherein:
the other of the plurality of transmission antennas and the plurality of reception antennas further include a fourth antenna group disposed in a fourth direction different from the third direction,
the third direction is a same direction as the first direction, and
the fourth direction is a same direction as the second direction.

20. The radar apparatus according to claim 1, wherein
a spacing between adjacent antennas in the third antenna group is equal to or greater than one wavelength of the transmission signal.

21. A method for transmitting and receiving a radar signal, comprising:
transmitting a transmission signal using a plurality of transmission antennas; and
receiving a reflected wave signal using a plurality of reception antennas, the reflected wave signal being the transmission signal reflected by an object, wherein
either the plurality of transmission antennas or the plurality of reception antennas include a first antenna group disposed in a first direction and a second antenna group disposed in a second direction different from the first direction, and
an other of the plurality of transmission antennas and the plurality of reception antennas include a third antenna group disposed in a third direction different from each of the first direction and the second direction.
